(19) United States
(12) Patent Application Publication
(10) Pub. No.: US 2012/0031193 A1
(43) Pub. Date: Feb. 9, 2012

(54) IDENTIFICATION OF LOADS ACTING ON AN OBJECT

(75) Inventors: Douglas E. Adams, West Lafayette, IN (US); Nick A. Stites, Longmont, CO (US); Nathanael C. Yoder, Lafayette, IN (US); Jonathan R. White, Sylvania, OH (US)

(73) Assignee: PURDUE RESEARCH FOUNDATION, West Lafayette, IN (US)

(21) Appl. No.: 13/262,450

(22) PCT Filed: Apr. 1, 2010
(86) PCT No.: PCT/US2010/029660

§ 371 Date: Sep. 30, 2011

Related U.S. Application Data
(60) Provisional application No. 61/165,631, filed on Apr. 1, 2009.

(51) Int. Cl. G01N 19/00

(52) U.S. Cl. 73/804

(57) ABSTRACT

Structural health monitoring systems can be limited to a minimum number of sensors due to cost, complexity, and weight restrictions. Some embodiments described herein pertain to a load and damage identification techniques that utilize one sensor. Several passive force estimation techniques are presented. Some techniques use either the shape or the amplitude of the magnitude of the applied force in the frequency domain. Several techniques iteratively reduce an underdetermined set of equations of motion into many overdetermined systems of equations to solve for the force estimates. The techniques are shown to locate and quantify impulsive impacts with over 97% accuracy and non-impulsive impacts with at least 87% accuracy. Impacts not acting at a specific input degree of freedom are also accurately located depending on the distance away from the modeled input degrees of freedom, and damaging impact forces are quantified by making assumptions about the impulsive nature of the applied force.

### CROSS REFERENCE TO RELATED APPLICATION

This application claims the benefit of priority to U.S. Provisional Patent Application Ser. No. 61/165,631, filed Apr. 1, 2009, entitled METHODS AND APPARATUS FOR IDENTIFYING LOADS AND EVALUATING DAMAGE, incorporated herein by reference.

### FIELD OF THE INVENTION

The present application pertains to methods and apparatus for identifying loads acting on an object, and in particular to methods and apparatus involving an experimentally-derived model of the object and a small number of measurement sensors.

### BACKGROUND OF THE INVENTION

Indirect (passive) force estimation is the determination of the external forces acting on a structure by measuring only the response of the structure. The benefits of passive force estimation include the ability to warn maintenance crews that a load capable of damaging the structure has occurred, and indirect force estimation can also locate the point of application of the load for further inspection. The difficulty of passive force estimation is that the number of forces acting on a structure often outnumbers the response measurements leading to an underdetermined set of governing equations. An underdetermined set of equations yields non-unique force estimates. However, if certain assumptions about the input forces are valid and the techniques described in this document are applied, forces on a structure with an underdetermined system of governing equations can be accurately located and quantified.

The technique of inverse methods is used for health monitoring based on vibration measurements. These methods interpret changes in the measured dynamic characteristics of a structural component using a physics-based or data-driven model of that component to detect, locate, and quantify damage. Often, a model derived using finite element analysis is used to estimate structural parameters based on common types of measurements (accelerations, forces, strains) Once these models have been validated using measurements from the pristine structure, subsequent measurements may be used in conjunction with the model to locate and quantify the damage.

Impacts in composite materials can induce extensive damage that is often located beneath the surface making visual inspection ineffective. Methods of inspection such as ultrasonic pitch-echo, impedance pitch-catch, and ultrasonic phased arrays are used in detecting such damage if the location and time at which an impact occurred are known. In practice, however, periodic nondestructive inspections should be performed across the entire component because both the presence and location of damage are unknown. The localized nature of these inspection methods consequently results in long inspection times and large support costs. One way to achieve near real time estimates of damage resulting from impacts is to determine the severity of the impact and its location. If this information is combined with the component's design data, the potential for damage and failure due to the impact could be ascertained. Nondestructive tests could then be applied locally in the impact zone to reduce inspection times.

The accuracy of the model used to solve the load identification inverse problem should be balanced by the time required to generate it. Models that are developed using experiments accurately describe the forced response behavior of a structural component, but are often disregarded due to the time required to test a sufficient number of degrees of freedom. On the other hand, finite element models can be developed with large numbers of degrees of freedom, but there are uncertainties associated with many aspects of these numerical models (e.g., damping, variability in manufacturing). Furthermore, finite element models should be validated, a process which usually requires an extensive number of experiments.

Passive structural health monitoring (SHM) techniques have been applied using structural models, which describe the baseline condition of the structure prior to the onset and growth of damage. For linear structures subjected to external loading, the inability to measure the input forces prohibits passive health monitoring systems from updating the system model to account for 1) changes in boundary and environmental conditions or 2) alterations in material properties caused by damage. This document presents a novel method for passively updating the frequency response function (FRF) model of a linear structural component to account for changes in material properties due to damage if certain assumptions about the input forces can be made. Because forced response models that describe the structural input-output behavior are identified before and after the onset of damage when using this new method to update the FRFs, active damage identification techniques, i.e., techniques that utilize the difference between the damaged and healthy FRFs or shifts in the modal frequencies, can be implemented to quantify damage. Active damage identification strategies, such as the two aforementioned techniques, usually provide a more meaningful measure of damage than purely passive techniques, and the robustness of passive SHM greatly improves with the ability to update the FRFs and employ active damage detection techniques that normalize response data with respect to input data.

Indirect (passive) force estimation, which is the determination of the external forces acting on a structure by measuring only the response of the structure, is a well-studied inverse problem. The benefits of passive force estimation include the ability to warn maintenance crews that a load capable of damaging the structure has occurred, and indirect force estimation can also locate the point of application of the load for further inspection. The difficulty of passive force estimation is that the number of forces acting on a structure often outnumbers the response measurements leading to an underdetermined set of governing equations. An underdetermined set of equations yields non-unique force estimates. However, if certain assumptions about the input forces are valid and the techniques described in this document are applied, forces on a structure with an underdetermined system of governing equations can be accurately located and quantified.

### SUMMARY OF THE INVENTION

Various aspects of the present invention pertain to the identification of at least one of the location or magnitude of an unknown force acting on an object by the use of an experimentally-derived model of the object.

In one embodiment of the present invention discussed herein a model of the structure was generated using experimentally acquired frequency response function (FRF) measurements. This model was then used to identify external impacts acting on the structure. In practice, such impacts could occur at any location on the structure and not just those that were tested. To solve for the location of an impact, the experimental model of the structure was refined by spatially interpolating the measured FRFs at each frequency. This model was then inverted using an iterative least squares technique and used to recreate FRFs at each location. The recreated FRFs were then compared to those in the model to identify the impact location.

One aspect of the present invention pertains to a method for estimating an unknown load on an object. Some methods include preparing an experimental model of the object that relates the spatial response at one location to a known load applied anywhere on the object. Yet other embodiments include impacting the object with an unknown load and measuring the spatial response of the object at the location to the unknown load. Still other embodiments include using the previously measured responses to predict a hypothetical load at one or more sites on the object and selecting at least one of the hypothetical loads as an estimate of the unknown load.

Another aspect of the present pertains to a method for estimating an unknown load on an object. Some embodiments include placing a sensor at a predetermined sensing location on an object, establishing a plurality of testing sites on the object, exciting the object at a testing site with the test load, and measuring the response of the object. Yet other embodiments include storing the responses in memory, and using the stored test load responses to predict a plurality of hypothetical loads each at a different one of the sites.

Still another aspect of the present invention pertains to a method for estimating an unknown load on an object. Some embodiments include preparing an experimental model of the object that relates the spatial response in at least two orthogonal directions on the object to a known load applied on the object. Other embodiments include impacting the object with an unknown load, and measuring the spatial response of the object to the unknown load. Still other embodiments include using the measured response and predicting a hypothetical load, and using the hypothetical load in the model to predict a hypothetical spatial response at another location on the object. Yet other embodiments include comparing the measured spatial response to the hypothetical spatial response.

It will be appreciated that the various apparatus and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is excessive and unnecessary.

### BRIEF DESCRIPTION OF THE DRAWINGS

FIG. 1(a). Flowchart indicating the steps involved in a health monitoring system according to one embodiment of the present invention.

FIG. 1(b) is a schematic representation of an object being tested according to one embodiment of the present invention.

FIG. 1(c) is a schematic representation of the objection of FIG. 1(b) as modified to include interpolated test locations.

FIG. 1(d) is a flowchart representing a method according to one embodiment of the present invention.

FIG. 1(e) is a flowchart representing a method according to yet another embodiment of the present invention.

FIG. 2. Carbon filament wound canister in (a) the simulated free-free boundary condition and with (b) the attached actuator and sensor.

FIG. 3. The mean of the absolute value of the difference of the interpolated and measured FRFs for the interpolated locations summed between 400 to 2500 Hz versus the number of experimental measurement locations between which interpolations were made.

FIG. 4. Comparison of FRFs interpolated longitudinally on the missile casing using (a) cubic splines and (b) sines and cosines.

FIG. 5. Normalized similarity values calculated over the surface of the canister for an impact at a longitudinal position of 10 and a circumferential angle of 90°. The color indicates the likelihood of the impact point with white being the most likely impact location.

FIG. 6. Experimental and reproduced time histories for a sample impact (a) during the impact event and (b) over the entire acquisition period.

FIG. 7. Sensor and actuator configuration used for NWMS. Also shown in this image is a PCB 712A02 actuator which was not used for the data presented here. The impact location is denoted with a white cross in (b) which is just above the crack location shown in image (c).

FIG. 8. Acquired FRFs for the pristine canister, and the three operating conditions that were used for the damaged canister for (a) the R-direction, (c) the θ-direction, and (d) the Z-direction. The top right image (b) is an enlarged image of the second mode of the system in the R-direction.

FIG. 9. The power spectral densities for the acceleration measurement using IM.

FIG. 10. The modulation ratio created by subtracting the median of the response between 58.5 kHz and then dividing the sum of the frequency content between 58.5 and 59.5 kHz by the sum of the content from 59.995 and 60.005 kHz plotted on a log scale.

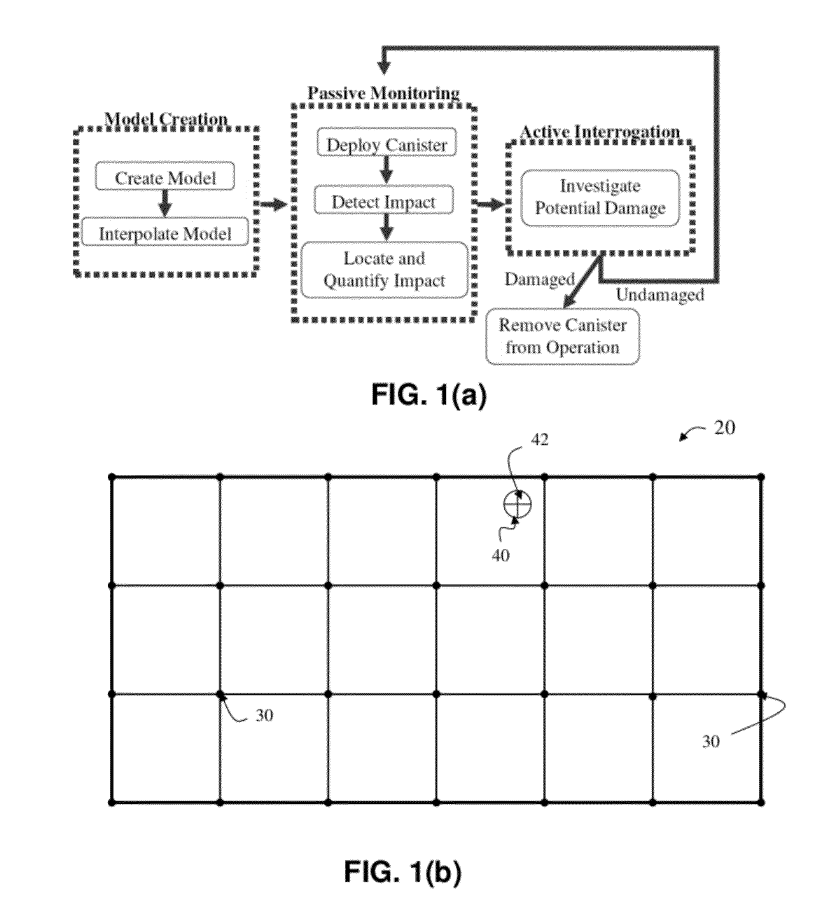

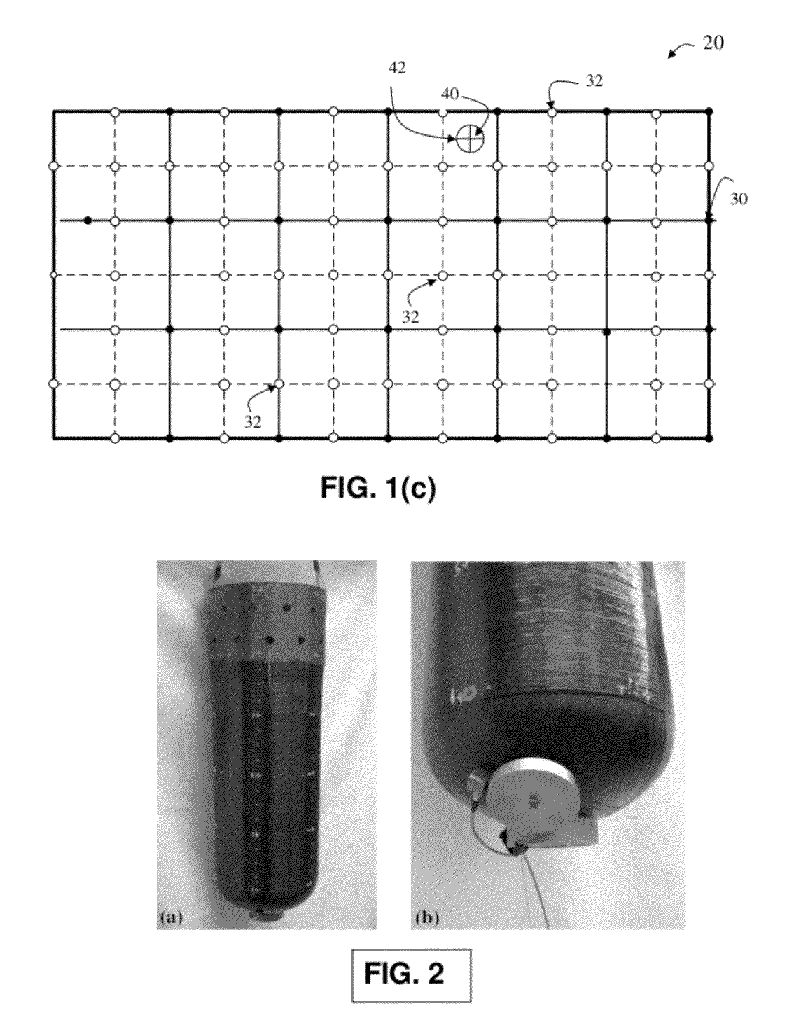

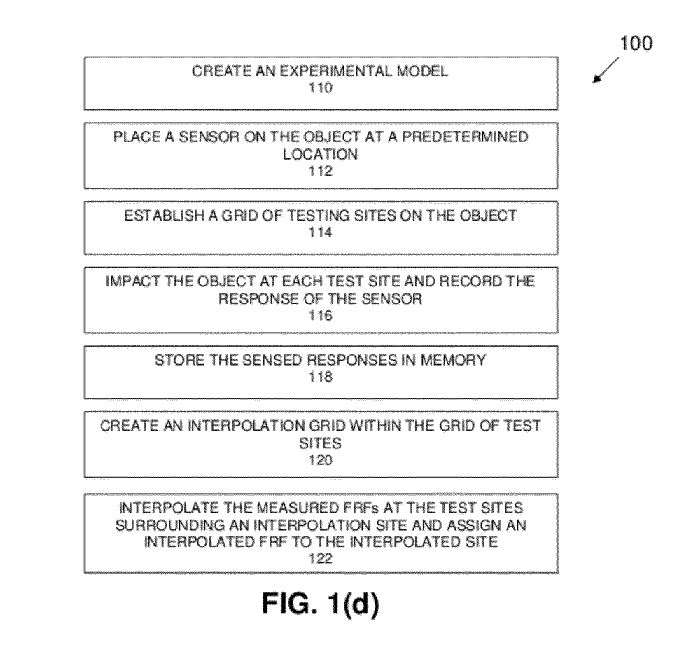

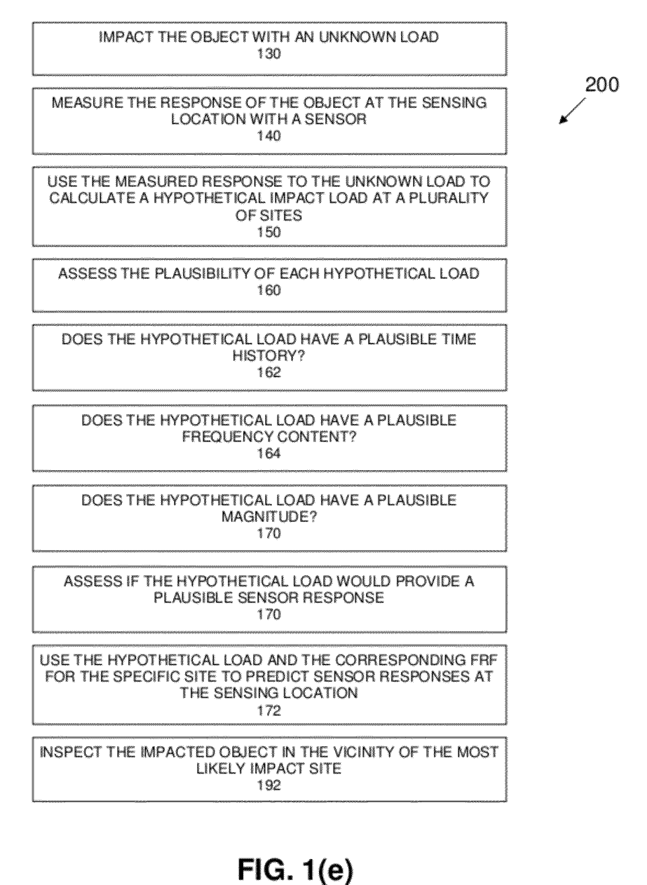

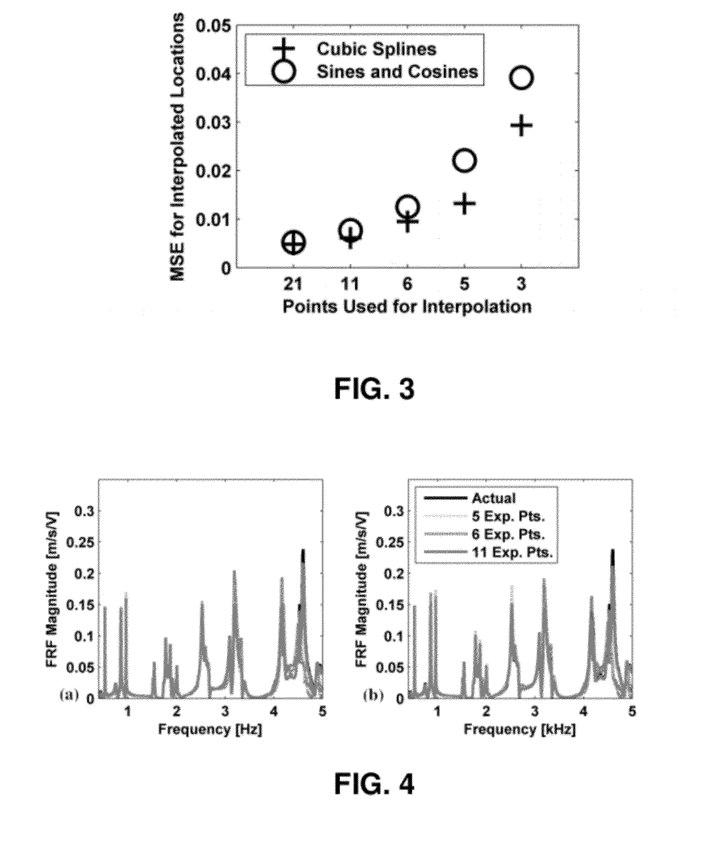

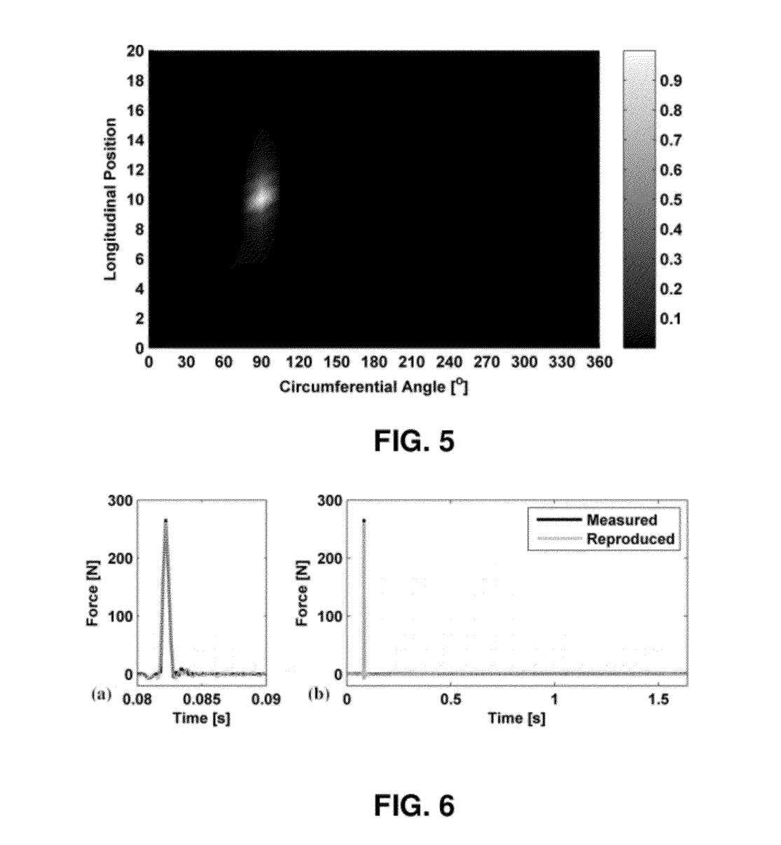

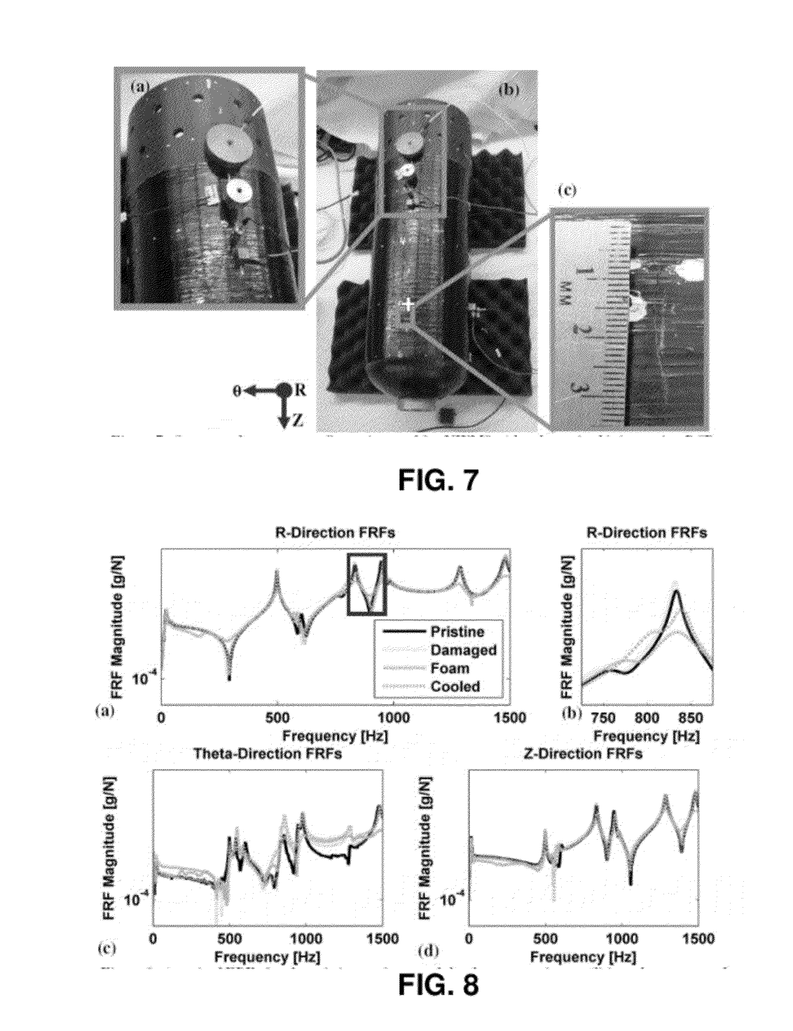

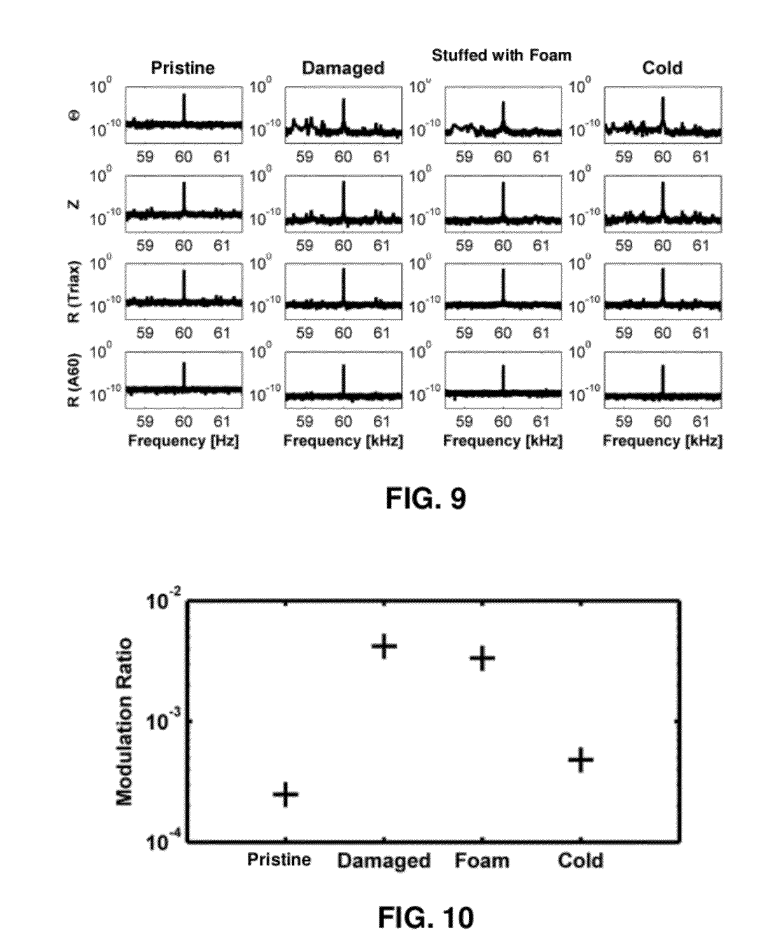

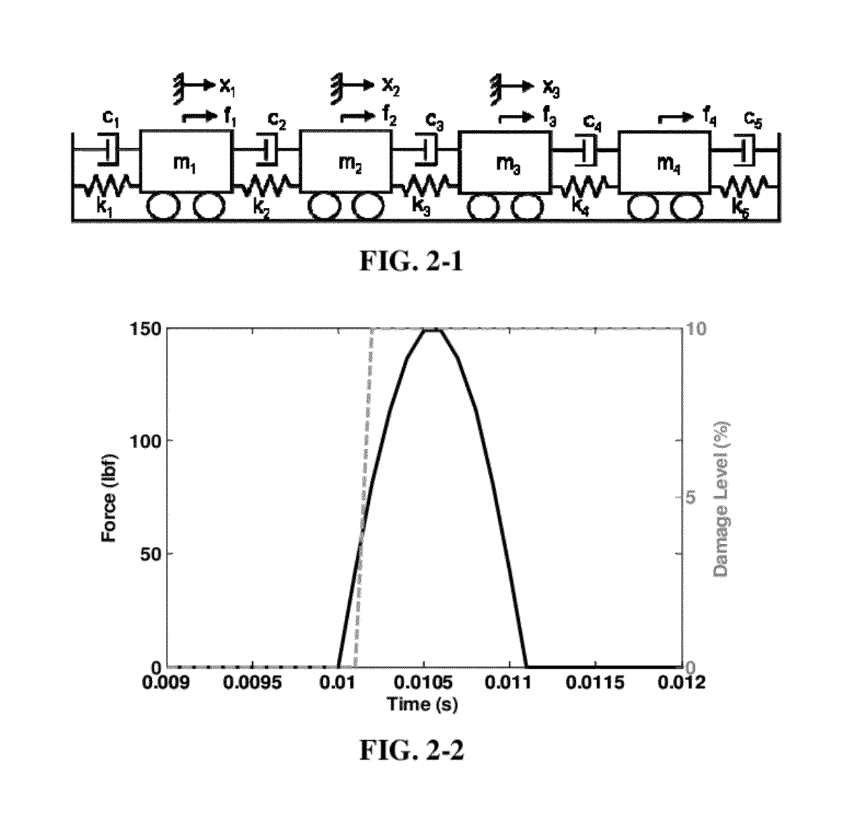

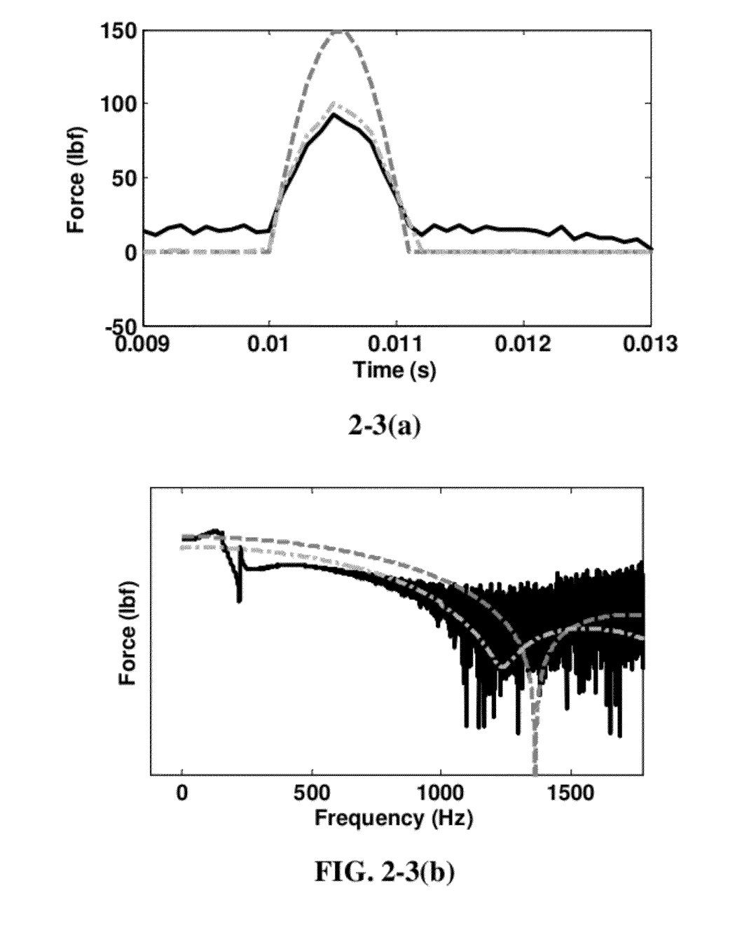

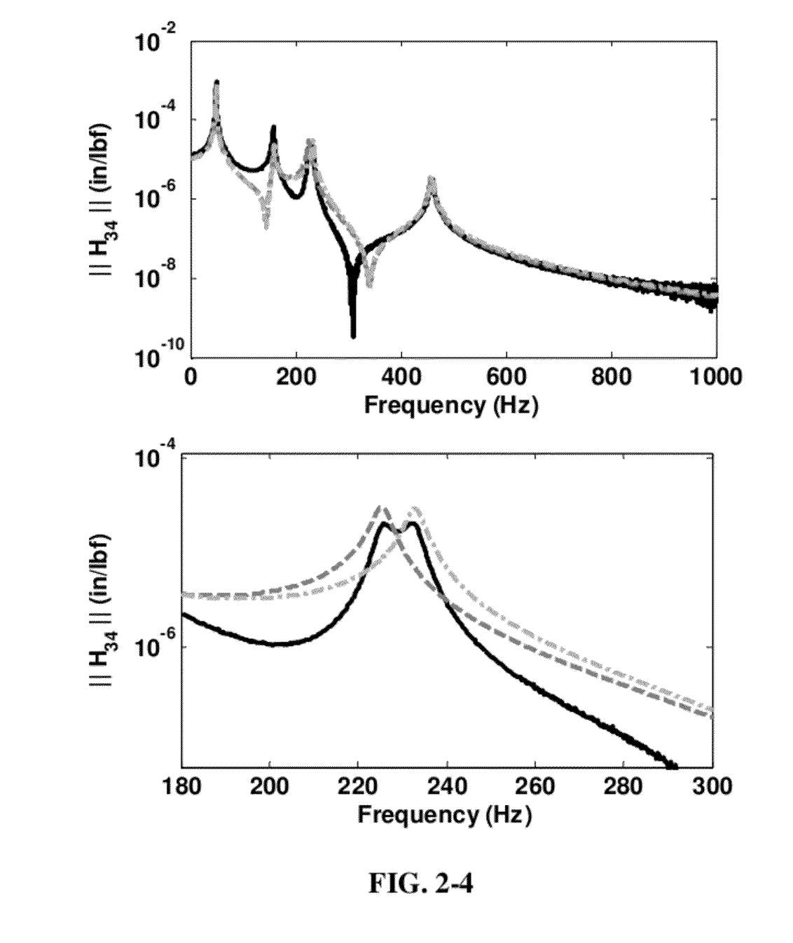

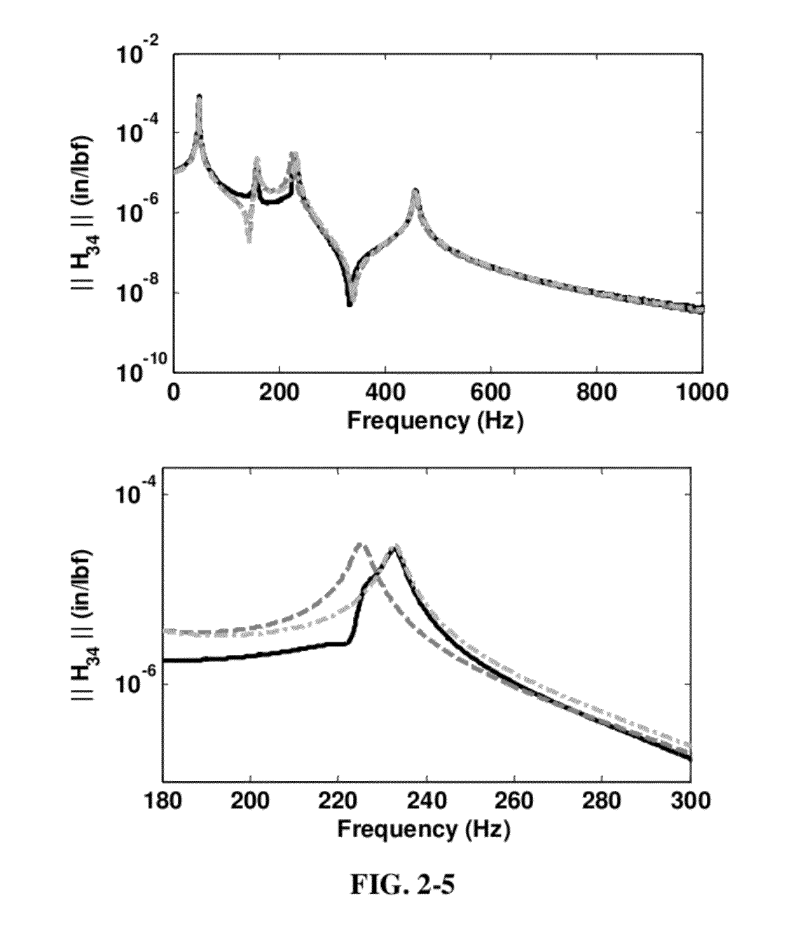

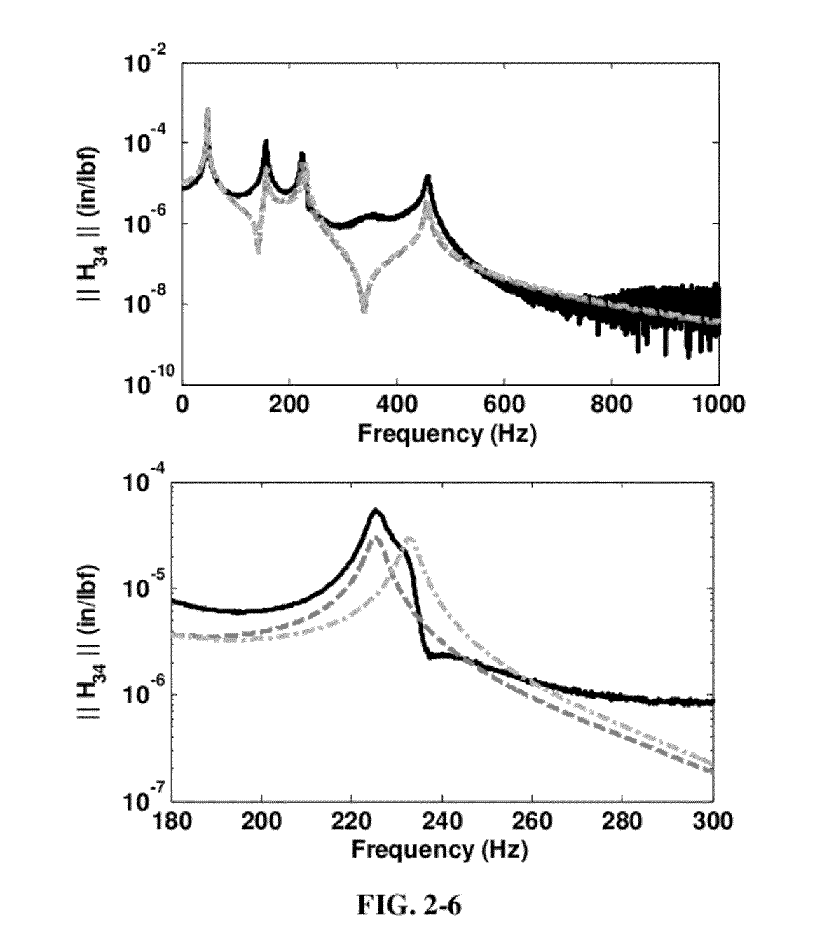

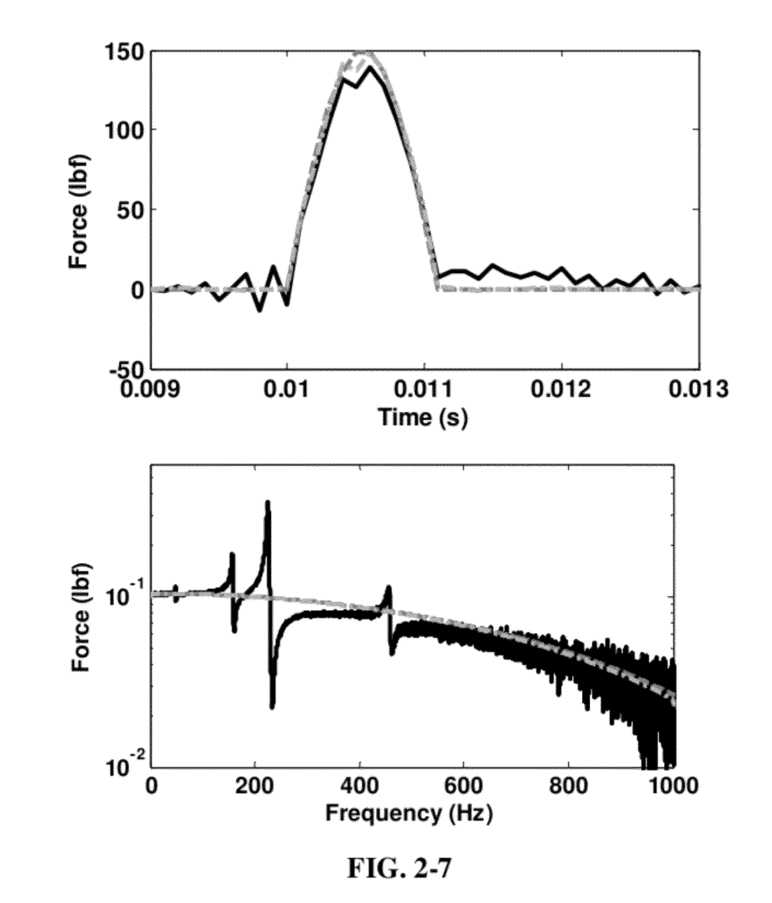

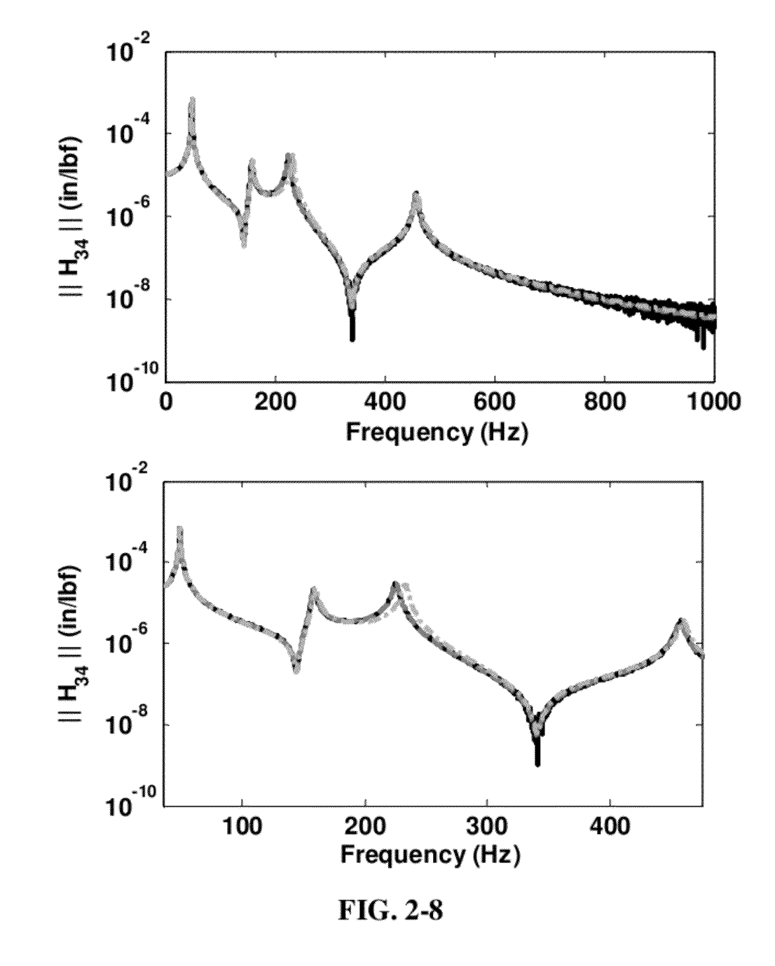

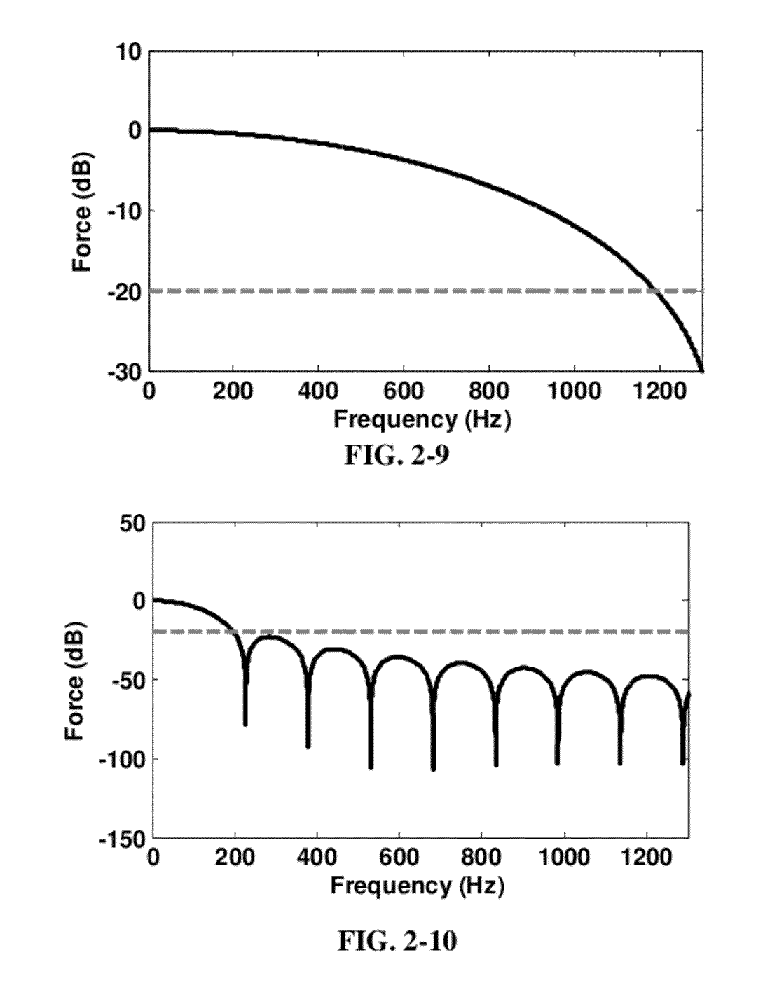

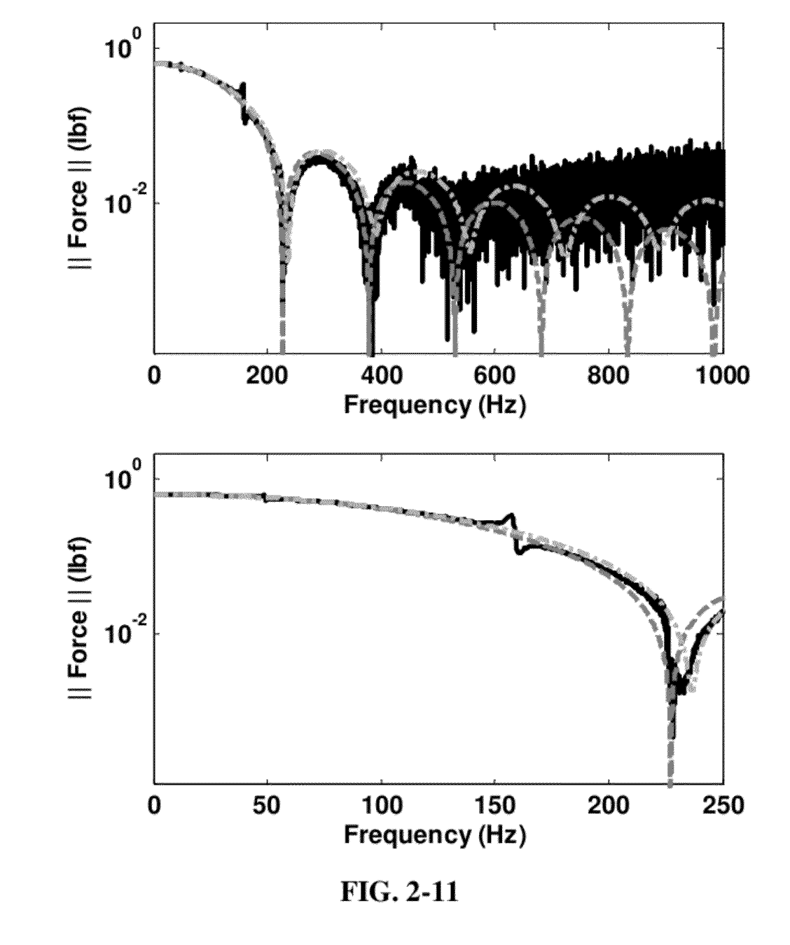

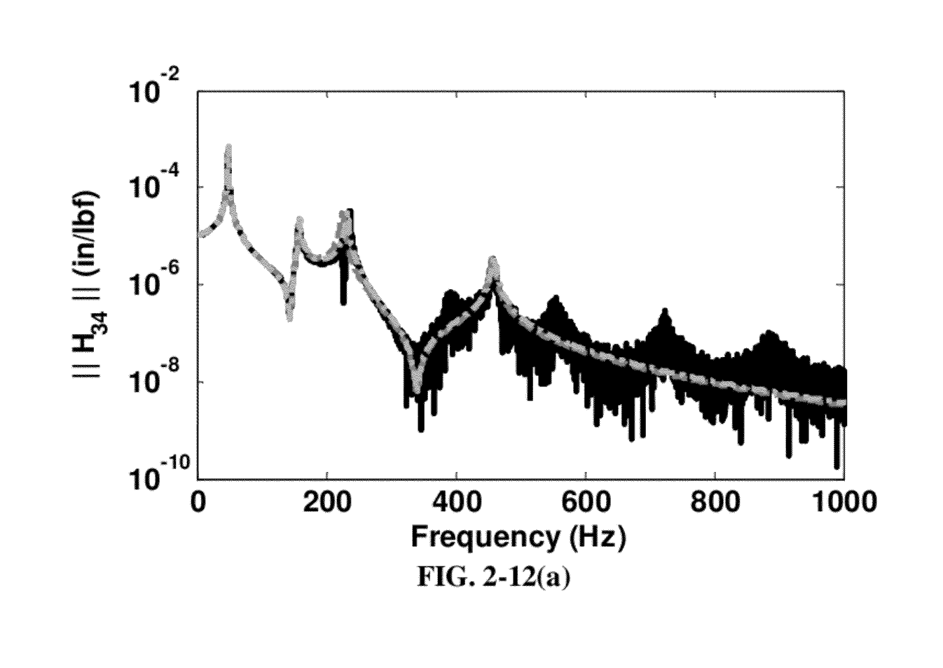

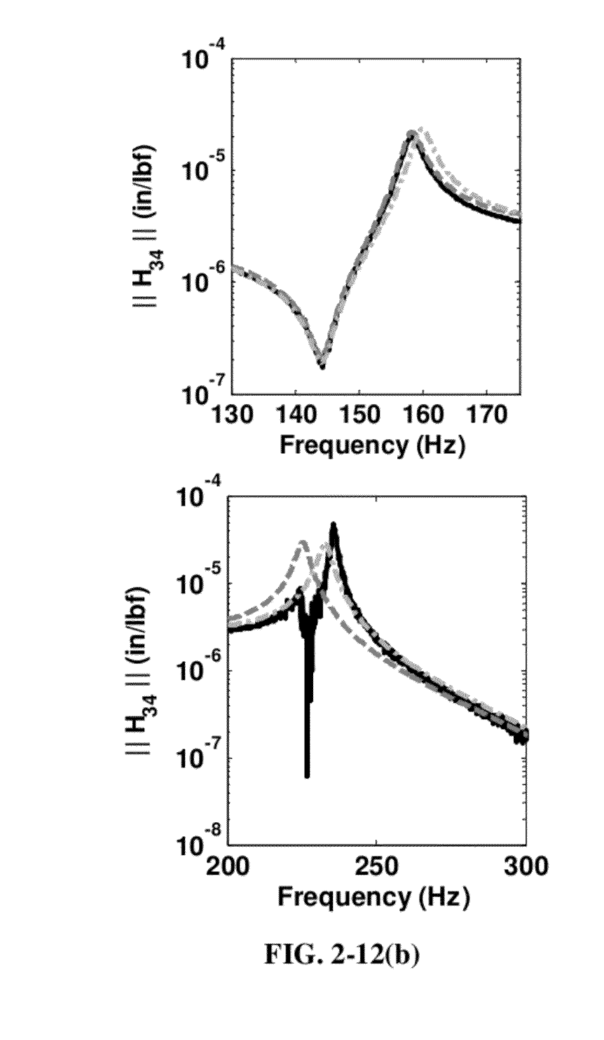

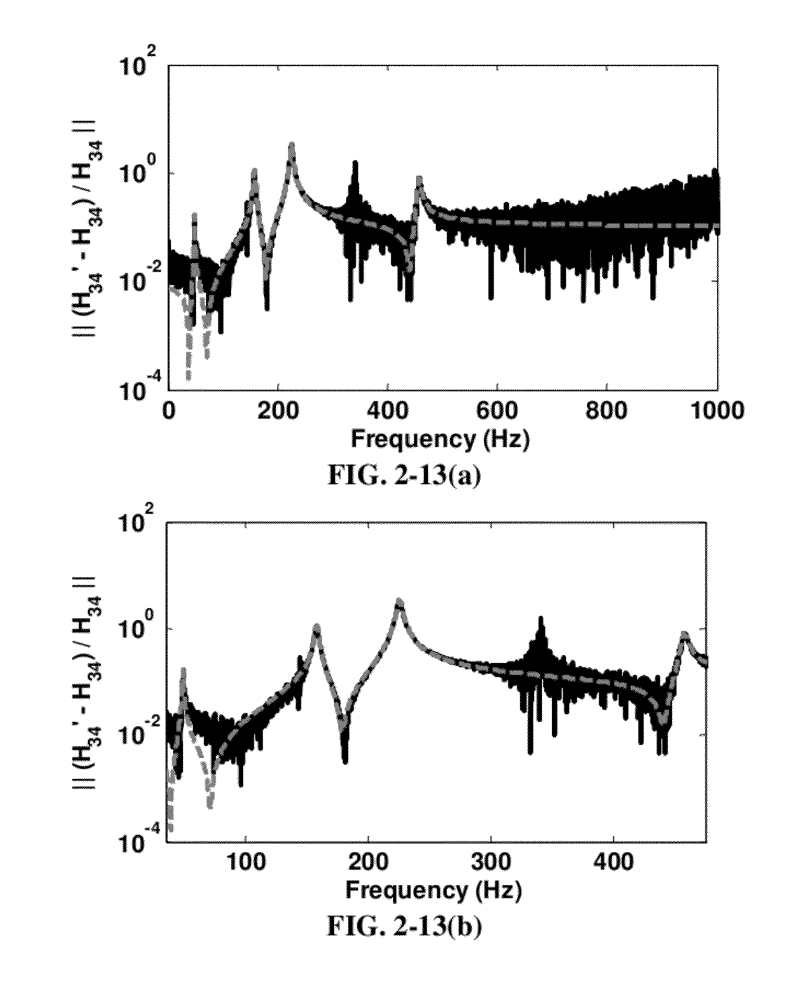

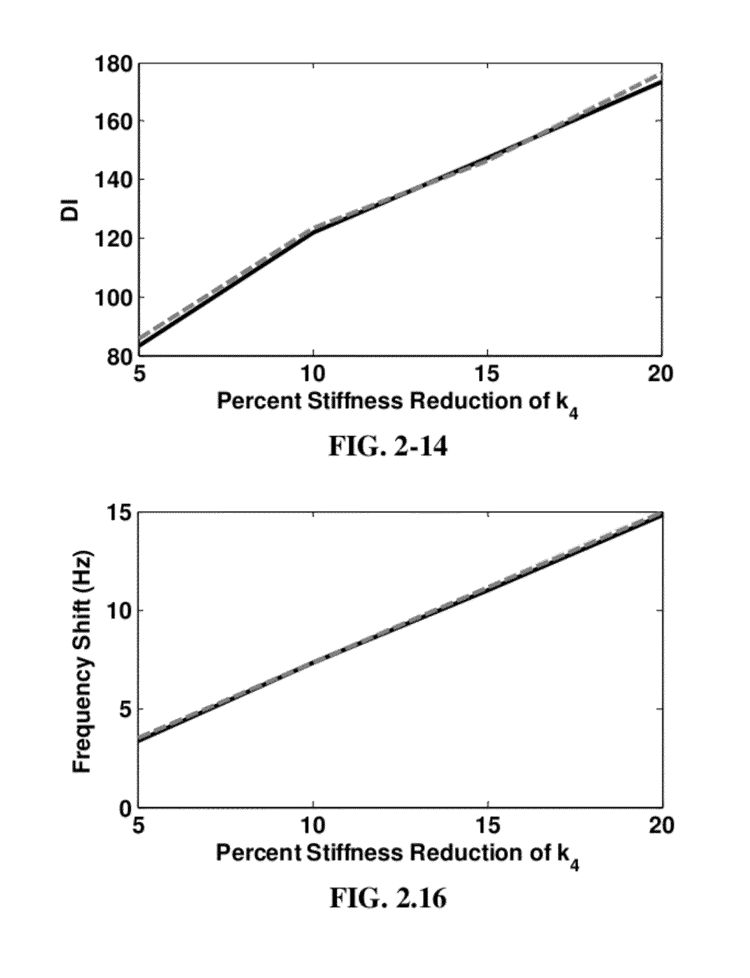

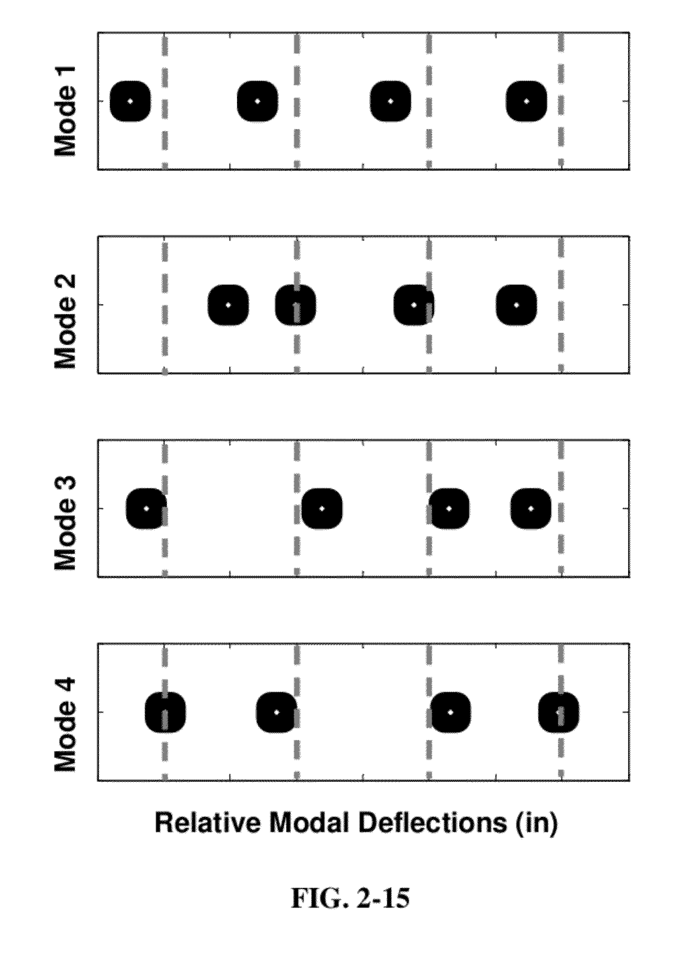

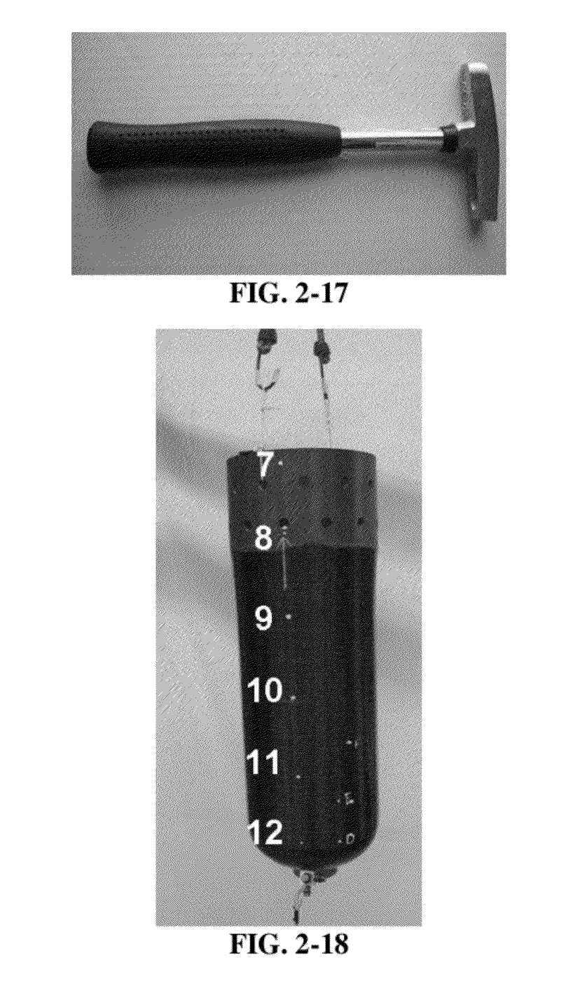

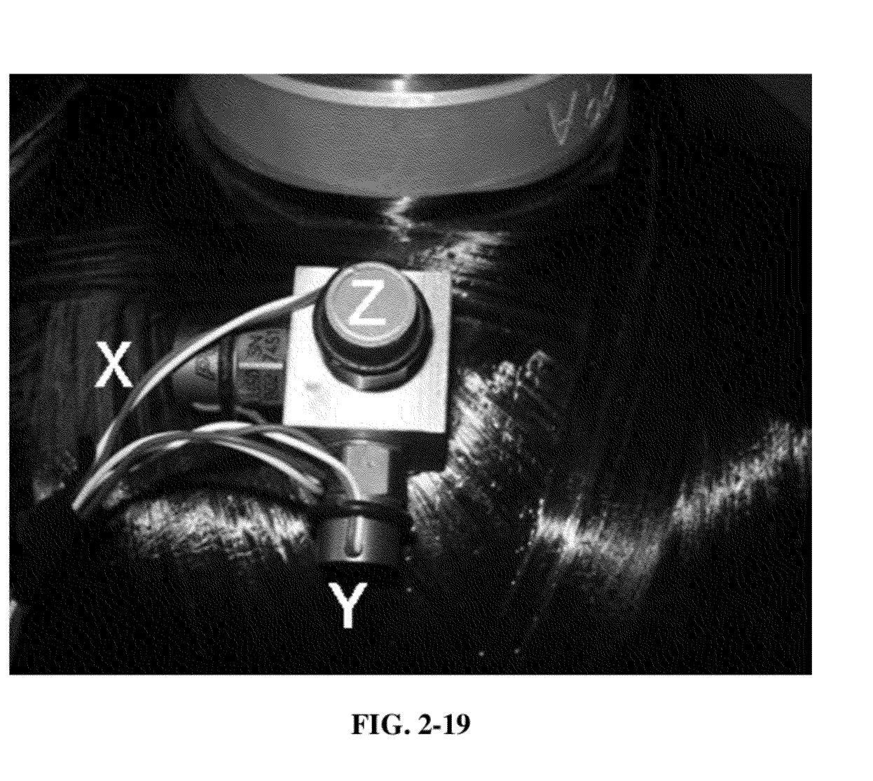

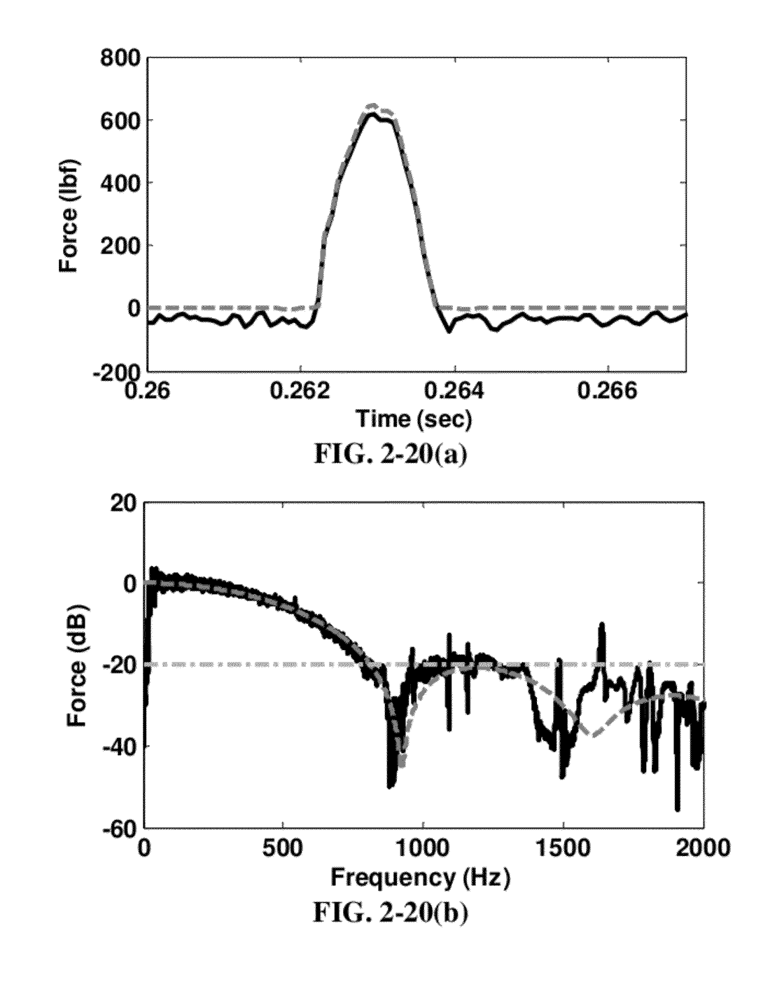

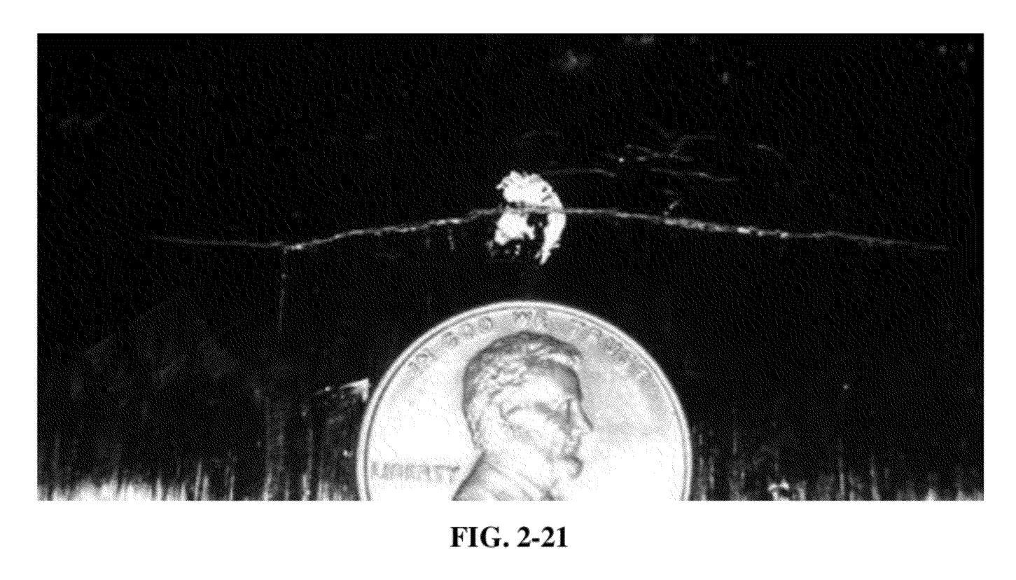

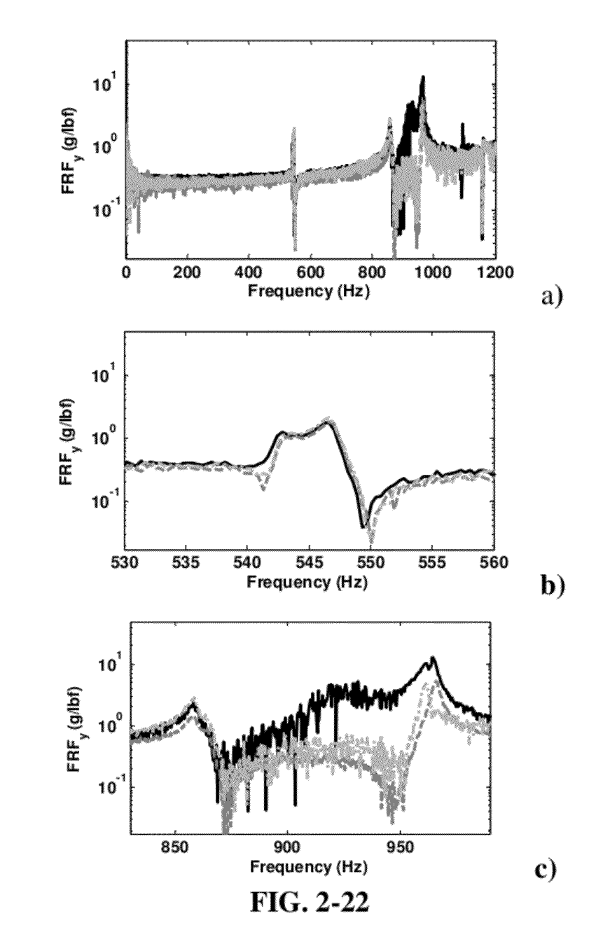

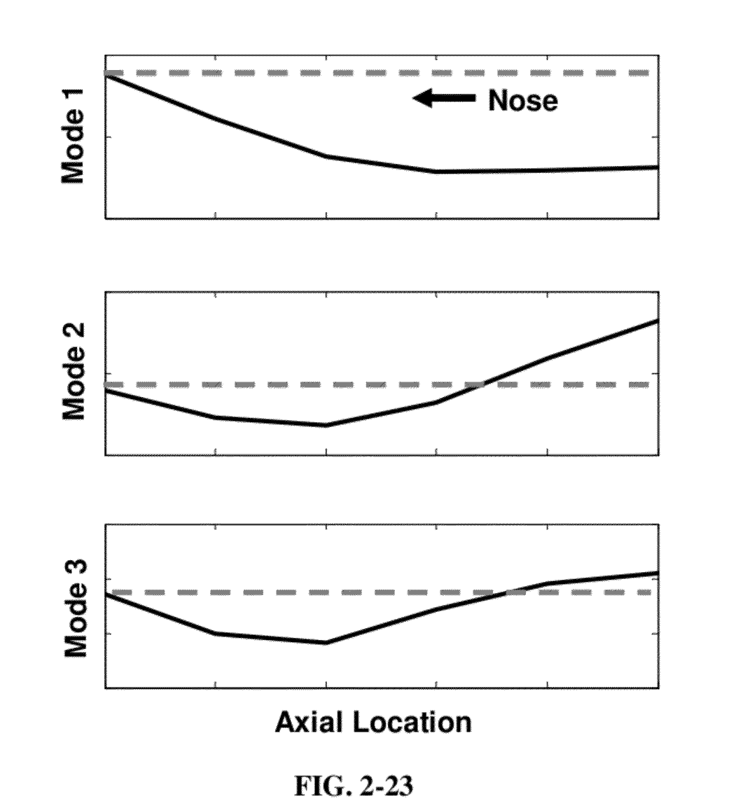

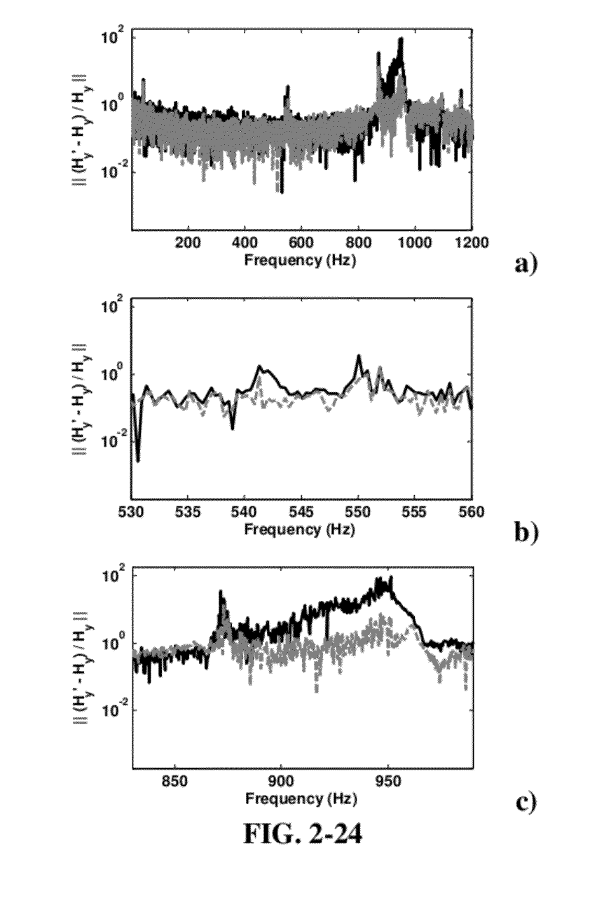

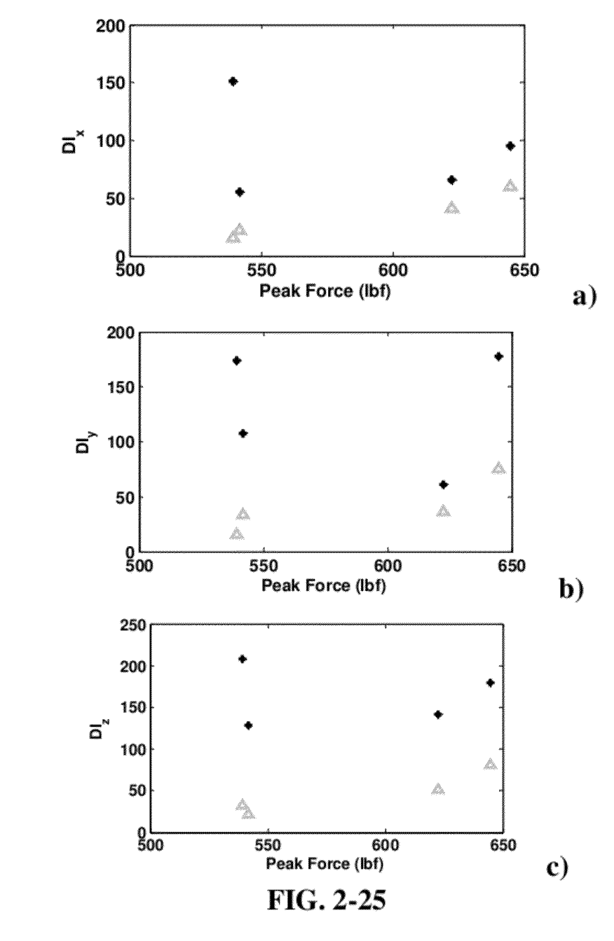

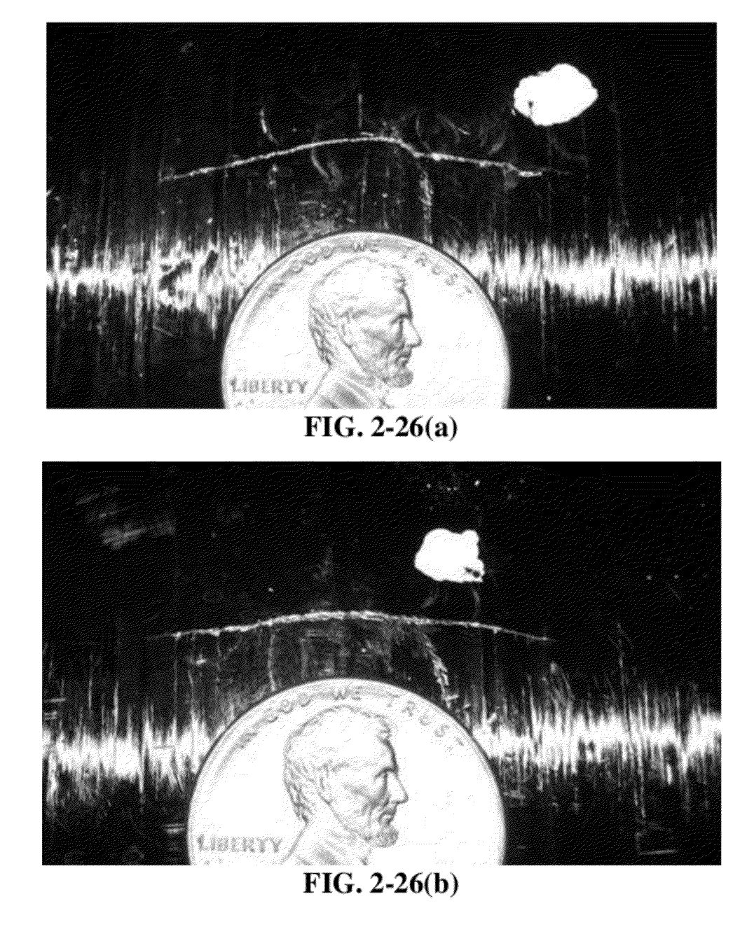

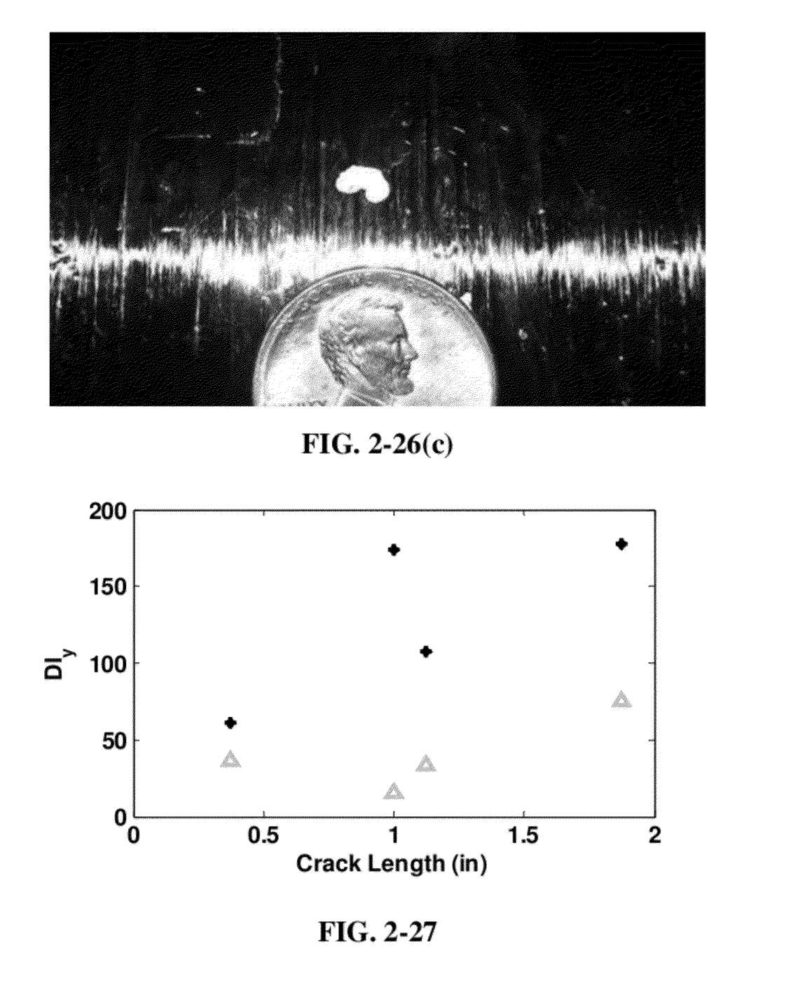

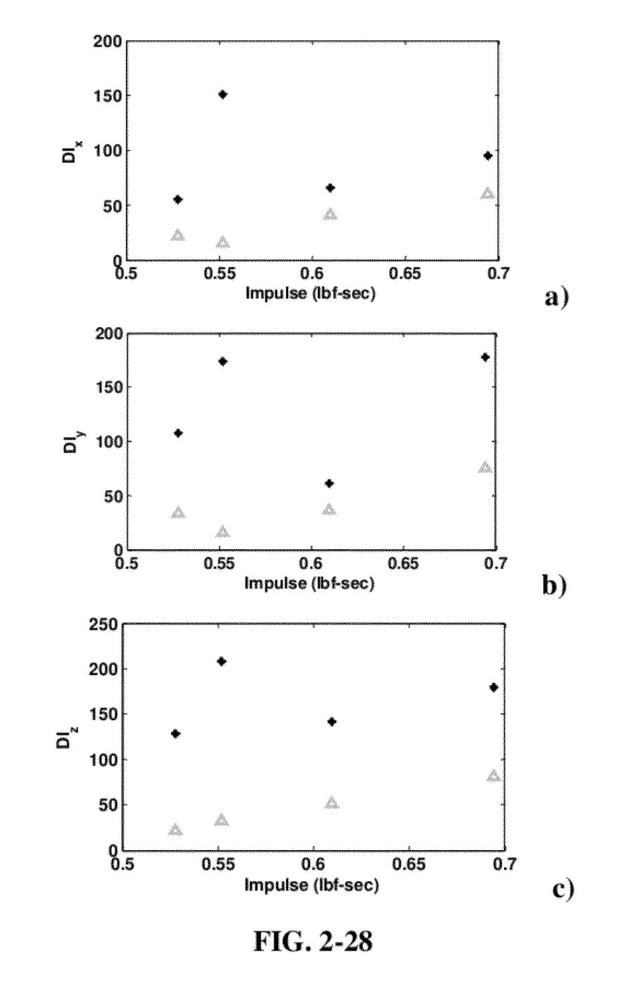

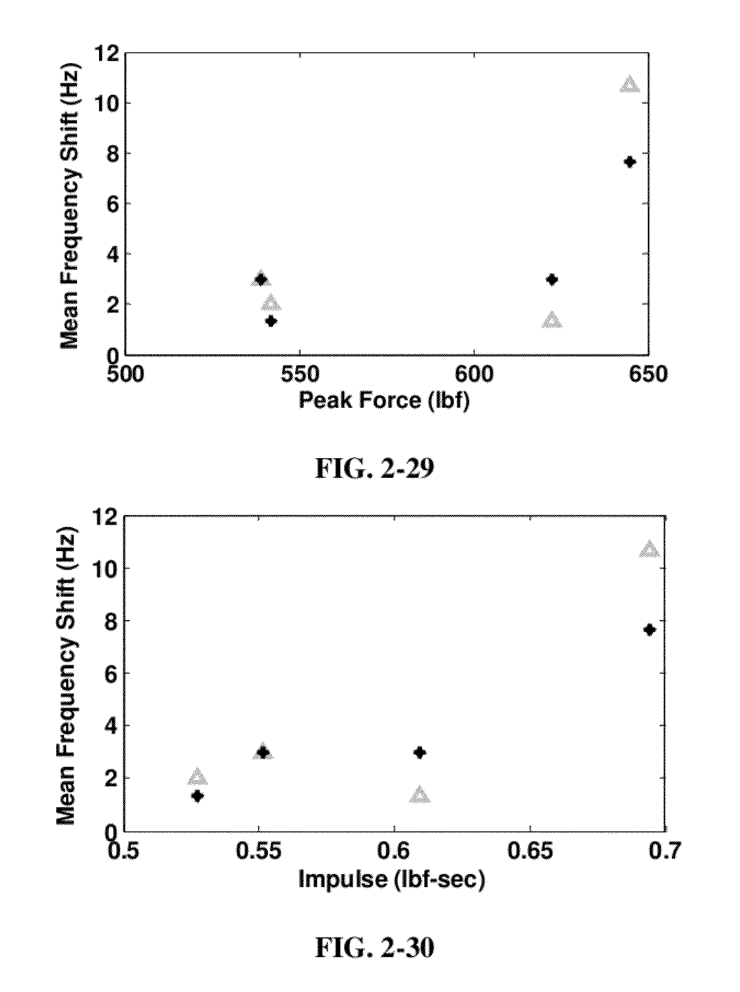

FIG. 2-1: Four-degree-of-freedom model with underdetermined system of equations of motion.

FIG. 2-2: Relationship between the applied force (line) and the damage level (dashes) of k₄ for the 4-DOF model.

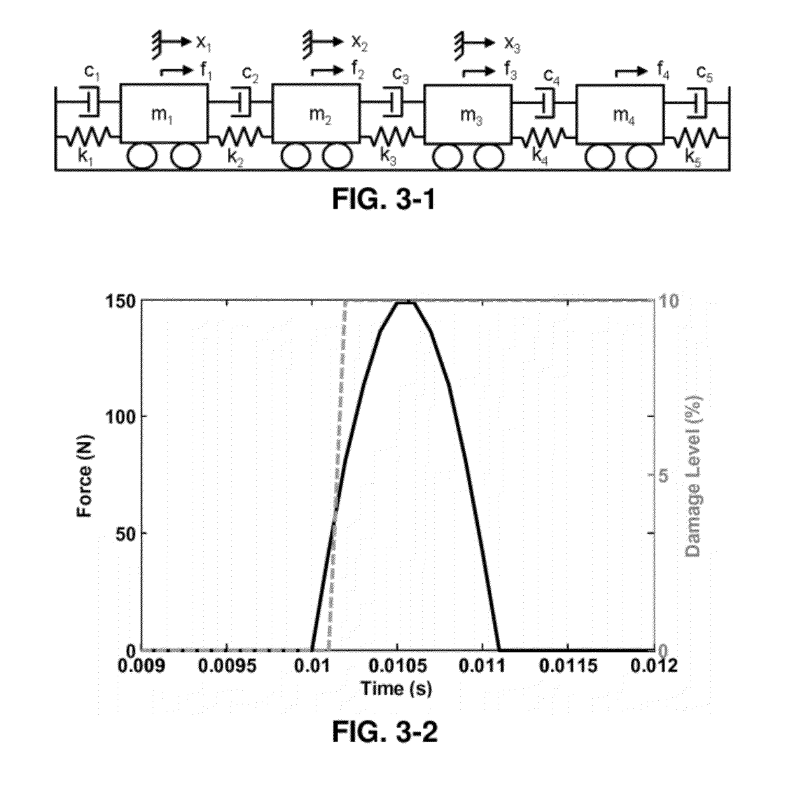

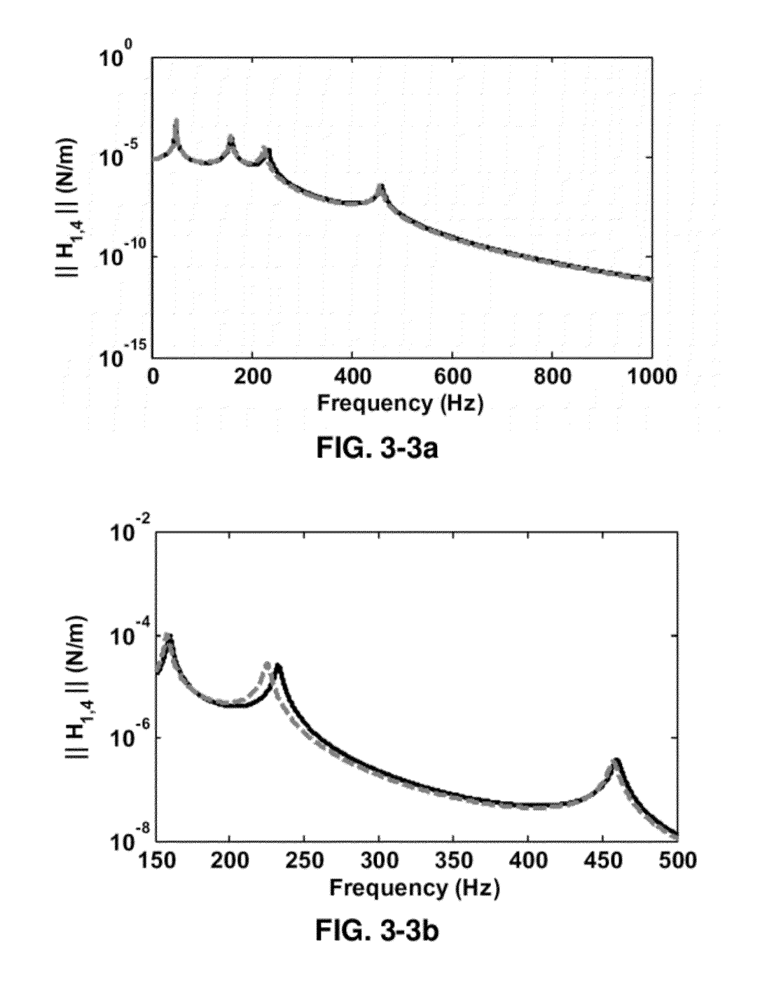

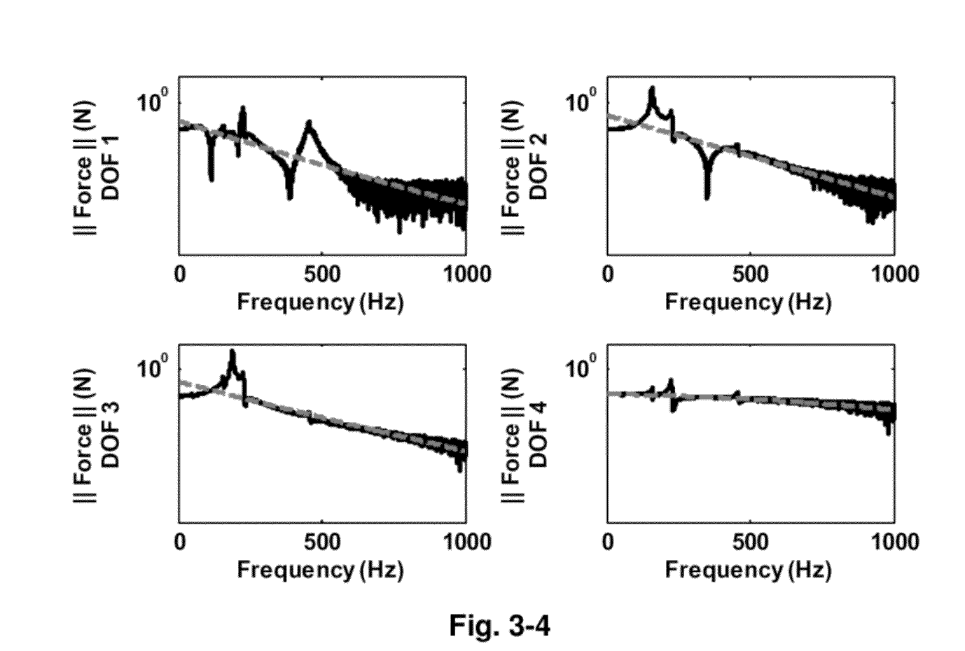

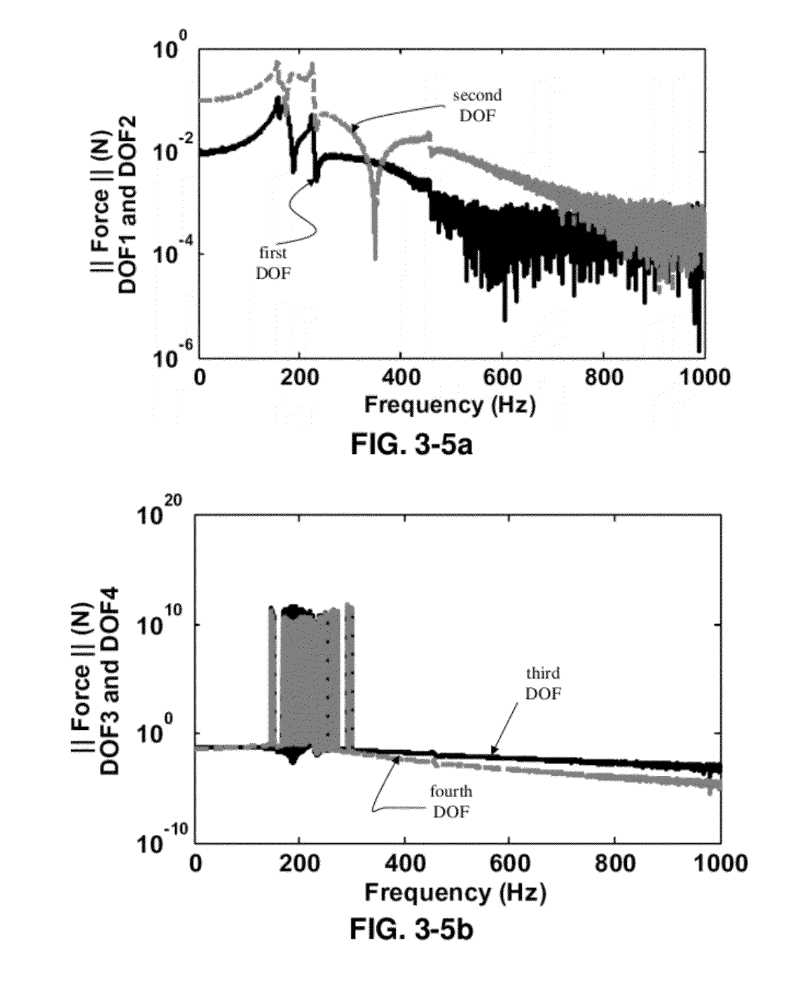

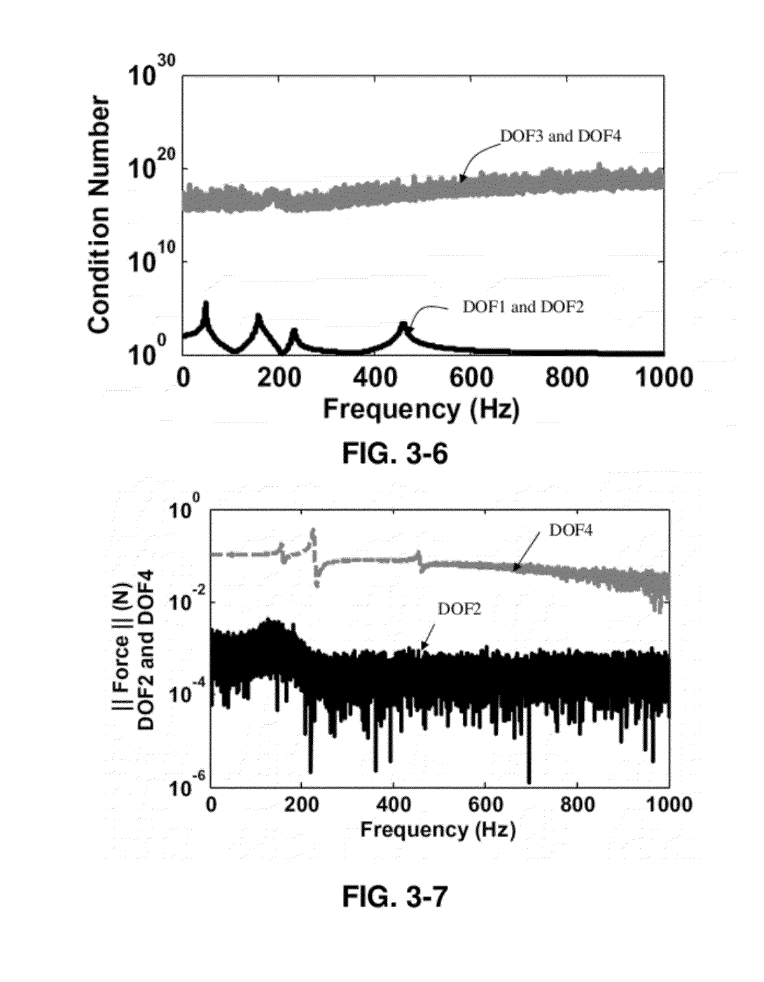

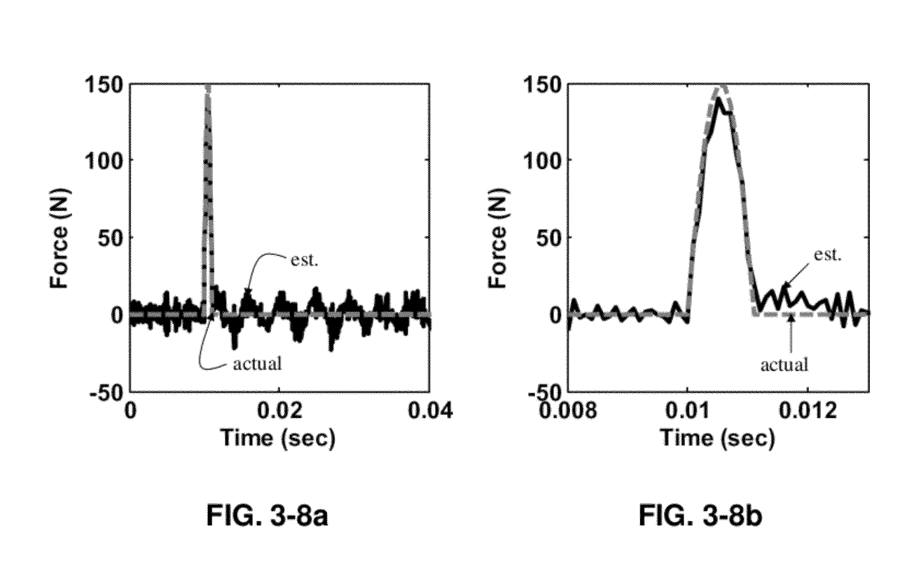

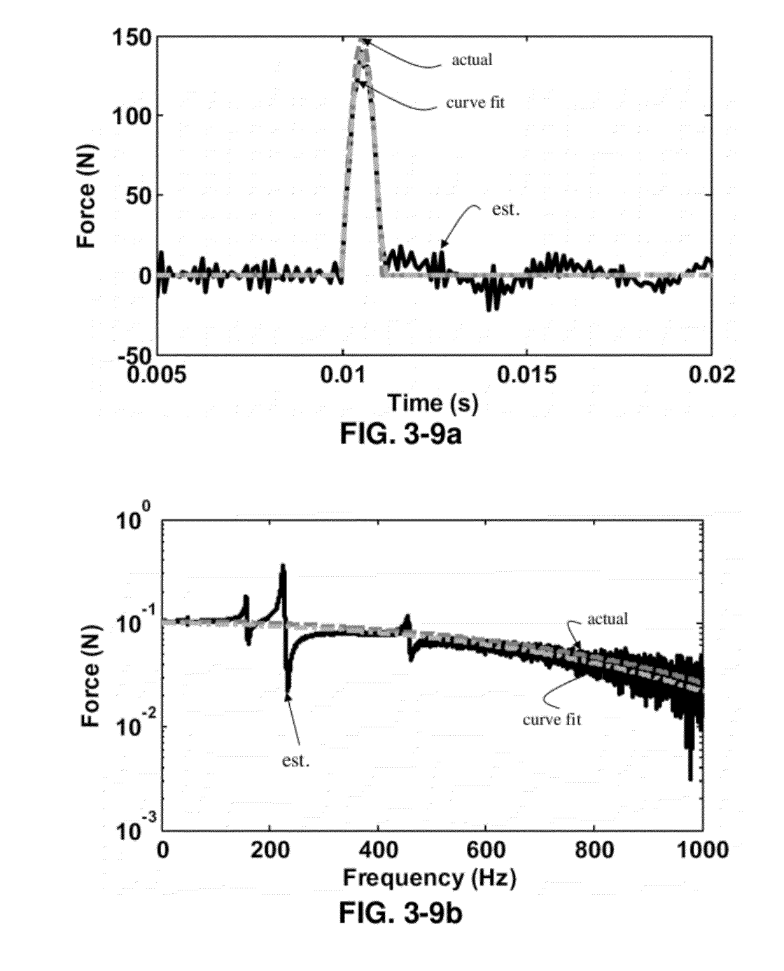

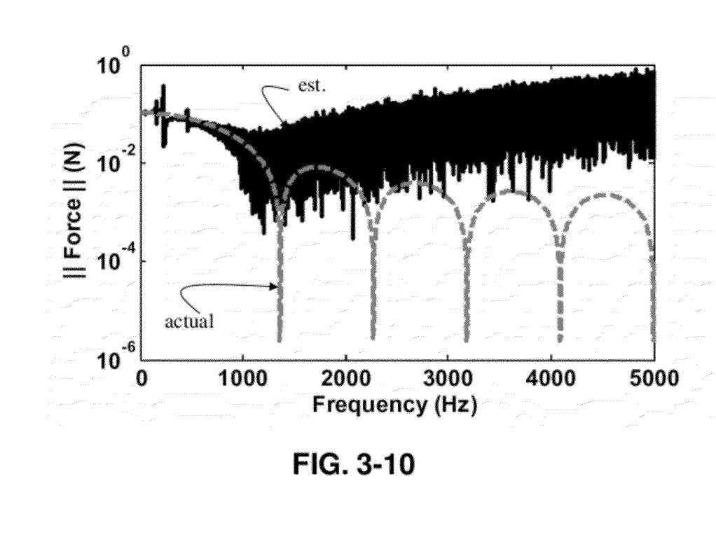

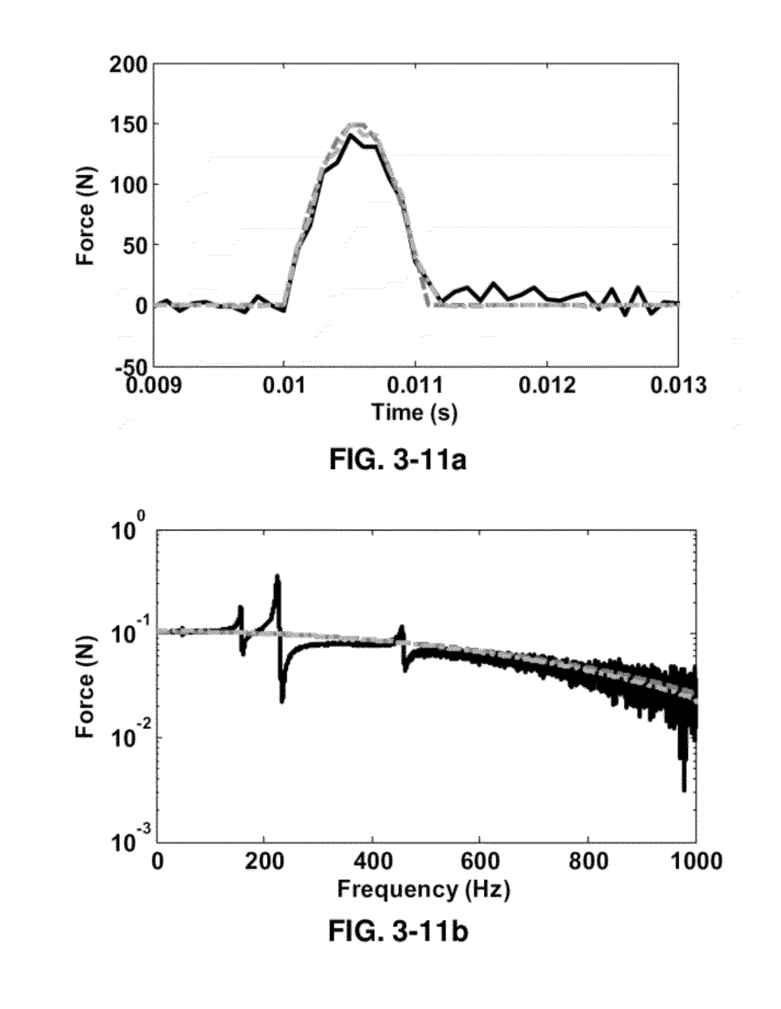

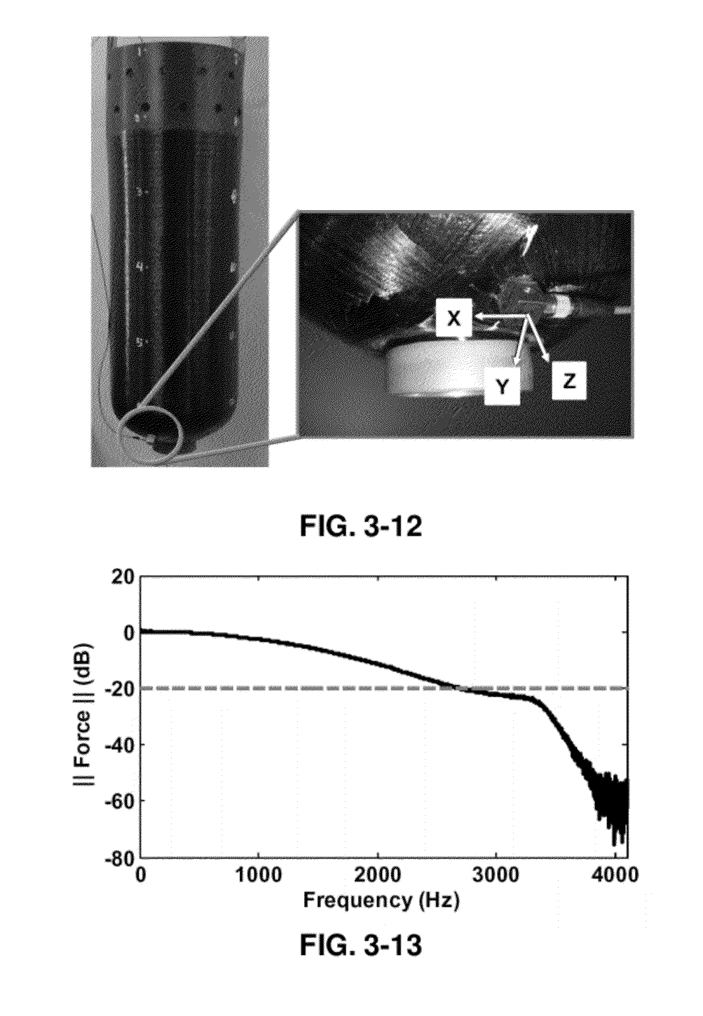

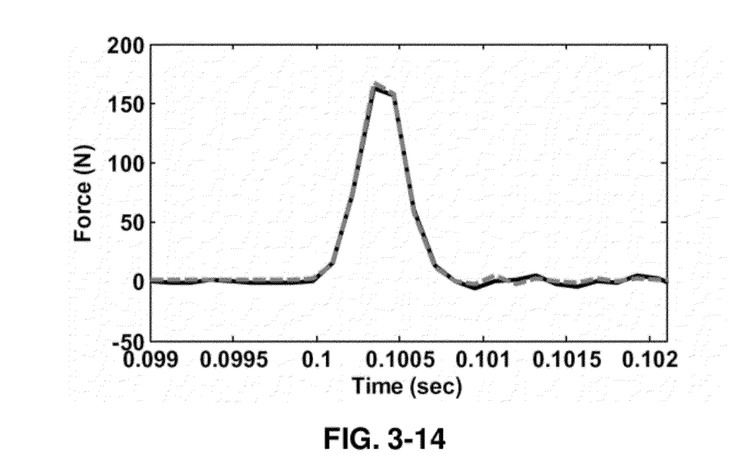

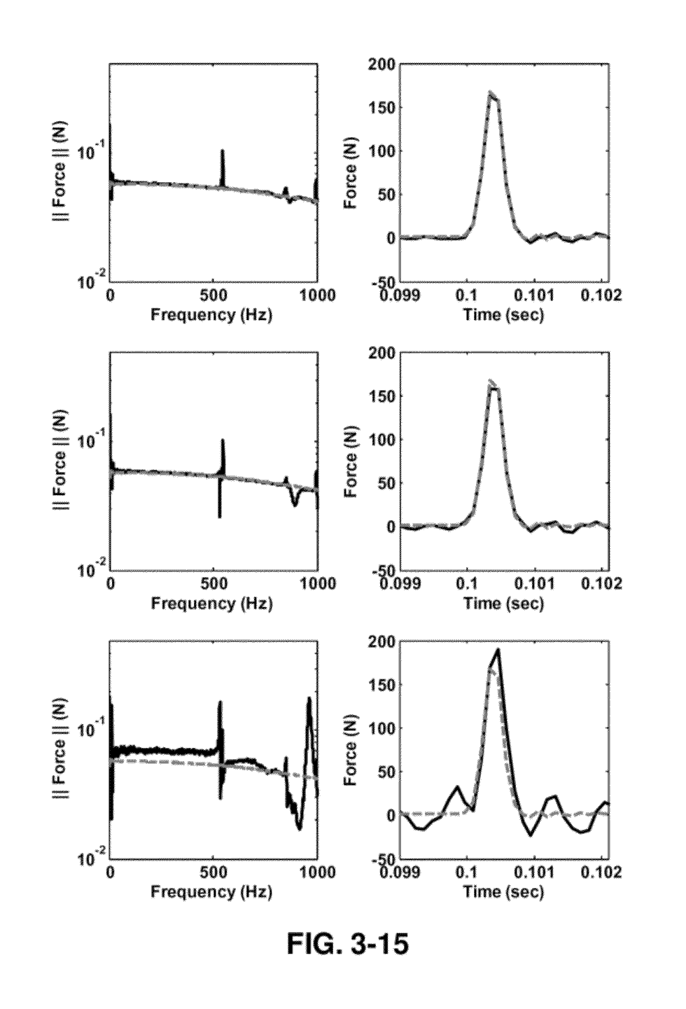

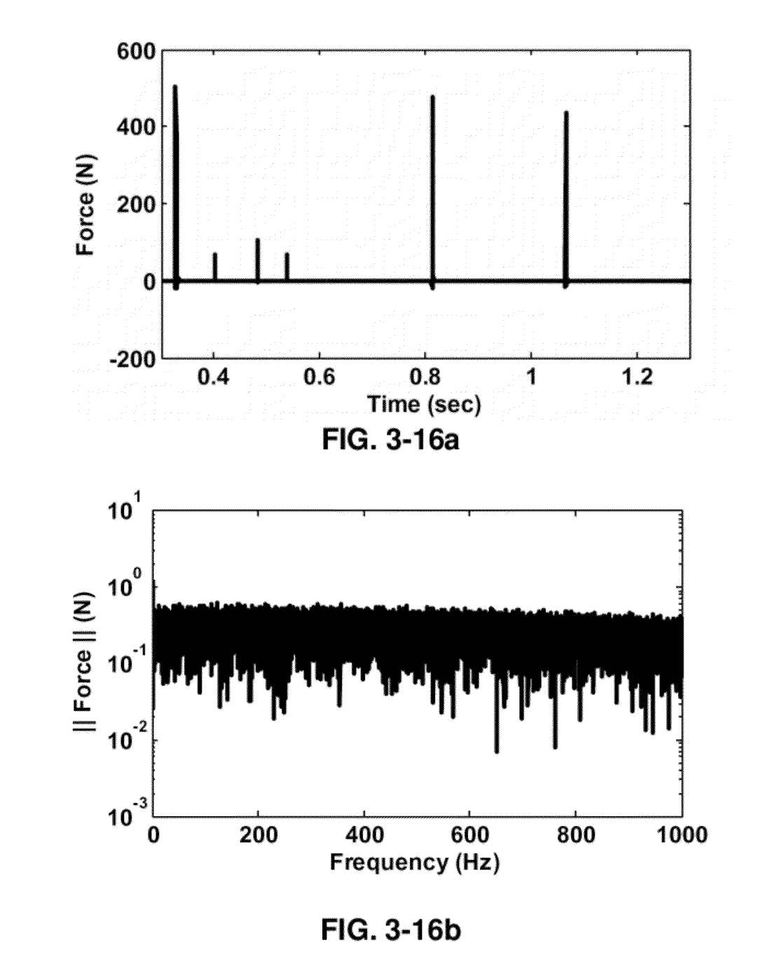

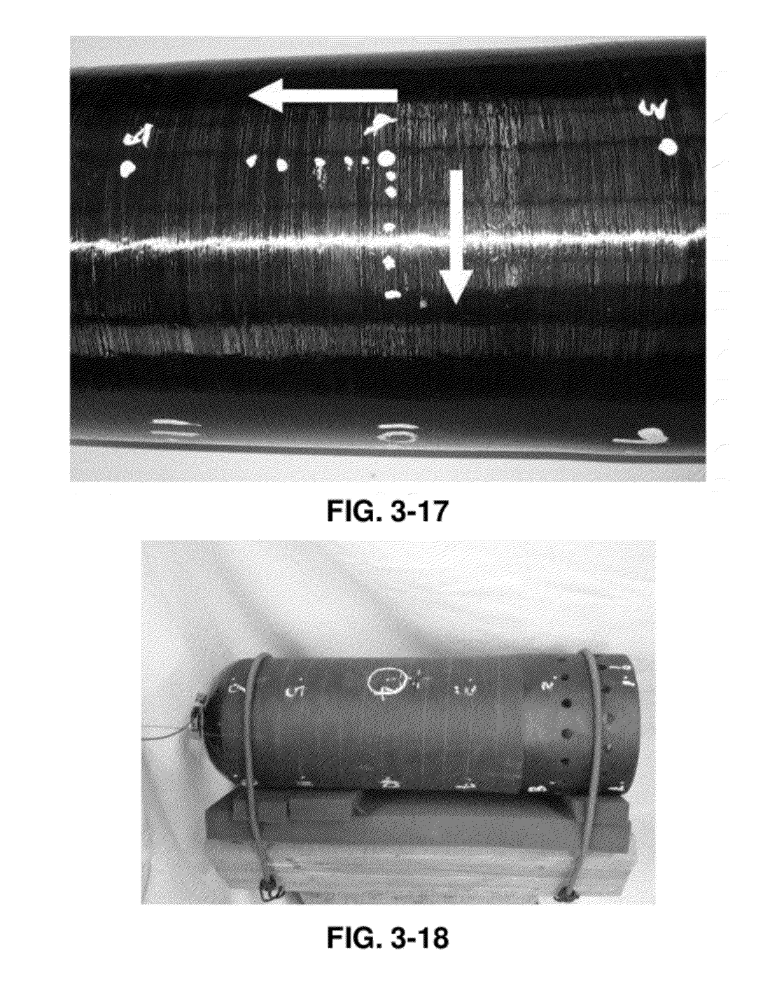

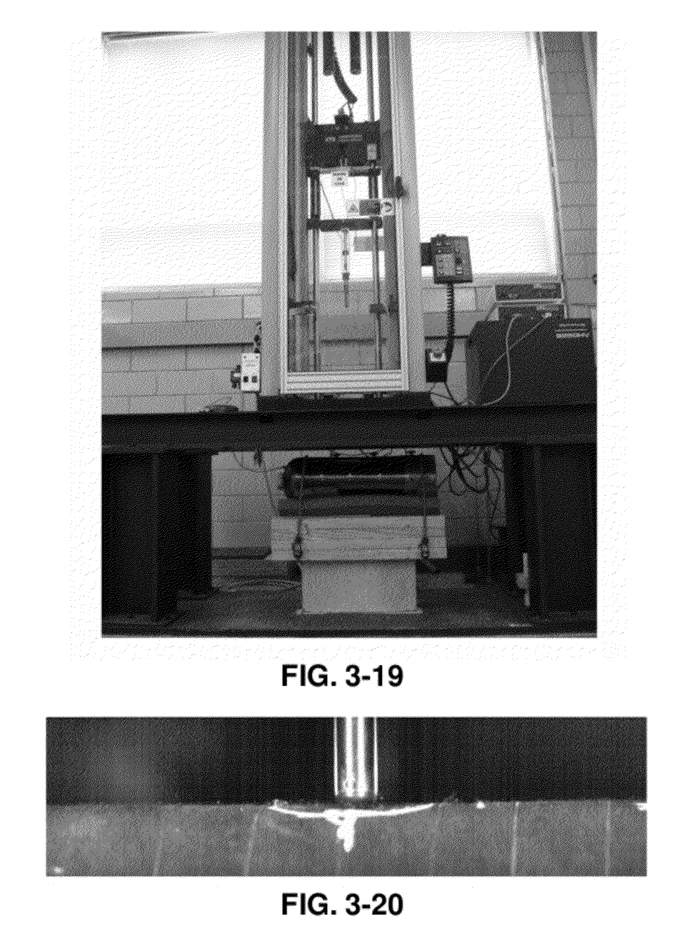

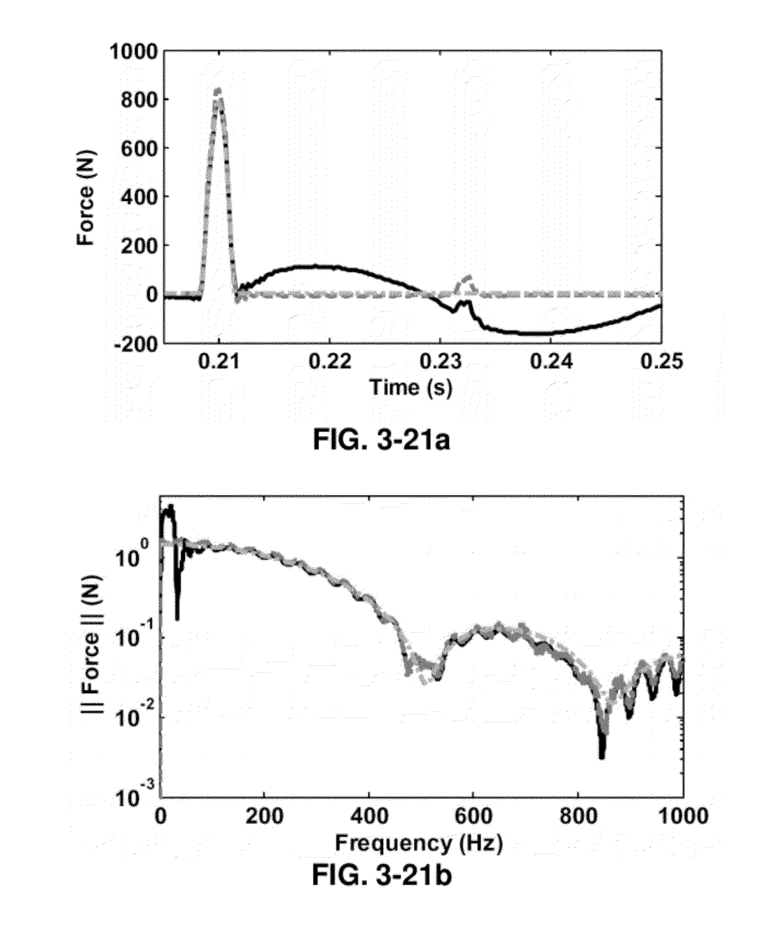

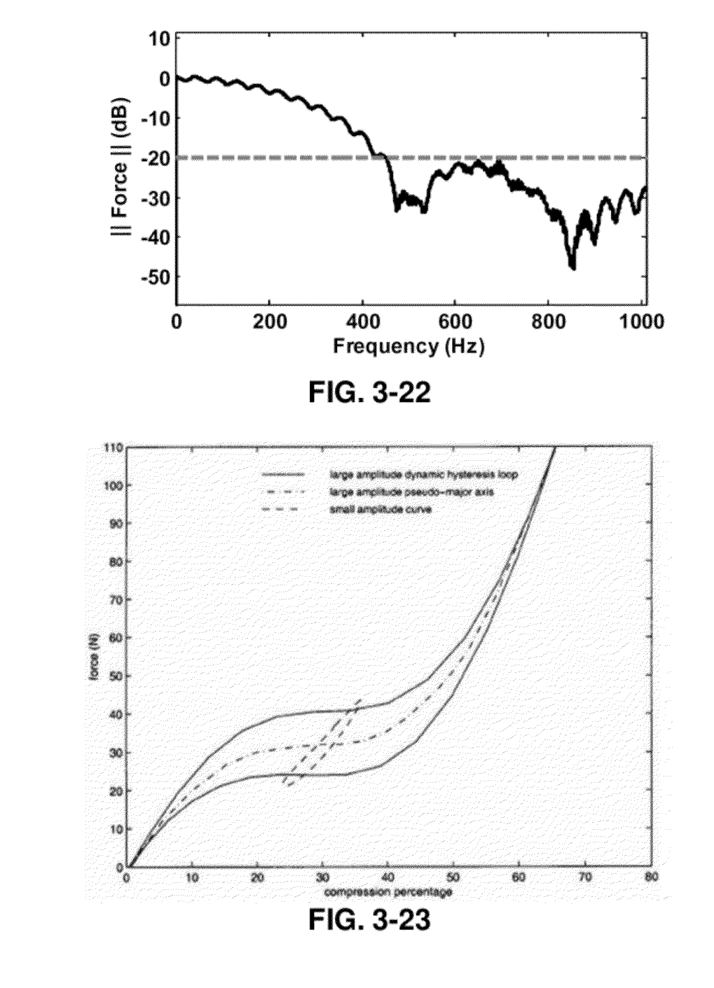

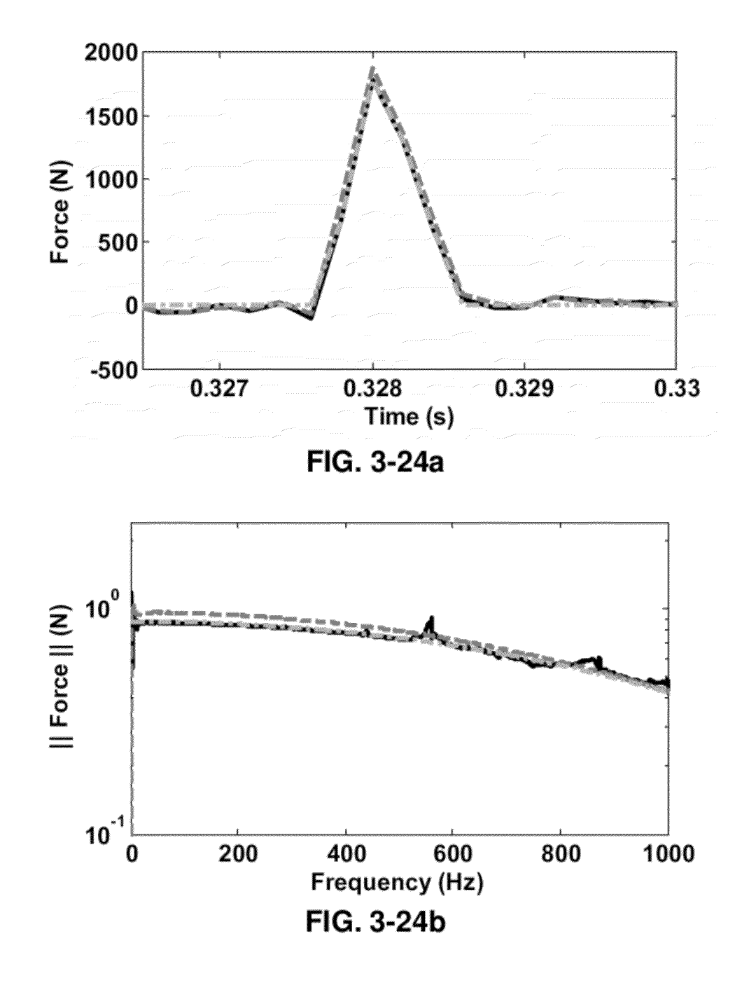

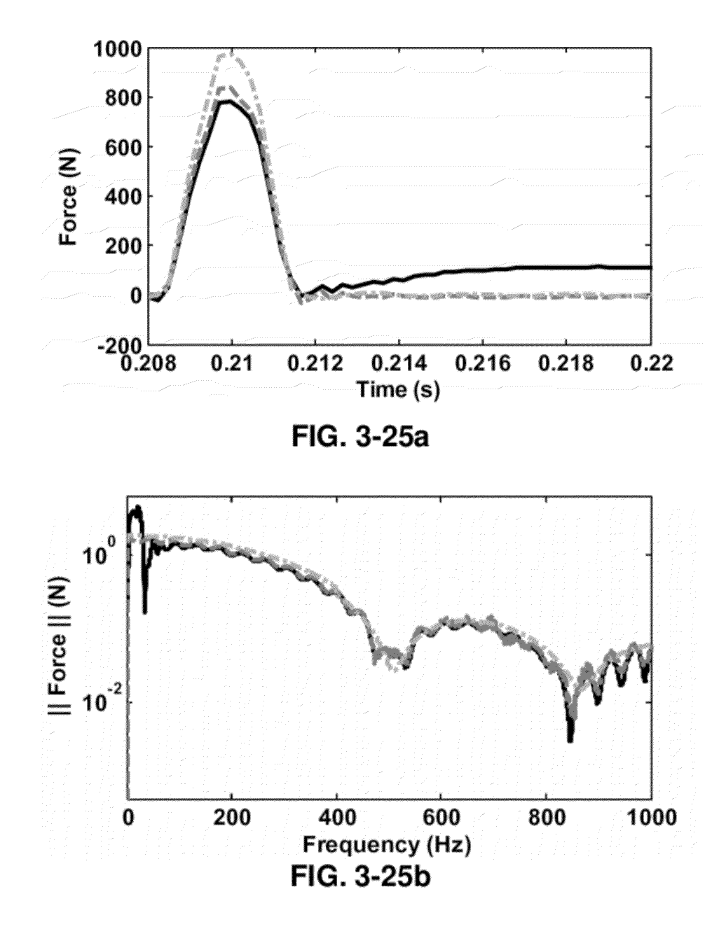

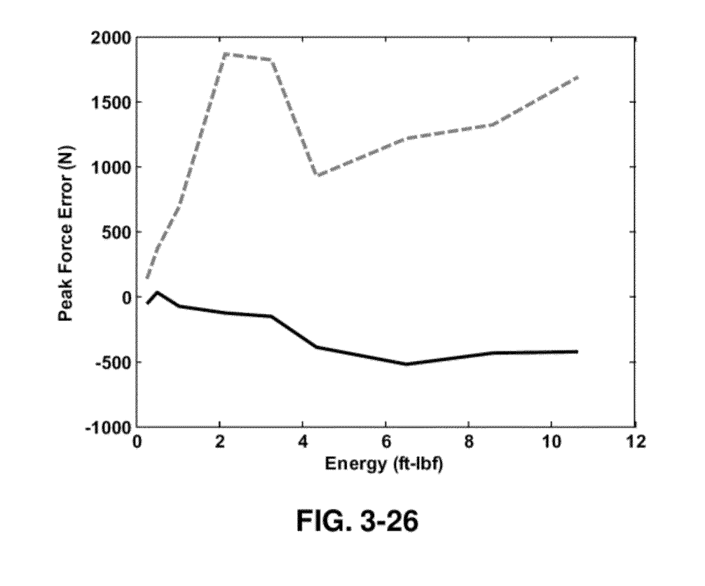

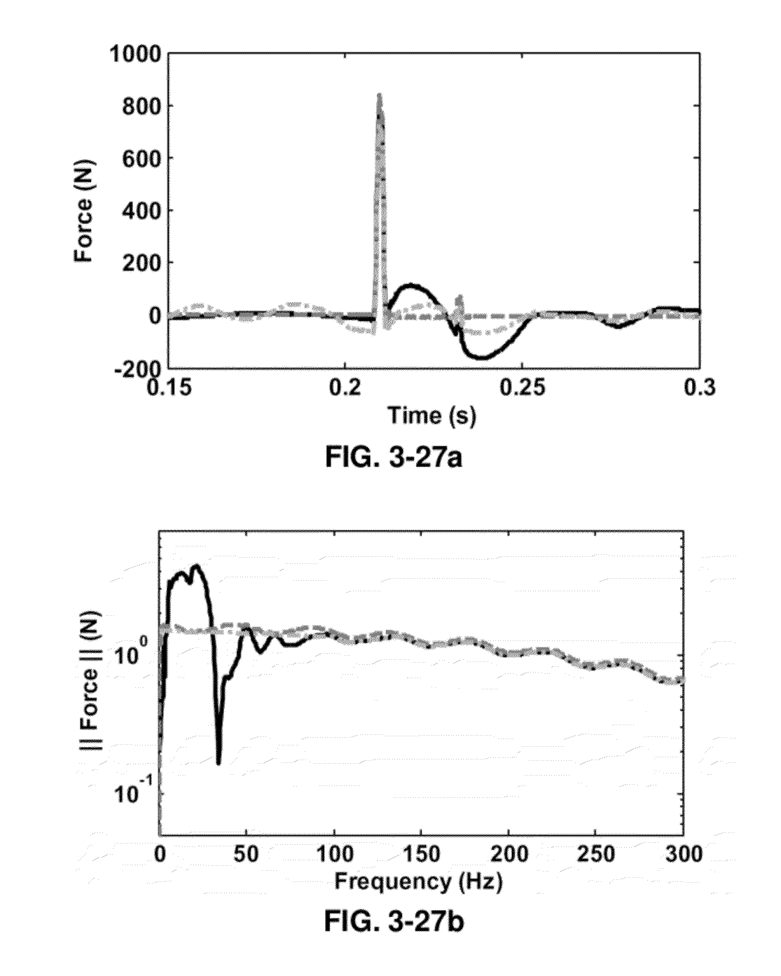

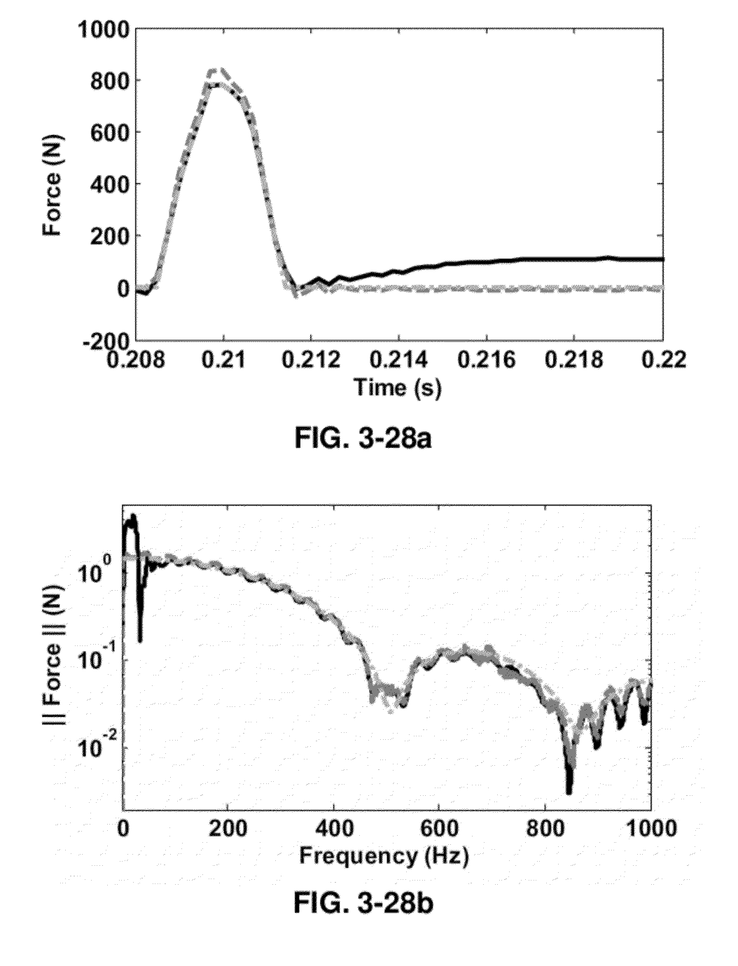

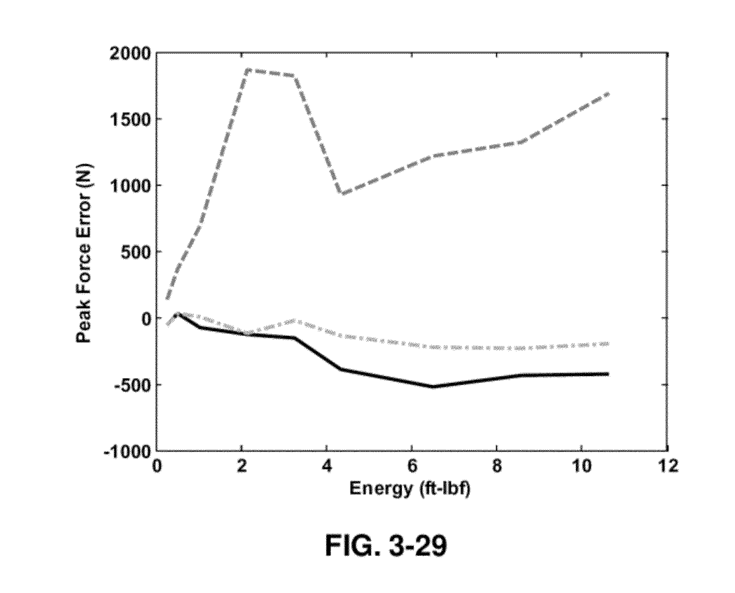

FIG. 2-3 Originally-estimated (line), actual (dashes), and curve-fit (dot dash) forces in the a) time and b) frequency domains for a 50%/50% average of healthy and damaged responses.

FIG. 2-4: Estimated (line), damaged (dashes), and healthy (dot dash) FRF for a 50% healthy and 50% damaged response average for a) broad and b) narrow frequency ranges.

FIG. 2-5: Estimated (line), damaged (dashes), and healthy (dot dash) FRF for a 80% healthy and 20% damaged response average for a) broad and b) narrow frequency ranges.

FIG. 2-6: Estimated (line), damaged (dashes), and healthy (dot dash) FRF for a 20% healthy and 80% damaged response average for a) broad and b) narrow frequency ranges.

FIG. 2-7: The original force estimate (line), the actual force (dashes), and the new curve-fit force estimate (dot dash) in the a) time and b) frequency domains

FIG. 2-8: Comparison of the estimated (line), damaged (dashes), and healthy (dot dash) FRFs for the third DOF with respect to an input force at the fourth DOF for a) broad and b) narrow frequency ranges.

FIG. 2-9: Input force (line) applied to the fourth DOF and its corresponding 20 dB roll-off level (dashes).

FIG. 2-10: The force (line) applied to the fourth DOF and its 20 dB roll-off level (dashes).

FIG. 2-11: Comparison of the originally estimated (line), actual (dashes), and curve-fit force (dot dash) for a) broad and b) narrow frequency ranges.

FIG. 2-12: Comparison of the estimated (line), damaged (dashes), and healthy (dot dash) FRF for the third DOF for a force at the fourth DOF for a) broad and b) narrow frequency ranges.

FIG. 2-13: Estimated (line) and actual (dashes) normalized differences in the FRF for the third DOF with respect to an input at the fourth DOF for a) broad and b) narrow frequency spans.

FIG. 2-14: The estimated (line) and actual (dashes) normalized difference damage index (DI) of the FRF for the third DOF for a force at the fourth DOF.

FIG. 2-15: Scaled modal deflections for each DOF (▪) relative to its equilibrium position (dashes).

FIG. 2-16: Relationship between damage level and the estimated (line) and actual (dashes) frequency shift of the third natural frequency.

FIG. 2-17: Six ounce tack hammer used to apply a broad-band, damaging impact force.

FIG. 2-18: The casing is suspended with cotton strings in series with bungee cords during the damaging-impact tests.

FIG. 2-19: Triaxial accelerometer consisting of three single-axis shock accelerometers.

FIG. 2-20: Originally-estimated (line) and curve-fit (dashes) force applied at Point D in the a) time and b) frequency domains with the 20 dB roll-off level (dot dash).

FIG. 2-21: Damaged sustained from an impact at Point D.

FIG. 2-22: Estimated (line), healthy (dashes), and damaged (dot dash) FRFs for a damaging impact at Point D with respect to the acceleration in the Y-direction for broad (a) and narrow (b, c) frequency ranges.

FIG. 2-23: Relative modal deflections (line) for the first three modes with respect to the equilibrium position of the canister wall (dashes).

FIG. 2-24: Estimated (line) and modally-determined (dashes) normalized differences in the damaged and healthy FRF for an impact at Point D with respect to the acceleration in the Y-direction for broad (a) and narrow (b, c) frequency ranges.

FIG. 2-25 The estimated (*) and actual (Δ) damage index (DI) based on the normalized difference of the damaged and healthy FRFs with respect to the a) X-, b) Y-, and c) Z-direction response measurements for four damaging impacts.

FIG. 2-26: Resulting damage from impacts at a) Point A, b) Point B, and c) Point C.

FIG. 2-27: Damage indices for the tack-hammer (*) and modal (Δ) impacts compared to the visible crack length.

FIG. 2-28: The estimated (*) and actual (Δ) damage index (DI) based on the normalized difference of the damaged and healthy FRFs with respect to the a) X-, b) Y-, and c) Z-direction response measurements for the impulses of four damaging impacts.

FIG. 2-29: Mean frequency shift of the third natural frequency according to the estimated FRFs (*) and the FRFs found via modal impact testing (Δ) assuming damage is proportional to the peak force.

FIG. 2-30: Mean frequency shift of the third natural frequency according to the estimated FRFs (*) and the FRFs found via modal impact testing (Δ) assuming damage is proportional to the impulse of the applied force.

FIG. 3-1. Four-degree-of-freedom model with underlined system of equations of motion.

FIG. 3-2. Relationship between the applied force (line) and the damage level (dashes) of k4 for the 4-DOF model.

FIG. 3-3. Comparison of the healthy, trained FRF (line) and the damaged FRF (dashes) for a) a broad frequency range and b) a narrow frequency range.

FIG. 3-4. Force estimates (line) and their curve-fit lines (dashes) for the shaped based technique used to identify a damaging impact on the 4-DOF model.

FIG. 3-5. Force estimates using the amplitude-based technique for a) the first (line) and second (dashes) DOF and b) the third (line) and fourth DOF (dashes).

FIG. 3-6. Condition number for the FRF matrices used in the force estimate calculations for DOF1 and DOF2 (line) and DOF3 and DOF4 (dashes).

FIG. 3-7. Comparison of the force at DOF 2 (line) and DOF 4 (dashes) for a damaging impact.

FIG. 3-8: a) Comparison of force estimate (line) and the pristine, actual force (dashes) for a damaging impact; b) close up of main portion of impact force.

FIG. 3-9. Comparison of the original estimated force (line), the actual force (dashes), and the curve-fit force (dot dash) in the a) time domain and b) frequency domain.

FIG. 3-10. Comparison of the original force estimate (line) and the actual force (dashes) for a frequency range from zero to half the sampling rate.

FIG. 3-11. The original force estimate (line), the actual force (dashes), and the new curve-fit force estimate (dot dash) in the a) time and b) frequency domains.

FIG. 3-12. Filament-wound rocket motor casing that is discretized into 24 possible forcing locations and has a triaxial accelerometer attached.

FIG. 3-13. The magnitude of a typical force at Point 1 (line) as well as the level at which the force magnitude drops by 20 dB (dashes).

FIG. 3-14. Comparison of the estimated impulsive force (line) and actual force (dashes) for an impact at Point 1.

FIG. 3-15. Comparison of estimated force (line) and actual force (dashes) when a) three, b) two, and 3) one response measurement(s) is(are) included in the system of equations.

FIG. 3-16. An example of a “random” impact force in the a) time and b) frequency domains.

FIG. 3-17. The impact location was varied away from the trained input DOF in both the radial and axial directions.

FIG. 3-18. Filament-wound RMC in test fixture for the drop-tower impacts.

FIG. 3-19. The RMC and wooden block is placed below the main cabinet of the drop tower for testing damaging impacts.

FIG. 3-20. A tup that is connected to the drop carriage by an aluminum extension strikes the RMC.

FIG. 3-21. The original estimate (line), actual (dashes), and curve-fit estimate (dot dash) forces for a 0.34 J drop-tower impact in the a) time and b) frequency.

FIG. 3-22. The actual force (line) and the level at which it drops 20 dB (dashes) for a 0.34 J impact domains.

FIG. 3-23. Typical force/deflection curves for high and low amplitude, single frequency strain cycling of polyurethane foam (Courtesy of White et al).

FIG. 3-24. Original force estimate (line), the applied force (dashes), and the curve-fit estimate (dot dash) of the force for a high-amplitude impact when the canister is suspended with rubber bands in the a) time and b) frequency domains.

FIG. 3-25. Comparison of the originally estimated (line), actual (dashes), and adjusted curve-fit (dot dash) forces in the a) time and b) frequency domains.

FIG. 3-26. Comparison of the difference between the actual peak force and the peak force of the originally estimated (line) and adjusted curve-fit (dashes) forces.

FIG. 3-27. Comparison of originally estimated force (line), actual force (dashes), and original force with the foam effects minimized (dot dash) in the a) time and b) frequency domains.

FIG. 3-28. The adjusted, curve-fit force (dot dash) better matches the value and shape of the actual force (dashes) than the original estimate (line) in both the a) time and b) frequency domains.

FIG. 3-29. Peak force error for the originally estimated force (line), the adjusted, curve-fit force without eliminating the foam effects (dashes), and the adjusted, curve-fit force after minimizing the effects of foam (dot dash).

### DESCRIPTION OF THE PREFERRED EMBODIMENT

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates. At least one embodiment of the present invention will be described and shown, and this application may show and/or describe other embodiments of the present invention. It is understood that any reference to “the invention” is a reference to an embodiment of a family of inventions, with no single embodiment including an apparatus, process, or composition that must be included in all embodiments, unless otherwise stated.

The use of an N-series prefix for an element number (NXX.XX) refers to an element that is the same as the non-prefixed element (XX.XX), except as shown and described thereafter. As an example, an element 1020.1 would be the same as element 20.1, except for those different features of element 1020.1 shown and described. Further, common elements and common features of related elements are drawn in the same manner in different figures, and/or use the same symbology in different figures. As such, it is not necessary to describe the features of 1020.1 and 20.1 that are the same, since these common features are apparent to a person of ordinary skill in the related field of technology. Although various specific quantities (spatial dimensions, temperatures, pressures, times, force, resistance, current, voltage, concentrations, wavelengths, frequencies, heat transfer coefficients, dimensionless parameters, etc.) may be stated herein, such specific quantities are presented as examples only. Further, with discussion pertaining to a specific composition of matter, that description is by example only, and does not limit the applicability of other species of that composition, nor does it limit the applicability of other compositions unrelated to the cited composition.

One embodiment of the present invention pertains to an impact identification system that uses a single triaxial accelerometer to detect, locate, and quantify an impact on the canister. To solve this inversion problem accurately and efficiently, an FRF model was created by experimentally acquiring a reduced set of FRFs on the structure and then interpolating the results using functions designed to approximate the mode shapes of the canister in each direction. The inherent multidirectional coupling of the canister was then utilized to determine the impact point using an iterative least squares algorithm. Using this methodology, the impact location was correctly localized to less than 4% of the structure 99.5% percent of the time.

Once a possibly damaging impact had been detected on the canister, further investigation into the true existence of damage was needed. However, damage detection methods based on the canister's vibrations were inherently difficult to apply because of the wide variety of ways in which the structure's dynamics could be altered. Changes in either the canister's operating boundary conditions (propellant filler) or environmental conditions (temperature and humidity) resulted in changes that masked the initiation of damage. To solve the damage detection problem in the face of this variability, a study was performed on the missile canister which demonstrated that the nonlinear modulation due to a crack in the canister was not only a clear indication of damage but persisted despite changes in both the canister's environmental and boundary conditions. A combination of these load and damage detection methods is proposed to develop a health monitoring system for a filament wound missile canister.

Various embodiments of the present invention offer two minimal sensing, passive force identification and quantification techniques. These methods can be applied to quantify forces acting on a structure with multiple input locations using one multi-directional sensor when the structure becomes damaged due to the impact. Both force estimation techniques investigated in this document are applied in the frequency domain. The first technique discussed is a shaped-based technique. The second method is based on the amplitude of the estimated force. The shape-based technique includes the assumption that the applied force is impulsive, but the amplitude-based technique includes no such assumptions. The shape-based technique is a global technique, i.e., it analyzes the shape of the force magnitudes over a broad range of frequencies. Conversely, the amplitude-based technique finds the median force value for a frequency region consisting of multiple, narrow frequency spans. Both force-estimation techniques reduce an underdetermined system of equations into many overdetermined systems of equations in order to locate and quantify the applied force.

1. The analytical application proved that although the FRF matrix is more ill-conditioned near resonant frequencies, the low SNRs for frequencies other than those near resonant frequencies cause more errors in the force estimate than the ill-conditioning of the FRF matrix. Therefore, it is helpful in some embodiments to focus on frequencies near the resonant frequencies of the structure when implementing the amplitude-based technique.

2. When estimating forces that damage the structure or that act on a damaged structure, the processes of curve fitting the estimated force in the time or frequency domain and matching the signal energy of the original estimate to that of the curve-fit force increase the accuracy of the estimated force. In the experimental tests that estimate damaging impacts, the adverse effects of the force estimates due to the nonlinear properties of the polyurethane foam and other unaccounted-for forces are minimized before equating the signal energies of the original and the curve-fit forces. The foam effects are minimized by revisiting the assumption that the applied force is impulsive, and that the magnitude of an impulsive force has a smooth roll-off in the frequency domain with increasing frequency.

3. The accuracy of the estimated force is proportional to the number of response measurements included in the equations of motion. For the experimental application involving the filament-wound RMC, at least two response measurements (i.e., in two orthogonal directions) achieve relatively accurate force estimates.

4. The two force-estimation techniques are able to identify the location of over 97% of 2400 impulsive impacts acting at a designated input DOF correctly.

5. Although the shape-based technique was developed to identify impulsive impacts, both force-estimation techniques are able to locate the input DOF for non-impulsive forces. The accuracies for both techniques for the small sample size tested is at least 93%, and the amplitude-based technique performs slightly better than the shape-based technique because no assumptions about the applied force are used.

6. In those applications pertaining to objects that are cylindrical, the techniques are able to better identify the nearest input DOF for forces that do not act at a trained input DOF if the impact acts away from the input DOF in the axial direction rather than the radial direction. This suggests that the discretization mesh can be coarser in the axial than the radial direction.

The experimental results suggest that in certain instances the shape-based technique better locates and quantifies the applied force than the amplitude-based technique (e.g. when the impact does not act at a specified DOF), but in some instances the opposite is true; the amplitude-based technique performs better (e.g., when identifying nonimpulsive impacts). Therefore, some embodiments of the present invention contemplate a force estimation technique that incorporates both the shape and amplitude-based techniques to provide robust performance in passively identifying and quantifying external forces on objects.

After a potentially damaging impact has been identified, the structure should be further inspected to ascertain the resulting damage as depicted in the flowchart shown in FIG. 1. If this inspection is performed using modal vibration data in the form of FRFs the detection of damage is difficult in the presence of variable environmental and structural boundary conditions. The difficulty in using modal vibration data for the detection of damage is that the natural frequencies and mode shapes of a structure are functions of the material density, modulus, and geometry as well as the structure's boundary conditions. These parameters are not only affected by damage but also by the structure's operating conditions. For example, although cracking may reduce the local stiffness of a structure and cause a corresponding change in the dynamic properties, this change could also be caused by a change in temperature, humidity or even a temperature gradient.

FIG. 1(b) is a schematic representation of an object 20, which is a section or subsection of a larger structure. In some of the embodiments discussed herein, object 20 is a structure such as a cylindrical rocket motor casing or a flat structural panel. However, these specific examples are given only as examples, and embodiments of the present invention contemplate the use of any kind of structural object.

For ease of discussion, object 20 as depicted in FIG. 1(b) is a substantially flat structural panel of a vehicle, such as an air vehicle. A plurality of test sites 30 are defined on the surface of object 20. Object 20 shows a plurality of test sites 30 that are arranged evenly in an x, y grid pattern. However, such a grid pattern is shown by way of example only, and other embodiments of the present invention contemplate arbitrary grid patterns, including those in which the fineness of the grid is adjusted across the shape of the part to account for variations in the stiffness, mass, or damping of the structure.

The set of boundary points 30 comprises an area in which a method according to one embodiment of the present invention is able to predict at least one of the magnitude or location of an unknown load, such as an impact load. Preferably, a sensing location 40 is located within the boundaries of the area defined by the test sites 30. Testing location 40 is preferably mechanically coupled to object 20 by the structure of object 20. Testing location 40 is chosen as a location that responds spatially (in displacement, velocity, or acceleration), such that a loading disturbance within the area bounded by sites 30 results in a spatial response at sensor location 40. Although what has been shown and described is a testing location 40 located within the boundaries of the array of test sites 30, this is by way of example only. Yet other embodiments of the present invention contemplate the use of a testing location not within the area defined by test sites, but which preferably has a measurable and predictable spatial response for any loading disturbance occurring within the area defined by the test sites.

In one embodiment of the present invention, object 20 includes a single testing location 40 at which point spatial responses are measured. The same sensing location is used both to construct an experimental model, and further to capture data when object 20 is excited by an unknown disturbance or load. However, in yet other embodiments of the present invention, it is possible to measure spatial disturbances at a first sensing location during generation of the model, and measure spatial disturbances on the same object at a second sensing location when the panel is in use (such as in an air vehicle during operation). However, it is preferable that there be a well-behaved frequency response function that correlates spatial responses between the two sensing locations.

A sensor 42 is placed at the sensing location and provides a signal corresponding to spatial disturbance at the location to a signal processing interface, which preferable establishes an electronic buffer between the sensor and an electronic analyzing unit, such as a computer (not shown). In one embodiment, the electronic analyzing unit is a digital computer having software and a display. Signals generated by sensor 42 at the sensing location 40 are provided to the signal processor and buffer, and from that buffer to a computer, such as a laptop computer. The electronic signals are converted into digital data, and the data is processed by one or more algorithms described herein. In some embodiments, the algorithms process the sensor signals and predict at least one of a location or magnitude of an unknown, external disturbance to object 20. Yet other embodiments there are algorithms that receive data from sensor 42 that is used to prepare the experimental model. Yet other algorithms use the sensed data to predict various qualities pertaining to any damage that may have occurred on object 20.

Sensor 42 senses spatial movement in at least one direction, such as spatial movement normal to the surface of location 40. Preferably, sensor 42 provides at least two orthogonal channels of spatial information, and yet in other embodiments sensor 42 provides three channels of orthogonal data (such as from a three axis accelerometer). In some embodiments, sensor 42 is a three axis accelerometer that measures vibration in a direction normal to the sensing surface, and in two other directions located in the plane of the surface.

However, in yet other embodiments, sensor 42 is a three axis accelerometer in which the three axes of measurement are each skewed at an oblique angle relative to the surface of object 20 at sensing location 40. As one example, each axis of measurement is angled forty-five degrees from the surface. In such embodiments, each of the measurement channels responds to movement of the object in a direction normal to the surface. Further, the three axes are, in some embodiments, each angled ninety degrees relative to each other, and thereby define three orthogonal directions. Such a skewing of the three accelerometers relative to the mounting surface generally eliminates or reduces the chances of an axis of measurement being relatively undisturbed when an impact occurs to object 20, because in such cases data received from that quiet channel has a low signal-to-noise (SNR) ratio. The noise in the signal leads to errors that manifest themselves in inaccurate predictions pertaining to the unknown load.

In some embodiments, the three accelerometers are skewed relative to a mounting surface of a housing that contains the three accelerometers. Therefore, the assembled accelerometer can be attached to the surface of the object in a conventional manner (such as adhering the mounting surface of the accelerometer to the surface of location 40), and thereby provide a skewing of the accelerometers themselves (the piezoelectric components) which are skewed relative to the surface.

Object 20 as depicted in FIG. 1(b) is used for the initial creation of an experimentally-derived model of the structure of object 20. As will be described later, during the initial generation of this model each of the test sites 30 is excited with a disturbance of known magnitude and known frequency content. As a specific site 30 is so disturbed, the spatial response of object 20 at location 40 is measured by sensor 42 and stored in the memory of the computer.

Preferably, each disturbance is applied at the geometric location of a site 30, and preferably the disturbance is applied at least once. In some of the embodiments described herein, it can be seen that the known disturbance should be applied close to the test site 30, but various embodiments described herein are robust enough to accommodate variations in the location at which the known excitation actually takes place.

In some embodiments, the known excitation come from a calibrated hammer (i.e., a hammer having a load sensor in its impacting tip). As that hammer strikes near or at a test site, the response of the hammer's load sensor is transmitted to a signal processor and electronic buffer which provide the processed signal to a CPU which stores the information in memory. In some embodiments, it is helpful to apply multiple known impacts at a particular site, and have an algorithm within memory that associates an average spatial response at location 40 based on those individual impacts. Further, although the use of an impact at a test site has been shown and described, it is understood that other embodiments of the present invention contemplate the application of any type of known force on an object proximate to a test site.

FIG. 1(c) depicts a subsequent stage in the production of the experimentally-derived model in which a plurality of interpolated sites 32 are introduced mathematically into the computer model. Although these interpolations sites are shown equally spaced among the test sites, other embodiments of the present invention contemplate non-uniform introduction of interpolation sites, which can be placed with more fineness in those areas of the model in which the measured transfer functions (also referred to herein as frequency response functions) are more rapidly changing (such areas likely being those in which the structure, mass, or damping of the object changes locally).

As will be discussed later, in some embodiments of the present invention an interpolated frequency response function is associated with each of the interpolation sites 32. The functions associated with a particular site 32 are mathematical interpolations of the frequency response functions for the surrounding test sites 30. In this way, an experimental model can be initially derived with a small number of test points. Later, that same model can be provided with increased fineness by the addition of interpolated frequency response functions at interpolated sites placed among the test sites.

FIG. 1(d) shows a method 100 for creating an experimental model. Method 100 provides a model of a structure in which a plurality of test sites (and interpolation sites) are linked by their corresponding transfer function (or frequency response function) to the spatial response of a predetermined sensing location.

The generated FRFs, when multiplied by a load, predict a spatial response at the sensing location. Each FRF is generated by impacting the object proximate to a particular test site with a known load. That known load provides a measured response at location 40. By dividing the spatial response by the known load (which can be done in either the time domain or frequency domain, and further performed in matrix form as shown herein) a response function between that test site and the sensing location is established. Some of the embodiments shown herein refer to response functions derived in the frequency domain. However, yet other embodiments of the present invention contemplate the generation of time response functions instead.

Method 100 includes the act 110 of creating an experimental model. This model, expressed in software in the memory of the computer, can be derived as described herein. However, an experimental model of any type and derived with other methods that provides time or frequency-based transfer functions from a test site to a sensing location can be used with the load identification methods described herein.

Method 100 further includes the act 112 of placing a sensor on the object at a predetermined location. As discussed above, in some embodiments the sensor is contemplated as a three axis accelerometer placed on the surface of the object. However, yet other sensors are contemplated (such as displacement and velocity sensors, especially on those objects and for those loading situations in which measurable displacements or velocities are expected). Further, yet other embodiments of the present invention contemplate the use of a non-contacting method, such as a laser vibrometer, and especially such vibrometers capable of providing multi-dimensional spatial responses at a particular sensing location.

Method 100 further includes the act 114 of establishing a grid of test sites on the object. The method further includes the act 116 of impacting the object at each test site and recording the response of the sensor. Method 100 further includes the act 118 of storing the sensed responses in memory for further manipulation. This mathematical manipulation includes the generation of transfer functions in either the frequency domain or time domain.

Method 100 further includes the act 120 of creating a grid of interpolation sites within the grid of test sites. The method also includes the act 122 of interpolating measured frequency functions at the test sites surrounding an interpolation site, and assigning an interpolated frequency response function to the particular interpolation site.

FIG. 1(e) shows various acts according to one embodiment of the present invention for using the experimental model of method 100 to predict at least one of the magnitude or location of an unknown (unmeasured) impact. FIG. 1(e) shows one embodiment of a load identification method 200 in which the spatial responses are measured at a testing location, and then used inversely through the experimental model to predict qualities (such as magnitude or location) of force (at a particular test site or interpolation site) would have provided the measured response. Method 200 further includes various ways of analyzing the plurality of predicted, hypothetical loads to determine which of these loads most likely represent the unknown impact.

Method 200 includes impacting the object with an unknown load. Various embodiments contemplate this act occurring as the object is serving its intended use. For example, it can be a rocket motor casing (RMC) that is part of a rocket that is captive-carried by a helicopter. As the helicopter operates in ground effect, it is possible that stones can be impacted against the rocket motor casing under the influence of the rotor wash.

For debris-related impacts, it is possible to make several simplifying assumptions about the effect of the unknown impact on the object 20. For example, in some types of impacts, it is likely that the time history of the impact will be a single, short duration, single-sided peak. This assumption may be applicable because the debris impacts the object once, and then falls away. With such single sided, single peak impacts, the frequency content of the load can be modeled as a smoothly rolling off function that has its maximum at low frequencies.

Yet another possible assumption is based on the sign of the impact. For a debris-related impact as discussed above, the direction of the impact is from a location outside of the interior of the object in a direction toward the interior of the object. Yet another simplifying assumption in some embodiments is that the impact does not cause permanent deformation or permanent damage to the object. Although such high load impacts are important because of the damage they cause, the location of such an impact site is easily established visually. In contrast, those impacts that cause no permanent damage (or leave other visible indications) are important to find because of the fact that they do not leave a visible indication, yet they may have nonetheless imparted non-visible damage within the structure. For such non-visible impact locations, various algorithms presented herein provide a way to identify the location of the impact. Although this location may not be precisely predicted, it nonetheless represents a good starting point for further inspection by the helicopter maintenance crew.

Method 200 further includes the act 140 of measuring the response of the object at the sensing location to the unknown load. This response is measured by sensor 42. As discussed herein, in some embodiments the frequency content of the measured response is truncated, and only frequencies within a certain band are assessed. Such limitations on the frequencies of interest may help in reducing the effects of noise present on the signal. Further, within act 116 and act 122 discussed above, it is further contemplated by some embodiments to place frequency limits (both high and low) on the frequency response functions.

Act 140 of method 200 establishes a measured response to an unknown load. Both the magnitude and location of the load are not known, and it is helpful to predict either or both of these qualities of the unknown load. In order to do this, method 200 includes act 150 in which the measured response is transformed by the inverse of the FRF at a particular site in order to predict a hypothetical load at that site that would have caused the measured response. The measured response is used to predict a plurality of hypothetical loads, one for each of the test sites and interpolated sites. It is understood that yet other embodiments of the present invention contemplate algorithms in which hypothetical loads are predicted at fewer than all of the test sites and interpolated sites.

Method 200 includes act 160 for assessing the plausibility of each of the hypothetical loads. In those embodiments incorporating some of the aforementioned simplifying assumptions, those hypothetical loads that significantly differ from a single, impulsive peak can be discarded. Further, those hypothetical loads that represent impacts that would have had to have occurred from the inside of the rocket motor casing toward the outside can be eliminated, since debris excited by rotor downwash cannot act in this direction. In yet other embodiments, the frequency response of the hypothetical load can be assessed. To the extent that the frequency content of the hypothetical load differs from the smooth roll off expected of an impulsive peak, such loads can be discarded from further consideration. Further discussion of these and other assessment algorithms are provided later herein.

Method 200 further includes the act 170 of assessing if a specific hypothetical load would provide a plausible sensor response. One way in which to do this is represented by act 172. With act 172, the hypothetical load predicted for a site and the corresponding FRF for that site are used to predict sensor responses at the sensing location. Although there may be some expectation that the hypothetical load and the FRF should produce exactly the measured response, use of the algorithms presented herein have shown that this is not the case. Instead, the hypothetical load acting through the FRF associated with the site will produce responses different than the measured responses, especially in those cases where the location and magnitude of the particular hypothetical load are not good estimates.

In some embodiments, act 172 includes comparing ratios of measured responses to ratios of hypothetical responses calculated by using the hypothetical load and the corresponding FRF. As one example, a normalized measured response vector (expressed in x, y, and z directions, for example) will have individual x, y, and z components, all less than 1 (because the individual responses have been normalized by the magnitude of the three dimensional response, as expressed by the square root of the sum of the squares of the individual responses). This unit vector response will include components all less than one, but further in particular ratios among the measured directions (such as the ratio of x to y, or y to z, or x to z).

This same unit-vector approach can then be applied to the hypothetical responses predicted at the sensing location as if the hypothetical load were applied at the site (30 or 32). Again, the individual vector components of the hypothetical response in terms of x, y, and z are normalized in the same manner. The resultant hypothetical unit vector includes normalized x, y, and z components, each of which has a magnitude less than 1. Interrelationships among these hypothetical responses can also be established (such as the relationship of x to y, y to z, or x to z, as performed for the response measured from the actual unknown impact).

In one embodiment, the ratios of measured response vector components (such as x measured divided by y measured) are compared by the corresponding hypothetical vector relationship (such as x hypothetical divided by y hypothetical). It has been found that one method for assessing the plausibility of the hypothetically predicted load is to see if the hypothetical responses have similar inter-related components as the measured response. For example, if the measured ratios x divided by y, y divided by z, and z divided by x, have values a, b, c, then these same ratios for the hypothetical responses should likewise have values a, b, c, or an integer multiple thereof. It has been found that those cases in which the ratio of hypothetical responses more closely resemble the ratio of measured responses indicate a hypothetical load with increased plausibility.

Method 200 further includes identifying at least one of the location or magnitude of the unknown load to the operator computer, such as on the computer display. Preferably, the method 200 provides a predicted location (which will correspond to one of the test sites of interpolated sites) that informs the computer operator of a good location at which further investigation of the structure of object 20 should be made. It has been also found in other embodiments of the present invention that by use of the plausibility algorithms discussed above (which are discussed later herein with regard to error indices), that in some cases there is reasonably accurate prediction of both the location and magnitude of the external disturbance.

What follows is discussion of one embodiment of the present invention that was used in a series of experiments. The discussion of this series of experiments refers to a number of equations, each by a number. Those numbers pertain to equations in other portions of the documents.

The vibration properties (modal frequencies and vectors) of the carbon filament wound missile canister tested in this document (FIG. 2) are sensitive to changes in temperature, humidity, and other factors. The effects of these factors on the dynamic response of the canister are especially complicated due to the anisotropic nature of the filament wound composite. Because of these issues, a damage inspection that is immune to environmental factors would be highly advantageous. Additionally, the canister's boundary conditions in practice will be different from those used in this document. More specifically, the canister will be filled with propellant and stowed in the missile body, which will cause changes in the modal vibration properties.

Some embodiments of the present invention pertain to a nonlinear vibro-acoustic method using multi-directional acceleration measurements. This method was shown to be less sensitive to changes in the canister's boundary conditions and temperature than the modal vibration characteristics while still detecting damage.

A modeling according to one embodiment of the present invention generates a dynamically accurate model of the missile canister using experimentation. To reduce the time required to generate this model while still retaining the spatial resolution needed for solving the load identification problem, a spatial interpolation algorithm was developed for use with the acquired frequency response functions (FRFs). The applicability of such an interpolation method to FRFs can be made apparent by writing the FRF in partial fraction form as follows:

$${H}_{pq} ( jω ) = {\sum }_{r = 1}^{N} \frac{{A}_{pqr}}{jω - {λ}_{r}} + \frac{{A}_{pqr}^{*}}{jω - {λ}_{r}^{*}} \qquad ( 1 )$$

where H_{pq} is the FRF of a structural component for the p^{th} output and the q^{th} input, r is the structural mode number, N is the total number of modes, λᵣ is the pole (or modal frequency), and A_{pqr} is the residue. The residue can be expressed as,

$${A}_{pqr} = \frac{{ψ}_{pr} {ψ}_{qr}}{2 j {M}_{r} {ω}_{dr}} \qquad ( 2 )$$

where Mr is the modal mass, ωdr is the damped natural frequency of the mode, and ψpr and ψqr are the modal coefficients for the output and input locations, respectively. This decomposition is helpful because at each frequency for a constant measurement location, the spatial variation of the FRFs across different excitation locations can be expressed as a function of the mode shapes of the structure.

Using a predetermined number of sample points, the interpolation will be achieved when the interpolating functions resemble the actual mode shapes of the structure. For example, at a given longitudinal location below the nose cone of the canister the dynamics of the carbon filament wound canister studied in this work (FIG. 2) are likely to resemble those of a cylinder and a cylinder's mode shapes are known to be comprised mainly of sines and cosines. However, the mode shapes in the longitudinal direction are likely to not be purely sinusoidal. To determine the proper basis functions for interpolation, 41 equally spaced FRFs were acquired along the length of the canister at a given circumferential location with a scanning laser Doppler vibrometer. A PCB 712A02 piezoelectric actuator, which was mounted as shown in FIG. 2, was used to excite the structure with a burst chirp from 400 to 5000 Hz.

The acquired FRFs were then spatially down sampled and recreated using interpolation with either sines and cosines or cubic splines. In some embodiments, the mode shapes of the canister, the second derivative of the cubic function used for interpolation was set to zero at the canister's free end (where the moment and shear boundary conditions were zero). Those of ordinary skill in the art will recognize that various derivatives can be set to zero or non-zero quantities based on the boundary conditions of the particular experiment.

To minimize the effects of the lack in periodicity of the data when sines and cosines were used as basis functions, a linear ramp was added and subtracted at each frequency using a linearly extrapolated point. Higher order functions were not used to remove the possible slope discontinuities as the error due to the extrapolation was assumed to be dominant. However, the present invention also contemplates those embodiments in which high order functions other than sine, cosines, or cubic splines can be used to model the structure.

The results of these two interpolation algorithms indicated that in this case cubic spline interpolation more accurately reconstructed the FRFs between 400 and 2500 Hz than did interpolation using sines and cosines, and that the error in the interpolated FRFs increases as the number of measured locations decreases (FIG. 3). Regardless of the interpolation scheme used, as the frequency increased the accuracy of both methods decreased as seen in FIG. 4. Therefore, in addition to choosing interpolating functions that are similar to the mode shapes of the structure, it is preferred that the frequency range of interest should also be low enough that the number of spatial measurement locations can adequately describe the deformation shape of the structure.

One obstacle to impact force identification is the ill-posed nature of the problem. In some embodiments of the present invention, an iterative version of the frequency domain deconvolution technique was adopted to obtain an estimate for both the location and the magnitude of an impulsive force on the carbon filament wound canister. The frequency domain deconvolution method is based on the principle that the measured response of a structure is directly related to the unknown input force acting on that structure through the frequency domain equation of motion:

X(jω)_{M×1}=H(jω)_{M×N}F(jω)_{N×1} (3)

where X(jω)_{M×1} is a vector consisting of the Fourier transform of the M measured responses, F(jω)_{N×1} is a vector of the N input forces, and H(jω)_{M×N} is the FRF matrix composed of the individual FRFs described by equation (1) for all of the input and output locations simultaneously. If the number of possible forcing locations is larger than the number of measured responses (N>M), as is typically the case in practice, this problem is underdetermined and a unique solution that is physically meaningful may not be obtainable. If the number of measured responses is equal to the number of possible input forces under consideration, then the FRF matrix can be directly inverted to determine the forces applied to the structure. However, numerical ill conditioning can be present in the FRF matrix and this ill conditioning can amplify measurement errors resulting in inaccurate force estimates.

To make this inverse problem more tractable and obtain an accurate and unique solution, one embodiment of the present invention imposes constraints based on the underlying physics of the problem. For example, if the constraint is imposed on the inverse problem that only a single location may be impacted during a measured response, each of the possible force locations may be considered individually rather than considering the entire distribution of possible forces at once. Consequently, if more than one response measurement is taken, the frequency based equation becomes overdetermined and the force that minimizes the least squares error between the measured and reconstructed responses is given by,

F^{R}(jω)=H_{1×M}⁺(jω)X_{M×1}′(jω) (4)

where the superscripts+indicates the Moore-Penrose pseudoinverse, the prime indicates that the data was obtained from the impact of interest, and the^{R} indicates that the force has been reproduced rather than measured. Because only one location has been impacted, if it is assumed that the structure does not exhibit an entirely symmetric response, only one of these reproduced forces should correspond to the applied force to the structure.

While iterating through the reproduced forcing functions, additional constraints can be imposed on the problem to help determine one likely impact location. For example, the impacts to be identified may occur on the outside of the canister. To ensure that only reproduced forces that meet this constraint were considered as possible candidates, the reproduced force was transformed into the time domain using the inverse fast Fourier transform and the sign of the maximum absolute force was investigated. If the sign of the peak reproduced force matched that of an external impact, it was considered in future analysis; otherwise, this location was discarded to reduce computation time. Yet other embodiments of the present invention contemplate embodiments in which other constraints may be applicable, such as the likelihood of damage occurring on the inside of the canister, and with regards to volumes that are not closed, for impacts occurring on particular sides of the object.

Another constraint that can be applied to the force identification problem is that the reproduced force should be able to maintain the coupling, or interrelationship, that exists between the measurements at each location. To investigate this constraint, the FRFs at the remaining possible impact locations were reproduced using the recreated forcing function,

H_{M×1}^{R}(jω)=X_{M×1}′(jω)/F^{R}(jω) (5)

where H^{R} is the vector of recreated FRFs at the given impact location.

By comparing the reproduced FRFs (H^{R}) to those that were used to model the structure (H) at each location, the coupling between the measured responses for this hit could be compared to the coupling present at each of the training locations. If the true impact location was different than the suspected location, a different complex scalar (F^{R}(jω)) would be required to transform each of the acquired responses into the respective FRF at each frequency due to differences in coupling between each of the newly acquired responses and the corresponding FRFs. Therefore, one possible impact location could be determined by identifying the location at which the reproduced and measured FRFs were the most similar for all of the measured responses.

In some embodiments of the present invention, the analysis includes a comparison of FRFs that can be accomplished using the variation in modal parameters. In the discussion to follow, the FRFs were instead directly compared. However, those embodiments using variation in modal parameters can include automated extraction of modal parameters, although in some cases such extraction can be difficult. In the discussion to follow, a comparison of the FRFs was performed on a point by point basis. However, the data contained frequency ranges in which variations occurred between multiple impacts at a given location.

To minimize the influence of these unreliable frequency ranges, the ordinary coherence (which was measured during the collection of the model's FRFs) was used to identify these areas of low confidence in each response. To obtain coherence functions for interpolated locations, the measured coherences were linearly interpolated between the measurement locations at each frequency. The coherence values were normalized such that the area under the coherence functions was equal for all impact locations, which ensured that each location was equally weighted. The similarity between the measured and reproduced FRFs was calculated using the equation,

$${S}_{q} = {\prod }_{p = 1}^{M} [ \frac{1}{{\sum }_{ω = ω 1}^{{ω}_{2}} [ \vert {H}_{pq}^{R} ( jω ) - {H}_{pq} ( jω \vert \underline{{γ}_{pq}^{2}} ( jω ) ]} ] \qquad ( 6 )$$

where p indicates the response, q indicates the potential impact location, γ_{pq}² is the normalized ordinary coherence, and ω ranges over the frequency points calculated using the FFT in the range specified. The product across measurements was used rather than the sum to exaggerate the cases in which the differences between the FRFs were small in all of the measurements as was the case when the impact location was correctly identified.

An experimental investigation was performed on the carbon filament would canister shown in FIG. 2. A single PCB 356B21 triaxial accelerometer with a nominal sensitivity of 10 mV/g in each direction was used. To help provide an adequate signal to noise ratio was obtained across all channels, the sensor was positioned on the crown of the canister and rotated such that the responses would be helpful in each direction.

Impact testing was then performed to acquire FRFs at 6 equispaced circumferential locations and each of 6 longitudinal heights resulting in 3 FRFs for each of the 36 distinct impact locations on the canister. The FRFs were then interpolated to 24 locations circumferentially (one every 15 degrees) and 21 locations longitudinally for a total of 504 different possible impact locations. This interpolation used sines and cosines as the basis functions in the circumferential direction and cubic splines for interpolation in the longitudinal direction. The resulting FRF model has a spatial resolution of less than an inch in both directions.

Two additional impacts were then taken at each of the possible impact locations using a PCB 086C03 impact hammer to evaluate the effectiveness of the impact identification algorithm both in terms of the identified location and the resulting force time history. Because of the frequency roll-off of the impact, the FRFs were compared between 250 Hz and 900 Hz.

When the iterative least squares algorithm was applied to the 1008 trial impacts using this frequency range, the location with the highest similarity measure was the exact point impacted 80.6% of the time. If the canister was interpolated using only sines and cosines, the correct point was identified 76.8% of the time whereas when only cubic splines were used the impact location was identified 35.0% of the time. These results confirm that interpolating with cubic splines in the longitudinal direction and sines and cosines in the circumferential direction was an appropriate choice in this situation.

As the model became more refined, it was more appropriate to define the impact location as an area rather than a single point. If the impact area was defined as being the 5 cm by 5 cm square with the impact point at its center, then one of the points in the impact area had the highest similarity measure 97.0% of the time. An example of the similarity measure calculated using the described algorithm for an impact at a location whose FRF was created via interpolation is shown in FIG. 5.

In some embodiments of the present invention, rather than only considering the point with the highest similarity value, another method was to examine all of the points with a similarity value above a certain threshold. This created a group of suspect impact locations, which could then be examined for damage after the impact had been detected. When this method was applied to the results from the canister and the threshold value was set at a quarter of the maximum similarity for the hit, the correct impact location was within the group of possible locations 99.5% of the time and the maximum number of points in this group for all 1008 trial impacts was less than 4% of the number of points on the canister. In most cases, the number of points in this group was smaller with the median number of points in the group being only three.

The accuracy of the force time history estimated using the impact identification algorithm was then assessed using the force measured by the impact hammer. When the maximum force that was reproduced was compared to the maximum measured force, the median percent error was 5.0% across all impacts. The root mean square (RMS) values of the reproduced and measured force time histories were also calculated, and there was a median percent error of 3.9% for all of the trial impacts. An example of a reproduced time history compared to the measured force at an interpolated impact point is shown in FIG. 6.

The ability of the impact identification algorithm to detect, locate, and quantify impulsive loads, a supplementary invention damage detection technique was also needed that could detect and isolate the effects of damage from other external influences. One of the major challenges to inverse-based damage detection techniques is that realistic structures typically operate in a time-varying environment. In fact, changes in a structure's vibration characteristics due to changes in its environmental or boundary conditions can be quite helpful and may mask changes due to damage if these other influences are not taken into account. Although additional measurements can be made to compensate for these variations in the structural model, this increases the complexity of the required measurements and model, and places even greater emphasis on the model's accuracy. For example, it would be helpful to measure temperature gradients in the canister, rather than just a single temperature, to compensate for the effects of temperature variations on the modal properties of the canister. It would also be helpful to test many canisters when they are inserted into the missile body to compensate for the effects of propellant and other boundary conditions. If any of these parameters are not measured, the number of free variables results in an ill-posed inverse problem.

An alternative is to develop a method for damage detection that uses dynamic characteristics of a structure that are more directly related to damage than to the environmental and boundary conditions. For example, nonlinear vibro-acoustic methods focus on detecting nonlinear characteristics associated with damage such as cracks, delaminations, and other mechanisms that are typically not present in undamaged materials. One type of vibro-acoustic test method is nonlinear wave modulation spectroscopy (NWMS) which exploits the modulation of a low frequency signal around a higher frequency carrier signal. One theory is that this modulation is due to changes in the contact area of the crack (or other defect) created by the lower frequency vibrations. Because of these changes in the contact area, the crack can be modeled as a spring with a quadratic nonlinear stiffness. If only a single mode of vibration is considered at a time and damping is ignored, the dynamic equation of motion of such a system is given by,

Mᵣ\ddot{x}(t)+Kᵣx(t)+μx(t)²=f(t) (7)

where Mᵣ and Kᵣ are the modal mass and stiffness of the r^{th} mode, μ is the parameter governing the extent of the nonlinear stiffness, and f is the applied forcing function. If this system is forced with a function of the form

f(t)=cos(ω₁t)+cos(ω₂t) (8)

with ω<<ω₁, the steady-state response will contain terms at the two individual frequencies in addition to a modulation term of the form,

$$cos ( {ω}_{1} t ) cos ( {ω}_{2} t ) = \frac{1}{2} [ cos ( ( {ω}_{1} + {ω}_{2} ) t ) + cos ( ( {ω}_{1} - {ω}_{2 )} ) t ) ] \qquad ( 9 )$$

which are forced harmonics caused by interactions between the two individual forcing frequencies through the nonlinear spring. In relation to this method, Equation (9) suggests that there will be responses at frequencies equal to the carrier frequency (ω₁) plus or minus the frequency of the low frequency vibrations (ω₂). If low frequency vibrations are created by applying modal impacts to the damaged structure, the structure's resonant frequencies will become modulated with the carrier signal, which is commonly referred to as Impact-Modulation (IM).

IM was implemented on the filament wound canister to detect cracking of the outer fibers due to an external impact and assess its robustness in the face of changing operational conditions. Because of the multi-directional coupling of structural vibrations, a PCB 356B21 triaxial accelerometer was used in conjunction with a 352A60 uniaxial accelerometer to measure the canister's response to a PI P-141.10 shear piezo actuator as shown in FIG. 7. An Agilent 33250A function generator was used to generate the 60 kHz carrier signal, which was amplified by a Krohn-Hite 7500 amplifier and then used as the input to the actuator whose primary direction of motion was in the longitudinal (Z) direction.

After baseline data had been acquired, an impact was applied to the canister using a tack hammer, which produced the crack in FIG. 7(c). Because of the shock loading expected due to this impact, all sensors were removed from the canister prior to impact. IM was then performed on the damaged canister when it was empty and at room temperature, when it was stuffed with foam to simulate a change in boundary conditions such as that due to propellant, and when the canister had been cooled to a lower temperature in a humid environment (freezer) to simulate a change in environmental conditions.

In each of the operating conditions explored, the resonant behavior of the structure was investigated by impacting the canister with an impact hammer at the location used for the IM investigation and measuring the response using the triaxial accelerometer. The acquired FRFs are shown for all three directions up to 1,500 Hz in FIG. 8. Note that the changes in the FRFs due to changes in the operating conditions were far more drastic than the changes in the FRFs due to damage. For instance, the increase in damping due to the foam in the canister produced dramatic changes across the entire frequency range in all three directions. Furthermore, when the second resonance was investigated more closely (FIG. 8(b)), while damage did produce a slight decrease in frequency and increase in amplitude, the alterations of the canister's operating conditions produced much larger changes in the canister's modal parameters. This variability due to changes in the operational environment makes the application of vibration-based inverse methods for damage detection difficult.

When IM was applied to the canister in the pristine state, there was almost no modulation around the 60 kHz carrier signal in any of the 4 measurements taken on the canister (FIG. 9, left). However, after the canister was impacted and the crack was produced, the modulation became prominent in the θ-direction as shown in the second column of FIG. 9. However, in each of these cases the modulation predominately occurred only on one side of the carrier frequency. If this problem is viewed as an inverse problem, it is evident that if the response is only modulated on one side of the carrier frequency, the response of the canister will have a modulation term of the form,

cos((ω₁−ω₂)t)=cos(ω₁t)cos(ω₂t)+sin(ω₁t)sin ω₂t) (10)

Rather than containing a single multiplicative term as did the two-sided modulation in Equation (9), the response in Equation (10) now contains two products, the second of which indicates that a 90 degree phase shift has occurred. It is believed that this can be explained by the inclusion of nonlinear damping in the equation of motion, Equation (8).

When the canister was stuffed with foam, the increased damping due to this boundary condition was observed with a lower response and fewer lightly-damped peaks in the modulated portion of the FRF; however, some modulation was still observed indicating that the crack was present (3rd column in FIG. 9). Furthermore, although the modulation was seen to decrease in the case when the canister was cooled, the modulation was greater than in the case of the undamaged canister (FIG. 9). This decrease in modulation may be due to the fact that during the cooling process the lack of humidity control may have caused condensation during the cooling process and resulted in water filling the crack, which has been shown to decrease the magnitude of modulated peaks. To quantify the amount of modulation present, the mean of the signal's frequency content from 58 to 58.5 kHz was subtracted and then the ratio of the sum of the frequency content in the modulated region to that at the driving frequency was calculated. The resulting modulation index for the θ-direction response increased by a factor of 17 for the damaged canister and by factors of 13 and 1.9 for the canister that was stuffed with foam and the cold canister respectively (FIG. 10).

An impact identification system was designed that uses a single triaxial accelerometer to detect, locate, and quantify an impact on the canister. To solve this inversion problem accurately and efficiently, an FRF model was created by experimentally acquiring a reduced set of FRFs on the structure and then interpolating the results using functions designed to approximate the mode shapes of the canister in each direction. The inherent multidirectional coupling of the canister was then utilized to determine the impact point using an iterative least squares algorithm. Using this methodology, the impact location was correctly localized to less than 4% of the structure 99.5% percent of the time.

Once a possibly damaging impact had been detected on the canister, further investigation into the true existence of damage was needed. However, damage detection methods based on the canister's vibrations were inherently difficult to apply because of the wide variety of ways in which the structure's dynamics could be altered. Changes in either the canister's operating boundary conditions (propellant filler) or environmental conditions (temperature and humidity) resulted in changes that masked the initiation of damage. To solve the damage detection problem in the face of this variability, a study was performed on the missile canister which demonstrated that the nonlinear modulation due to a crack in the canister was not only a clear indication of damage but persisted despite changes in both the canister's environmental and boundary conditions. A combination of these load and damage detection methods is proposed to develop a health monitoring system for a filament wound missile canister.

What follows is discussion of one embodiment of the present invention that was used in a series of experiments. The discussion of this series of experiments refers to a number of equations, each by a number. Those numbers pertain to equations within these experiments and not to equations in other portions of the document.

Various embodiments of the present invention pertain to analysis of damaging impacts to a device. As one example, various embodiments will be discussed relative to a device that is a filament wound missile component. If the damage is assumed to occur at the same input degree of freedom (DOF) as the applied force, which is located and, only the level, not the location, of the damage should be determined via a semi-active damage detection technique. The term “semi-active” has been used to describe this ability to apply active damage detection techniques with data from passive sensors. The ability to apply a semi-active damage detection technique, such as those discussed in this document, increases the robustness and usefulness of passive SHM systems.

A frequency response function (FRF) is a ratio of the Fourier transform of the structural response at a specific output DOF to the Fourier transform of the input force at a specific input DOF. In a passive SHM, the FRF matrix is determined, or trained, using known input and output data in order to model the structural input-output behavior of a structure. Based on the trained model, input forces are located and quantified using passive force estimation techniques. A passive force estimation technique developed in accordance with various embodiments of the present invention assume that a single, impulsive force acts on the structure and utilizes curve-fitting processes in order to minimize the adverse effects in the force estimate from damage sustained by the structure and from changes in the boundary conditions. However, other embodiments of the present invention are not so constrained, and contemplate multiple forces of any type, including non-impulsive forces including repetitive forces. With regards to those embodiments using a single impulsive force, in the time domain, the curve-fitting process constrains the force to zero until the force exceeds a threshold, and after the peak amplitude is reached and the force drops below the same threshold, the force is again constrained to zero. The amplitude of the curve-fit force estimate is then adjusted in the frequency domain in order to account for the signal energy lost by constraining the force to zero outside of the main lobe of the forcing function in the time domain.

Assuming that the estimated curve-fit force is an accurate representation of the applied force, both the structural response and input force are known, and an updated FRF can be estimated using the equation:

$${H}^{′} ( jω ) = \frac{X ( jω )}{{F}_{curve - fit}^{′} ( jω )} . \qquad ( 1 )$$

The updated FRF, H′(jω), reflects changes in the properties of the structure and environmental conditions. H′(jω) and F′_{curve-fit}(jω) indicate that the applied force and the updated FRFs are estimated, not measured, and X(jω) is a response measurement at a specific output DOF. The accuracy of the corrected FRF is directly dependent on the accuracy of the estimated force; therefore, it is helpful if the estimated force is reasonably accurate. Accuracy in the force estimate assists in the implementation of a curve-fitting process in the force estimation procedure that is used in various embodiments of the present invention. The structure should be excited over a frequency range (i.e., F′_{curve-fit}(jω) and in some embodiments of the present invention corresponds to an impulsive-type excitation force) in order to ensure that the structural dynamic characteristics of interest in the response data.

Consider the linear 4-DOF model shown in FIG. 2-1. To more realistically represent the typical situation where a full analytical model of a structure is not available, the model is considered to have an underdetermined system of equations where the number of possible input DOF is larger than the number of known outputs (x₁, x₂, x₃). The stiffness of k₄ is assumed to undergo a 10% reduction for any force over 50 lbf applied to the fourth DOF. Because the stiffness of k₄ is assumed to instantaneously decrease during the application of the force, the stiffness of the model is time variant. The varying stiffness of k₄ is modeled in two ways that assume the damage due to impulsive forces is discontinuous in nature.

The force shown in FIG. 2-2 is applied to the fourth DOF, and correspondingly, the damage level of k₄ increases to 10% soon after the force starts to act on the fourth DOF. A first modeling technique according to one embodiment of the present invention is used to model the reduction in stiffness of k₄ assumes that the actual response of a time-variant structure is a combination of the responses of a healthy structure and a damaged structure. For real structures, like the filament-wound missile casing, it is difficult to determine the exact time that damage is sustained. The lack of information concerning when the damage is sustained makes it difficult to determine the exact percentages of the contributions due to the healthy structure and damaged structure. However, in order to investigate how the time-variant structural properties affect the semi-active damage detection process, three different weight factors are used to estimate the response of the time-varying model by calculating a weighted average of the damaged and healthy structural responses.

Because the applied force quickly surpasses 50 lbf with respect to the total time span of the non-zero portion of the forcing function, a second modeling technique according to other embodiments to represent the damage process assumes the structure is damaged at the instant the force is applied to the fourth DOF. If damage occurs at the instant the force is applied to the structure, the force is actually acting on a damaged structure, and the response of the structure reflects changes in the structural properties and FRFs caused by the damage.

The assumption that the structure is damaged prior to the impact contradicts the experimental tests where a damaging impact is quantified. However, valuable insight is gained from investigating the 4-DOF, linear, discrete structural model under this assumption because the procedure followed in order to calculate the updated FRF is the same for both the analytical and experimental applications.

One simplified method to determine the response of a structure with time-varying properties due to a damaging impact is to assume that half of the response is associated with a healthy structure and half of the response is associated with a damaged structure. For the 4-DOF model that sustains a 10% reduction in the stiffness of k₄ when a damaging force is applied to the fourth DOF, the actual response is assumed to be the average of the response of the healthy model subject to the same force and the response of the damaged model. The estimated force and updated FRF for the third DOF with respect to a force at the fourth DOF using the averaged responses (which include measurement noise) are shown in FIG. 2-3 and FIG. 2-4, respectively. As evident in FIG. 2-3b, the force applied to the fourth DOF is corrupted by noise forcing functions (e.g. environmental acoustics), and the random noise forces are also applied simultaneously to the other three DOF. The noise sources are assumed to be ambient input forces that act on all DOF resulting in noisy response measurements. The random forces have a mean of zero, standard deviation of one, and a maximum peak-to-peak amplitude of 1.0% of the root-mean-squared value of the pristine forcing function applied to the fourth DOF.

The amplitude of the estimated force may be erroneous in FIG. 2-3, but the shape of the magnitude of the force in the frequency domain more accurately represents the applied force, and the resulting FRF resembles the FRFs corresponding to both the damaged and healthy components. If an averaging scheme that weighs both the healthy and damaged responses equally is used to represent the time-varying structure, the estimated FRFs contain characteristics of both the healthy and damaged structures. The combination of characteristics is especially evident at the peak of the FRF at the third natural frequency as shown in FIG. 2-4b. The peak of the FRF has split to include two frequencies: one at the natural frequency of the healthy structure, and one at the natural frequency of the damaged structure.

As the percentages of the contributions of the damaged and healthy responses to the time-varying response change, the shape of the estimated FRF and the split peak for the third natural frequency change. If the actual response is assumed to be 80% representative of a healthy structure and 20% representative of a damaged structure, the estimated FRF more closely matches the FRF of a healthy structure than a damaged structure as FIG. 2-5 shows. Conversely, if the response is 20% due to a healthy structure and 80% due to a damaged structure, meaning that the damage is sustained very shortly after the force is applied, the FRF represents the FRF of the damaged structure more than the FRF of the healthy structure as FIG. 2-6 illustrates.

If a structure is damaged from a force at approximately the instant the force is applied, a second technique for modeling the time-variant structural properties is to assume that the structure was damaged prior to the force being applied and that the applied force causes no further damage. When the FRFs of the healthy structure are known, the force estimate for a force acting on the damaged 4-DOF model with a 10% reduction in k₄ and noisy response measurements is shown in FIG. 2-7. One force estimate is found after curve fitting the original force estimate in the time domain and equating the energy of the curve-fit and originally-estimated forces. This method of estimating the force is by example only, and other embodiments of the present invention contemplate other methods for estimating the force.

The adjusted curve-fit force is used in Equation (1) to find the damaged FRFs for the three output-measurement DOF with respect to an impact at the fourth DOF. The newly estimated FRF, the FRF of the damaged structure, and the FRF of the healthy structure for the third DOF for a force applied to the fourth DOF are compared in FIG. 2-8. The corrected FRF closely matches the damaged FRF because the estimated force closely matches the applied force. The noise that corrupts the response measurements affects the accuracies of the FRF estimates at higher frequencies and at frequencies away from the natural frequencies of the model (e.g., antiresonances) where low signal-to-noise ratios (SNRs) are typical. The reduced accuracy of the corrected FRF at higher frequencies is attributed to the lack of modal (natural) frequencies above 500 Hz, not due to the fact that the applied force did not adequately excite the higher frequencies.

As FIG. 2-9 shows, the frequency at which the magnitude of the applied force drops 20 dB is approximately 1,200 Hz (the reference value used for the decibel scale is the DC value of the force).

Although most of the inaccuracies of the estimated FRFs in the above example are due to reduced modal densities at higher frequencies, inaccuracies in the estimated FRFs can occur if the applied force does not adequately excite the frequency range of interest. For example, the force shown in FIG. 2-10 is applied to the fourth DOF of the damaged 4-DOF model. The force is six times as wide in the time domain as the previously applied force simulating a longer duration impact, and, accordingly, the 20 dB roll-off frequency is approximately six times lower.

The curve-fit estimate for the force in FIG. 2-10 is shown in FIG. 2-11. For frequencies below the 20 dB drop-off frequency the estimated force generally matches the applied force, and the force estimate becomes more erroneous with increasing frequencies. The error in the force estimate is reflected in the corrected FRF estimates as shown in FIG. 2-12.

The errors in the corrected FRF at frequencies beyond the frequency at which the applied force drops 20 dB in magnitude are evident for the force that has a roll-off frequency of approximately 200 Hz even though the higher frequencies contain modal frequencies. The fact that the error in the corrected FRFs increases for frequency regions outside the main frequency region of excitation may mean that the process of correcting the FRFs in order to apply an active damage-detection technique may be better suited for impulsive impacts that excite a very broad range of frequencies. Two active damage-detection techniques are considered later, and the applied force is the broad-band force of FIG. 2-9, which shows a drop of 20 dB in magnitude at approximately 1,200 Hz, and the structure is assumed to be damaged prior to the force acting on the structure.

One measure of the change in structural properties of a structure is the normalized difference between the FRFs of the healthy and damaged structures as shown in Equation (2):

$${H}_{difference} = \frac{{H}_{damaged} - {H}_{baseline}}{{H}_{baseline}} . \qquad ( 2 )$$

This normalized measure of change in the FRF is the basis for a transformation matrix. The comparison of the actual and estimated normalized change in the FRFs for the third DOF of the 4-DOF model with respect to a force applied at the fourth DOF is shown in FIG. 2-13.

The noisy response measurements have an effect on the accuracies of the estimated FRF difference shown in FIG. 2-13. The effects of the noise are apparent at frequencies away from the natural frequencies of the system where there are poor SNRs. Therefore, when quantifying damage with a technique involving the normalized difference of the FRFs (as in Equation (2)), it is helpful to focus on frequency ranges near the natural frequencies of the structure or regions of the FRF with high SNRs.

In order to demonstrate the ability of the normalized FRF differences to quantify different levels of damage, the force and FRF estimation processes are repeated for three other levels of stiffness reduction (5%, 15%, and 20%), and the normalized differences between the healthy and estimated FRFs of the third DOF with respect to an input at the fourth DOF are found. The normalized differences for the four levels of damage are summed over four frequency ranges that are 10 Hz wide and centered at each natural frequency of the healthy structure in order to find a single-number damage index (DI). The damage indices for the four damage levels are shown in FIG. 2-14. It is clear that the estimated damage indicator closely matches the actual values, and that the normalized difference damage index of the FRF quantifies the different damage levels. The damage index is close to being linearly related to the damage level because the 4-DOF model has linear structural properties and the damage is being modeled using a percent decrease in the stiffness.

The natural frequencies of a specimen are dependent on the structural properties of the component. Therefore, if the structural properties of the component change, because of damage for instance, the natural frequencies of the component will shift to neighboring frequencies. Consider the FRFs for the healthy and damaged (10% stiffness reduction of k₄) components for the third DOF of the linear, 4-DOF structural model shown in FIG. 2-8 and FIG. 2-12. As FIG. 2-13 illustrates, all four natural frequencies shift to different frequencies, but the third natural frequency exhibits the greatest change. The damage sustained by any general structure can affect each natural frequency differently. Assuming that the sustained damage can be modeled as a change in stiffness and no structural mass is added or removed (i.e., the impacting object does not embed into the specimen), the degree to which the damage changes the different natural frequencies can be estimated by inspecting the modal deflection shapes for each modal frequency.

The four modal deflection shapes are approximated for the linear 4-DOF system and are shown in FIG. 2-15. The modal shapes are determined by using the co-quad, or peak-pick, technique. The peak-pick technique assumes that the modes of the structure are largely uncoupled and at every natural frequency, only one mode shape dominates the response. The modal shape can then be estimated by recording the imaginary portion of the corresponding FRFs (e.g., H₁₄, H₂₄, H₃₄, H₄₄) at each natural frequency.

As shown in FIG. 2-15, the modal shape corresponding to the third natural frequency at approximately 233 Hz exercises the relative motion between the third and fourth DOF more than any of the other modal deflection shapes. Consequently, the stiffness reduction of k₄ affects the third natural frequency the most.

Because the linear stiffness of k₄ largely affects the third natural frequency, the modal stiffness for the third modal frequency is directly proportional to the stiffness of k₄. Modal stiffness can be characterized by:

$${ω}_{{n}_{i}} = \sqrt{\frac{{k}_{{n}_{i}}}{{m}_{{n}_{i}}}} \qquad ( 3 )$$

where ω_{nI} is the ith natural frequency of the structure, k_{nI} is the corresponding modal stiffness and m_{nI} is the modal mass. Again, assuming that the damage of a structure can be modeled as a change in stiffness and all modal masses remain unchanged, the change in the natural frequencies of the structure reflects the change in the modal stiffnesses. Therefore, changes in the third natural frequency of the 4-DOF model reflect changes in the third modal stiffness and, consequently, changes in the stiffness of k₄.

The amount that the third natural frequency shifts in Hertz for varied stiffness reductions of k₄ is shown in FIG. 2-16. As the damage level increases, the shift in frequency of the third mode increases. Similarly to the normalized difference damage index, the frequency change is linear with respect to damage level because the 4-DOF model has linear structural properties, but, as is shown in the following experimental-application section, structural properties and the relationship between frequency shifts and damage level are not always linear.

A filament-wound missile casing is used as a test structure to investigate the applicability of the semi-active damage detection techniques previously discussed to structures with continuous structural properties. In order to adequately excite the natural frequencies of the missile casing during a damaging impact, a six ounce tack hammer, shown in FIG. 2-17, is used to strike the casing. The hammer is lightweight yet strong enough to deliver the force over a small area to damage the casing. The impact from the tack hammer represents a damaging impact that the casing might experience in normal operating conditions because the hammer is lightweight and should impact the canister with a high velocity in order to cause damage as in the case of flying debris from helicopter blade wash.

The casing is suspended by two cotton strings attached in series with bungee cords, as shown in FIG. 2-18. Because a standard tack hammer is used to strike the missile casing, the actual force is not recorded and the energy of the impact cannot be specified prior to the impact. Therefore, the passively estimated force is assumed to be correct and the peak force of the estimated force is used as a metric to quantify the damage that is caused by the impact. For example, an applied force with a peak amplitude of 450 lbf is assumed to cause less damage than a force with a peak amplitude of 650 lbf.

A handmade triaxial accelerometer consisting of three shock accelerometers, PCB 350B02 (0.1 mV/g), is mounted on the nose of the missile casing as shown in FIG. 2-19. The shock accelerometers are used in order to comply with the measurement range of the NI USB-9233 data acquisition system that is used for the tests in this section.

The passive force estimation and semi-active damage detection techniques previously described are investigated for four different damaging impacts. Before each damaging impact, a modal impact hammer with a metal tip is used to train the FRF matrix for the specific input DOF where the damaging impact acts, and after the damaging impact, the modal hammer is again utilized to find the damage FRF matrix. The sampling frequency for the data acquisition system for all tests, including the damaging impact, is 12,500 Hz to maximize aliasing, and the number of data points recorded is 32,768. The input DOF for the four damaging impacts are labeled as Points A, B, C, and D. The location of Point A is approximately half-way between Points 17 and 23 of the discretized grid consisting of 24 points, 4 equidistant points circumferentially at 6 equidistant longitudinal locations. The location of Point A was chosen in order to give a more balanced SNR for the X- and Y-directions accelerometer signals. The use of shock accelerometers with unshielded cables generally introduces much more noise in the response measurements than the accelerometers with coaxial cables. Consequently, SNR problems are much more prevalent when using the shock accelerometers with unshielded cables.

An impact at Point A better balances the resulting structural responses between the X- and Y-direction accelerometers than an impact at Point 17 or 23. Point B is located along the same axial line as Point Z, but Point B is centered between Points 16 and 22. Point C is located approximately 180 degrees opposite of Point A, between Points 5 and 11, but Point C is slightly closer to the nose of the missile than Point A. Point C is approximately half-way between Points 5 and 6 in the axial direction. Similarly, Point D is half-way between Points 4 and 10 and Points 4 and 5. Points A and B are offset from Points C and D in the axial direction in order to always train and damage an input DOF with undamaged fibers around the circumference of the casing (hoop fibers). A higher amplitude force is applied to the casing at Points C and D compared to the force applied at Points A and B. The damage levels estimated via the semi-active damage detection techniques described previously are compared for the four input DOF.

For each of the four damaging impacts investigated, the applied force is estimated using the response data from the triaxial accelerometer (3 single-axis shock accelerometers) and the trained FRF matrix. The originally-estimated and curve-fit forces for the damaging impact at Point D are shown in FIG. 2-20a in the time domain and in the frequency domain on a dB scale in FIG. 2-20b (the DC value of the curve-fit force is used as the reference value for the dB scale).

The magnitude of the force falls 20 dB at approximately 800 Hz, and the end of the first lobe of the force is at approximately 900 Hz. Also, the magnitudes of the force estimate in the second lobe of the spectrum have relatively high values with a few values near the 20 dB roll-off level of the force. Therefore, as the FRF in FIG. 2-22 shows, the applied force adequately excites the first two natural frequencies of the missile casing, and the force also adequately excites the third natural frequency at approximately 966 Hz.

The force at Point D causes a large crack in the axial direction as shown in FIG. 2-21. In order to quantify the damage sustained during the impact, the updated FRFs are estimated. The passively estimated force is used in Equation (1) with the three response measurements to estimate the damaged FRFs. The estimated FRF with respect to the Y-direction response measurement is shown in FIG. 2-22.

The high level of noise in the response measurements is evident in the FRFs as shown in FIG. 2-22. The error in the estimated FRF increases at higher frequencies because the error in the force estimate increases at higher frequencies. As shown in FIG. 2-22, the magnitude of the force deviates from the shape of the magnitude of the originally estimated force at higher frequencies. However, disregarding the fact that the magnitude of the estimated FRF is incorrect, one aspect of the FRF shown in FIG. 2-22 is that the FRF peak for the third natural frequency is split between the natural frequencies of the healthy structure and the natural frequencies of the damaged structure. As explained above, the peak splitting phenomenon is a result of the structural response being influenced by both the healthy and the damaged structural properties.

FIG. 2-22c also illustrates that the third natural frequency experiences the largest shift in frequency of the first three modes. The sensitivity of the third mode to the structural damage sustained at Point D is explained by analyzing the modal deflection shapes of the first three natural frequencies. The modal shapes for the first three modes are estimated using the peak-pick, or co-quad, technique and are shown in FIG. 2-23. Only the deflection shape of one axial line along the missile casing is needed, assuming axial symmetry, to find the modal shapes. The modal shapes are estimated using the FRF of Points 1-6 and the Y-direction accelerometer data for a healthy missile casing. The modal deflection shape of the third mode exercises the relative deflections of the casing near Point 4, Point 5, and, consequently, Point D more than the other modal shapes. Therefore, as explained in the analytical section, the third natural frequency is sensitive to the first three natural frequencies to structural damage at Point D and, accordingly, at Points A, B, and C also.

Although the third natural frequency shifts in frequency when the casing sustains damage, the second natural frequency only shifts in magnitude, and the first natural frequency is minimally affected by the damage. The shift in amplitude of the second mode can be linked to the shift in the natural frequency of the third mode. If the casing is modeled as a linear superposition of uncoupled, lightly-damped modes, the shift of the third natural frequency pushes the magnitude of the second frequency up. The shift of the third natural frequency affects the amplitude of the second mode more than the first mode because the second mode is relatively close, with respect to frequency, to the third mode. The contribution of the third mode to the total FRF at the first natural frequency is negligible because the first mode is at a much lower frequency.

The fact that the third natural frequency is excited for the types of damaging impacts considered in this document and that it is sensitive to structural damage in most areas of the casing because of its deflection shape is helpful because the modal shape of the third natural frequency is similar to the deflection shape of the casing when it is pressurized. The shift in the natural frequency of the third mode is an indicator of how much the stiffness for the third modal shape has decreased, and, therefore, can lend insight to reductions in burst pressures as a result of sustained damage. The sensitivity of the third natural frequency to the structural damage induced by impacts considered in this document can be used to quantify the damage, but first the normalized differences in the estimated and healthy FRFs are discussed

The normalized difference between the damaged and healthy FRFs is a measure of change in the structural properties of a structure. If the operating and environmental conditions are constant, the change in the FRFs can be used as a damage indicator. Equation (2) is used to find the normalized difference between the damaged and healthy FRFs for an impact at Point D with respect to the Y-direction accelerometer measurement, and the differences are shown in FIG. 2-24 as a function of frequency. The normalized difference is largely affected by 1) errors in the force estimate and 2) noise in the response measurements. The force errors were shown to increase at higher frequencies in the previous section. The inaccuracy of the force estimate explains the large contradiction in the normalized difference in the FRF of the estimated and the modally-determined FRFs, FIG. 2-24. In regions near the natural frequencies of the structure, where the SNR is relatively high, the normalized difference is slightly less affected by the noise and is a smoother function. The smoother difference function around the natural frequencies is evident for the Y-direction data around the third natural frequency as illustrated in FIG. 2-24c.

One natural frequency is below the frequency at which the applied force decreases by 20 dB, and the effect of the sustained damage on the FRF near this first natural frequency is negligible as shown in FIG. 2-22b for the impact at Point D. Consequently, the normalized differences between the FRFs are summed around the second and third natural frequencies, which are adequately excited by the applied force and demonstrate changes due to the sustained damage, in order to find a single-numbered damage index (DI). The two frequency regions are ten Hertz wide, and the damage index is found for the four damaging impacts considered in this chapter. The damage indices for the data from the X-, Y-, and Z-direction accelerometers are shown as a function of the peak amplitude of the applied force in FIG. 2-25. The peak force is assumed to be proportional to the amount of structural damage sustained by the casing.

The estimated damage index for all three response measurements is consistently higher than the damage index from the FRF found from modal impact testing. The damage index from the modal FRF illustrates the expected upward trend with increasing peak force, but the estimated damage index does not portray as well this direct relationship. The estimated damage index not correlating as well with expected results or the results from the modal impact testing can be due to a combination of three factors.

First, the curve-fit force in FIG. 2-20 is erroneous at higher frequencies. The applied force is known to be impulsive, and impulsive forces have a smooth roll-off characteristic in the frequency domain. Therefore, the shape of the curve-fit estimate of the force better represents the actual force applied, but the amplitude is inaccurate. Any errors in the force estimate are carried through to the estimated FRFs and, finally, to the normalized difference in the FRFs.

A portion of the errors in the force estimates for the tack-hammer impacts are due to the forces acting on the casing that are not originally modeled in the trained FRF matrix. These unaccounted-for forces include those stemming from the nonlinear properties of the casing and the boundary conditions. The errors may also be due to the impact location of the tack-hammer impact. The casing is not struck with the tack hammer at the exact training location because of human error. The distances of the tack-hammer force from Points A, B, C, and D is approximately 0.375, 0.5, 0.5, and 0.0 inches, respectively. An estimated impact that acted away from the trained DOF is erroneous because the appropriate FRFs are not used to estimate the force. Also, the method of virtual forces, of which the normalized difference in the FRFs is the transformation function, is sensitive to the input location of the applied force. Therefore, because the location of the modal impacts are better controlled than the tack-hammer impacts, the damage indices from the modal impacts are more reliable than the indices found from the estimated FRFs, and the erroneous force estimate greatly affects the accuracy of the damage indices from the tack-hammer impacts.

Secondly, the axial location affects the damage index. The impacts at Points B and D have higher damage indices than the impacts that act closer to the nose of the missile casing. The higher damage indices occur because the third modal deflection shape, the shape of one mode affected by the damage, has a higher amplitude near the center of the casing that exercises and makes apparent the damage at Points B and D more than at Points A and C.

Thirdly, the four impact locations likely have different impact compliances. Therefore, the peak force may not be directly proportional to damage level. Two other indicators of damage level that might better correlate with the damage sustained by the casing are visual damage and the impulse (area under the curve) of the applied force.

The visible damage sustained by the casing does not increase with applied-force level. The applied force with a peak amplitude of approximately 630 lbf acts at Point C and causes less visible damage than the two impacts with lower peak amplitudes that act at Points A and B. The resulting damage from the three impacts at Points A, B, and C are shown in FIG. 2-26. The decreased amount of visual damage reflects the results of the normalized difference in the FRFs, and an upward, increasing trend for the tack-hammer damage index is apparent as shown in FIG. 2-27 for the Y-channel data. This upward trend would be even more evident if the DI for the impact with the highest peak force, Point D, was slightly higher. The reason why the DI for Point D is slightly lower than expected is that the FRF for Point D has a split peak possible that this peak is an artifact of the time-variant properties of the structure. When the peak of a FRF splits, both the characteristics of the damaged and healthy FRF are evident, and the difference between the estimated FRF and the healthy FRF decreases. Although the DI for the tack-hammer impacts increases with visual damage, the upward trend that was apparent for the modally-determined DI when comparing DI to the peak force is no longer evident. Because damage in a composite structure is not always visible, the damage index is not required to follow an upward trend when compared to the visible damage sustained in order to accurately assess the damage level. The damage indices determined from the modal impact are likely more correct than the tack-hammer indices because of errors in the force estimate; therefore, it is more appropriate to compare the damage indices for the normalized difference in the FRFs to peak force or the impulse of the force.

The applied force that is passively estimated is narrow with respect to time, but the force is large in amplitude. The estimate of the peak amplitude for this type of impulsive force is susceptible to the sources of error previously discussed. However, relatively, the area of the estimated force, i.e., the impulse of the force, is not as sensitive to slight errors in the force. Therefore, the damage indices from the normalized FRFs are compared to the impulses of the applied forces as illustrated in FIG. 2-28.

As shown in FIG. 2-28, the trend of the DIs when plotted with respect to the impulse of the applied force differs from the trend of the DIs when plotted with respect to the peak force. The modally-determined damage indices generally increase as the impulse of the applied force increases, especially for the data from the Z-direction accelerometer. If the estimated DI for the force with the largest impulse, Point D, was larger for all three directions, i.e. if its FRF did not have such a pronounced split peak, the trend of the tack-hammer DI would better match the DI determined modally and also the trend found when investigating the shift in the frequency of the third mode.

The third natural frequency is sensitive to structural damage along the cylinder-like portion of the casing. The modal stiffness of the third mode is related to the burst strength based on the modal deflection of the third mode. Therefore, shifts in the third natural frequency can potentially be used as a damage indicator that lends insight to the residual burst strength after damage is sustained.

The natural frequencies of the structure are global properties; therefore, the amount that the natural frequencies shift should be consistent for the FRFs with respect to all response measurements. Because of signal processing and noise error, the frequency shifts are different for response measurements in different directions (i.e., the frequency shift of the third mode for this application is different based on which triaxial-accelerometer measurement is utilized). The third natural frequency is evident in the FRF for all three response measurements in this example, so the average frequency shift of the third natural frequency is used as the damage-quantification metric. In most cases, the difference between the actual frequency shift and the average frequency shift is less than one Hertz. The frequency shifts of the third natural frequency for the four damaging impacts considered in this document are shown in FIG. 2-29 with respect to the peak amplitude of the applied force and in FIG. 2-30 when compared to the impulse of the applied force.

The frequency shifts for the tack-hammer and modal impacts do not strictly increase with increased peak force or impulse as expected, but the trend of the frequency shifts are similar to the trend of the damage indices from the normalized difference in the FRFs (when either peak force or impulse is used as a measure of damage), especially the trend of the modally-determined damaged indices. In contrast to the values of the estimated DIs not matching the modally-determined DIs, the estimated shifts in frequency closely match the modally-determined shifts. The results for shift in frequency better match compared to the DIs because the shift in frequency is concerned with how the third natural frequency changes with respect to frequency, not with respect to magnitude. Therefore, the technique of analyzing the shift in natural frequency is less dependent on the accuracy of the estimated force.

The effects of impacting at different axial locations are also apparent in the shift in natural frequency. The lowest peak force is from the force applied at Point B, and the next lowest peak force is from the force applied at Point A. The shift in frequency for Points A and B are close and the variability between the two shifts can be due to the different axial locations for the two input DOF as explained previously. The difference in shift in natural frequency between Point C and D is large because the impact at Point D causes much more damage than the impact at Point C.

The estimated level of damage from the impact at Point C (approximately 630 lbf peak force) is lower than expected if assuming a linear relationship between the DI of the previous section or the shift in the third natural frequency and peak force or impulse. The damage level for Point C is approximately the same as the damage level for impacts with much lower peak force or impulse providing a strong argument that a semi-active damage detection technique quantifies damage rather than assuming that the sustained damage is directly proportional to the peak force or impulse.

The concept of semi-active damage detection according to some embodiments of the present invention incorporates passive hardware, passive load identification, and active damage detection techniques. Semi-active damage detection techniques can include one or more of the following assumptions:
1. The applied force should be isolated and impulsive. The accuracy of the semi-active techniques increases as the broad-band nature of the applied force increases.
2. The applied force is passively identified and quantified correctly. The location of the impact and the FRFs, relating the force at the impact location to the response measurements, should be known a prior by developing an experimental FRF matrix model or estimating such a model using finite-element methods and then utilizing that model for force identification. This process can be made more efficient by introducing an interpolation to estimate FRFs for input DOF at which no experimental data is available.
3. Any damage sustained by the structure occurs at the input DOF at which the force acted. Therefore, the level of damage needs to be determined by utilizing a semi-active damage detection technique.

Various embodiments herein present at least two semi-active damage detection techniques. After the force is estimated, the curve-fit force is used to estimate an updated FRF. The estimated FRF models the damage sustained by the structure and is used to find the normalized difference between the damaged and healthy FRFs. The updated FRF is also used to find the frequency shift of a natural frequency that has a corresponding modal deflection shape that exercises the relative motion of the DOF that are affected by the structural damage. This shift in the natural frequency of the structure can be linked to a change in the stiffness that dominates that mode of vibration. The FRF-correction and semi-active damage quantification methods according to some embodiments can account for the facts that the structure has nonlinear structural properties that are time variant at the onset of damage (split peaks of the FRF can occur) and that the normalized difference in the FRFs is found to be sensitive to the location of the impact force.

The estimated FRF corresponds to the damaged FRF near modal frequencies where the SNRs are high. Similarly, the normalized differences in the FRFs are less affected by noise near resonant frequencies, and the damage index that focuses on regions near natural frequencies yielded somewhat of a direct relationship between damage level and the impulse of the applied force for the experimental application. The direct relationship between damage index and impulse (or peak force) is evident in the modally-determined damage index. The frequency shift of the third natural frequency of the casing produced more expected results than the normalized differences in the FRFs. According to one embodiment, semi-active damage detection technique that analyzes the shift in the third natural frequency can quantify damage sustained by the composite missile casing because it is not as dependent on the accuracy of the estimated force as many other active damage detection techniques.

When a structure is subject to boundary and operating conditions, the semi-active damage detection techniques may be used to quantify structural damage. The boundary conditions should be linear and modeled in a trained FRF matrix. The operating conditions when a damaging impact (which should be isolated and impulsive) is sustained should approximate the operating conditions when the FRF is trained because the accuracies of all semi-active techniques can be dependent on the accuracy of the passively identified and quantified applied force. It has been found that the robustness in damage-quantification abilities of passive HSM systems can be increased by stratifying certain assumptions and environmental conditions.

What follows is discussion of another embodiment of the present invention that was used in a series of experiments. The discussion of this series of experiments refers to a number of equations, each by a number. Those numbers pertain to equations in other portions of the documents.

A general structure can be modeled as a linear, lumped-parameter system, in which the n input forces, F(jω), and m response measurements, X(jω), are related by a matrix H(jω):

X(jω)_{m×1}=H(jω)_{m×n}F(jω)_{n×1}. (1)

Each entry in the X(jω) vector corresponds to a response measurement from a certain location and in a certain direction on the structure. Similarly, the entries of the F(jω) vector correspond to external forces acting at (in) specified locations (directions) on the structure. The frequency response function (FRF) matrix, H(jω), describes how the structural properties transform the input forces into output responses.

In passive structural health monitoring (SHM) techniques, the FRFs should be known a priori in order to infer forces given the structural responses. Typically, the H(jω) matrix is experimentally estimated (trained) in a test with known input forces and responses, for example, using impact testing, while a specimen is in its baseline (healthy) state. It is helpful to train the FRF model while the structure is subject to typical operating conditions and environmental loads so that the normal operating and boundary-condition forces are included in the data-driven model of the structure, H(jω). By testing under the proper conditions, errors in the estimated external forces can be minimized.

If the number of input forces, n, is equal to the number of output responses, m, the forces acting on a structure can be estimated by inverting the FRF matrix as follows:

(H(jω)⁻¹)_{n×m}X(jω)_{m×1}=F′(jω)_{n×1} (2)

where the prime in F′(jω) indicates that the forces are indirectly estimated, not measured. If the number of output responses is greater than the number of forces being estimated (m>n), the system of equations is overdetermined, and if the number of outputs is less than the number of inputs (m<n), the system of equations is underdetermined. For an overdetermined (or underdetermined) system of equations, a least-squares, pseudo-inverse technique can be used to estimate the forces:

F′_{n×1}=([H^{T}H]⁻¹ H^{T})_{n×m}X_{m×1} (3)

where the frequency indices have been excluded for convenience.

In one embodiment of the present invention, equations (2) and (3) are used to indirectly estimate the forces acting on a structure in the frequency domain. This method indirectly estimates forces in the frequency domain because of the ease of implementation of Eqs (2) and (3). An overdetermined system of equations in Eq. (3) leads to better numerical stability for the inversion of H(jω) than a fully determined (m=n) system. This stability is helpful because the FRF matrix is often ill-conditioned. When inverting an ill-conditioned FRF matrix, slight perturbations in the response measurements, like measurement noise typically contained in experimental data, are amplified into large, erroneous fluctuations in the force estimates. An overdetermined, least-squares, pseudo-inverse for matrix inversion helps minimize these large fluctuations in the force estimates without implementing a regularization technique as is often used when solving force-estimation problems.

The governing equations of motion for all real structures are inherently underdetermined (when modeled as lumped-parameter systems). Structures have continuous system properties with an infinite number of locations at which input forces can act. As a result, an infinite number of response measurements are required in order to ensure that the forces estimated in Eq. (1) are unique. However, response data often consists of a relatively small number of primary modes of vibration. In these cases, the equations for force estimation can be conditioned to provide reasonable estimates if assumptions can be made about the applied forces and one or both of the techniques described in this document are applied.

Various embodiments of the present invention address the technical issues of performing passive force estimation for forces acting on structures that have noisy response measurements or sustain damage that alters the values of the FRF matrix. The “training” of the FRF matrix can hinder the capabilities of passive health monitoring after the onset of damage because the baseline FRF matrix no longer accurately models the structure after damage occurs. If the input forces are indirectly estimated using the inaccurate H(jω) or with noisy response measurements, errors are introduced in the force values. However, if certain assumptions about the input forces can be made, e.g. only one force acts on the structure and that force is broadband impulsive, the force estimates can be curve-fit in the time or frequency domain in order to reduce errors and predict the actual forcing functions.

The techniques for force estimation according to some embodiments of the present invention are used to estimate non-damaging impulsive forces and damaging impulsive forces. Both the shape-based technique and the amplitude-based technique discussed in the next section incorporate the aforementioned assumptions (e.g., only one force acts on the structure at one input location and that force is broadband impulsive). Some of the features of the new shape-based technique are outlined below (it being understood that not all embodiments include all of these features or assumptions):

1. A continuous structure is discretized such that a finite number of possible force locations are considered. The FRF matrix is populated by measuring the structural responses for an input force at each discrete location.

2. After an impact, each of the possible force locations is analyzed individually as if that location was the only possible force location. Assuming that more than one response measurement is available, Eq. (1) is solved as an overdetermined inverse problem for other possible forcing location on the structure.

3. The main lobe of the magnitude of the Fourier transform of an impulsive force is broad in frequency and has a smooth roll off with increasing frequency. Because the impact force acting at one of the possible forcing locations is assumed to be impulsive, only the correct force estimate will possess this smooth, roll-off characteristic.

4. A quadratic line is curve fit to some of the force estimates in the frequency domain, and the squared deviation of each force is calculated from its respective curve-fit line and is normalized by the mean of the force magnitude. This normalization emphasizes small deviations in small force estimates and de-emphasizes smaller deviations in large amplitude forces.

5. The force with the lowest normalized squared deviation from its curve-fit line is assumed to be the impact location.

6. The force is curve-fit in the time domain to eliminate errors from signal processing, measurement noise, and ill-conditioning of the FRF matrix. The curve fitting is based on the assumption that the impact force is impulsive; consequently, the force is set to zero before and after the peak force with respect to time when the force magnitude falls below a threshold equal to a percentage of the maximum force value.

A second technique of indirect force estimation is based on the amplitude of the possible force estimates in the frequency domain, rather than the shape of the force estimates as in the previous technique. The main steps of this technique are outlined below:

1. As in the shape-based technique, the structure being monitored is discretized into a finite number of input DOF, and the FRF matrix is measured.

2. Using some of the response measurements available, the input forces are estimated at two of the possible force locations. For force estimation utilizing a triaxial accelerometer, which provides three equations of motion, the estimation of two forces is an overdetermined problem.

3. The values of the magnitude of the two forces are compared in spectral regions near resonant frequencies. Spectral bands far from resonant frequencies and near anti-resonances are susceptible to changes in the structural properties and operating conditions because of poor signal to noise ratios, and this susceptibility can lead to erroneous force estimates. In regions near resonant frequencies, the signal to noise ratio is much more likely to lead to more accurate force estimates. However, as mentioned previously, the FRF matrix is often ill-conditioned near resonant frequencies causing large, incorrect estimates of the forces. However, the ill-conditioned FRF effects are less disturbing to the force estimates than the signal to noise ratio, and when two forces are compared, the force estimates are often more accurate near resonant frequencies.

4. The ill-conditioned effects when comparing the values of two force estimates are minimized by finding the median of each force over the combined regions of consideration (those near resonant frequencies). The median of the force estimates is not skewed by the large fluctuations that can occur because of the inversion of the FRF matrix. Of the two forces being compared, the force with the highest median value is assumed to be the correct location of the impact force. Neither of the two force locations being considered need be the correct location, but the force that is considered the “correct” force in this step will later be compared to another “correct” force stemming from another pair of possible force locations. Eventually, the force estimate for the location that is actually correct will appear in the final two possible forcing locations and prevail with the highest median value (in theory, the other force to which the correct force is being compared should have amplitudes of zero in the frequency domain because the force acts at one location).

5. Steps 1-4 in some embodiments can be repeated for a new pair of possible input locations until all possible input forces have been compared to at least one other possible force. After this step is completed, the number of possible input locations should have been reduced by at least half.

6. Steps 1-5 in some embodiments can be repeated for the remaining possible input forces in order to reduce the number of possible input locations by half again.

7. Steps 1-6 in some embodiments can be repeated until two possible input locations remain. The last two possible forces are compared as steps 1-4 describe in order to identify the location at which the force actually occurred.

8. Using all of the structural responses available, the overdetermined inverse problem of Eq. (3) is solved in order to estimate the force at the location identified in step 7.

9. The estimated force is then curve fit as described in step 6 of the shape-based method in order to find a better estimate of the actual forcing function. The amplitude-based technique actually uses the same number of force estimation calculations as the shape-based method and uses simple logical intermediate steps to narrow the number of possible forcing locations. One aspect of utilizing the amplitude-based technique with more intermediate steps is realized when identifying and estimating non-impulsive impacts as described below.

Consider the linear, discrete four-degree-of-freedom (4-DOF) system shown in FIG. 3-1. The displacements of the first three masses are measured, emulating the response measurements from a triaxial accelerometer that will be used in the experimental application section, but the displacement of the fourth mass is not. However, it is possible that an input force acts on any of the four masses. The system of equations in Eq. (1) is, therefore, underdetermined. The FRF matrix used in Eq. (1) is populated with respect to a healthy, baseline structure with the properties shown in Table 1. The properties were chosen so that the structural system is lightly damped and so that the modes of vibration are largely uncoupled as in the test specimen used in the experimental section.

A half-sine-wave, impulsive force with a peak amplitude of 150 N and width of 0.0011 seconds is applied to the fourth DOF and the two aforementioned techniques for passive force estimation are used to estimate the location and magnitude of the force. The force is applied to the fourth DOF rather than any of the first three DOF because in an actual application, such as the rocket motor casing, the impact location is often not collocated with any response measurements. The impact is assumed to cause damage to the system, and noise is included on the response measurements. The analytical simulation uses a sampling frequency of 10,000 Hz in order to capture the shape of the input force and a time span of 6.5536 seconds (65536 samples).

TABLE 1
System properties and natural frequencies of the 4-DOG shown in
FIG. 3-1

| | | |
|---|---|---|
| m₁ | 0.25 | kg |
| m₂ | 0.25 | kg |
| m₃ | 0.25 | kg |
| m₄ | 0.25 | kg |
| k₁ | 50,000 | N/m |
| k₂ | 200,000 | N/m |
| k₃ | 900,000 | N/m |
| k₄ | 300,000 | N/m |
| k₅ | 50,000 | N/m |
| c₁ | 2.5 | N/m/sec |
| c₂ | 2.5 | N/m/sec |
| c₃ | 2.5 | N/m/sec |
| c₄ | 2.5 | N/m/sec |
| c₅ | 2.5 | N/m/sec |
| fₙ₁ | 49 | Hz |
| fₙ₂ | 160 | Hz |
| fₙ₃ | 233 | Hz |
| fₙ₄ | 461 | Hz |

Consider the 4-DOF structure in FIG. 3-1 where the fourth mass is subjected to the impulsive force shown in FIG. 3-2. Suppose that any force equal to or greater than 50 N causes structural damage to the 4-DOF system in the form of a 10% stiffness reduction of k₄. FIG. 3-2 pictorially illustrates the damage level of the model as the impulsive force is applied. During the impact event, the structure sustains damage that alters the material properties and, therefore, the values of the functions in the FRF matrix. FIG. 3-3 illustrates how a 10% reduction in the stiffness of k₄ changes the FRF of the first DOF for a force applied at the fourth DOF.

The resonant frequency at approximately 233 Hz shifts to a lower frequency as a result of the damage and is the mode of vibration that is affected by the damage. The shift in frequency of the third mode is helpful in understanding errors that are introduced during the passive, force estimation process. Because the 4-DOF system sustains damage shortly after the force is applied to the fourth DOF, the damaged FRFs govern the response of the system, and, for simplicity, it is reasonable to assume that the system is damaged before the force is applied.

The force applied to the fourth DOF is corrupted by noise forcing functions (e.g. environmental acoustics), which result in noisy response measurements. The random noise forces are also applied to the other three DOF because the noise sources are assumed to be ambient input forces that act on all DOF. One manner of characterizing these random forces is to assume that the random forces have a mean of zero, standard deviation of one, and a maximum peak-to-peak amplitude of 1.0% of the root-mean-squared value of the pristine forcing function applied to the fourth DOF. The maximum amplitude of the noise forces is small compared to the maximum amplitude of the applied force because, in application, when an impulsive force capable of producing damage is applied to a structure, the maximum amplitude of the damaging force will be much greater than the amplitudes of random noise forces.

The noisy response measurements for the damaging impact applied to the four DOF differ from the pristine and healthy measurements at frequencies that had the largest change in the FRFs, namely near the third mode of vibration at 233 Hz. Therefore, it is conceivable that the passive force estimates for a damaging impact will have the highest error near frequencies that experience the largest change in the FRFs when damage is sustained. The erroneous force estimates near modes more affected by damage is evident in FIG. 3-4, as seen in the force estimate for the fourth DOF. FIG. 3-4 displays the results of the shape-based method of passive force estimation for an impact on a damaged structure with noisy response measurements.

The location of the force is visually evident by comparing the force estimates of FIG. 3-4 to their respective curve-fit lines. The force with the lowest deviation from the curve-fit line is that of the fourth DOF, and the force estimate is already as accurate as possible because all three response measurements were included in the calculation to make the system of equations as overdetermined as possible.

In order to locate the applied force using the amplitude-based technique for force estimation, the force estimates for the first and second DOF are compared along with the forces for the third and fourth DOF as shown in FIG. 3-5. The tendency of ill-conditioned FRF matrices to amplify small perturbations in the response data into large, erroneous fluctuations in the force estimates is evident in the force estimates for the third and fourth DOF as displayed in FIG. 3-5. The large fluctuation in the force estimates for the third and fourth DOF can be explained by analyzing the condition number of the FRF matrix used at each discrete frequency to estimate the forces.

The condition number is a measure of the numerical stability of a set of equations and bounds the possible solution. A matrix with a low condition number (a condition number should be greater than or equal to one) is considered to be well-conditioned and will yield force estimates that closely match the actual forces, and a matrix with a high condition number is ill-conditioned and can yield force estimates that are not close to the actual forces. FRF matrices with low condition numbers are desirable. FIG. 3-6 shows the condition number of the FRF matrices used in the force estimation calculations for the first and second DOF pair and the third and fourth DOF pair. It is evident in FIG. 3-5b that the compounded conditions of noisy response measurements and ill-conditioned FRF matrices cause large, rapid changes in the force estimates for the third and fourth DOF at certain frequencies.

Despite the large inaccuracies of the force estimates for the third and fourth DOF, the median force value for the two sets of force estimates are found in order to determine on which mass within each pair the force most likely acted. Four frequency ranges, each with a span of 20 Hz and centered around each of the natural frequencies listed in Table 1, are considered when finding the median value. Although the FRF matrix for frequencies near resonant frequencies can have higher condition numbers, it is found that the effect from the ill-conditioned FRF affects the accuracy of the force estimate for frequencies near resonant frequencies less than the SNRs for frequencies between the resonances. Regions between resonances, including antiresonances of FRFs not shown, are more affected by the noise than resonant regions because of low SNRs and, therefore, are not considered when finding the median force value. The median values, Table 2, for the four forces suggest that the impact occurred at the second or the fourth DOF, and the force estimates for this pairing are shown in FIG. 3-7.

TABLE 2
Comparison of median force values in the frequency domain for the first
iteration of force estimates for a damaging force

| Degree of freedom | Median force value (N) |
|---|---|
| 1 | 0.0104 |
| 2 | 0.1033 |
| 3 | 0.0247 |
| 4 | 0.0474 |

Qualitatively, the median force for the force acting on the fourth DOF is much larger than that for the second DOF indicating that the amplitude-based technique correctly identified the force location in the presence of damage and noisy response measurements. The force is quantified as well as possible by repeating the calculation of Eq. (3) using all response measurements to estimate one force. The result of the calculation is the same as that found for the shape-based technique shown in FIG. 3-4 for the fourth DOF. The estimate of the applied force is shown in the time domain in FIG. 3-8.

The damage and noisy response measurements cause the force estimate to be incorrect in its peak force estimate and have a ringing, or oscillating, effect after the main lobe of the forcing function. Both errors are primarily the result of damage because simulations involving noisy measurements and no damage did not produce errors in the force estimates that were as large as in the case of damage as shown in FIG. 3-8. The damage causes a portion of the signal energy of the force to leak from the main lobe of the forcing function into the subsequent oscillations. The error in the peak force is approximately 7%, but if this error is ignored temporarily, the force estimate at other points in time can be improved if the assumption that the force is impulsive, i.e., similar to the half-sine-wave force of this example, can be made.

If the impact force is impulsive, the applied force is assumed to be zero before the force begins to rise to its peak value, and the force returns to zero soon after the peak value is achieved. By knowing the form of the forcing function in the time domain, the force estimate is curve-fit in some embodiments of the present invention to minimize the adverse effects from sustained damage and measurement noise. The force estimate is assumed to be zero for all time before the forcing function exceeds a predetermined threshold, and the estimate is assumed to be zero for all time after the peak force when the force estimate drops below the same threshold. This threshold depends on the amount of measurement noise that is typical of the equipment used to collect data and is empirically determined. If the response measurements are noisy so that the force estimate is also noisy, the threshold for which all force values are neglected and set to zero should be higher than the force estimates with little noise. Also, care should be taken when determining the cutoff threshold because the threshold needs to be large enough to eliminate incorrect force estimates like that in FIG. 3-8 following the main portion of the forcing function, but not so high as to prematurely constrain the force to zero.

For the analytical example of this section where damage and noise are both included in the force estimate, the threshold below which the force estimate is constrained to be zero is 15 N, or approximately 10% of the peak force. When this constraint is enforced, the force estimate in both the time and frequency domains is as shown in FIG. 3-9.

The curve-fit force estimate in FIG. 3-9 in both the time and frequency domains closely resembles the shape of the applied force that is being passively identified. The large fluctuations of the original force estimate in the frequency domain are absent in the curve-fit force. The curve-fit estimate still has a lower peak amplitude than the actual forcing function, and the Fourier transform coefficients of the curve-fit estimate are also lower than those of the actual force. The Fourier transform coefficients for the curve-fit force are also lower than the original, non-curve-fit force estimate, which is also noticeable at frequencies below approximately 175 Hz, because some of the energy of the original force estimate is lost due to the curve-fit process when the force is constrained to zero before and after the main portion of the force during the curve-fitting process. In order to conserve energy during the curve-fit process, the curve-fit Fourier transform coefficients should be adjusted so that the original force estimate and the curve-fit estimate contain the same amount of energy from a signal-based perspective.

The process of equating the energies of the two signals includes that the response measurements contain noise that modifies the energy of the original force estimate. The energy in frequencies of the signal that result from the actual impact force rather than the noise should be equated. In frequency regions where the SNR is high, like near the first three modal frequencies, the measurement noise has little contribution in determining the force estimate. Therefore, the energy contained in the signal for frequencies that are less affected by measurement noise are compared and equated between the original and curve-fit estimates.

The total energy of a signal is related to the continuous Fourier transform coefficients by the following equation:

Energy=|F(0)|²+2Σ_{ω=0}_{⁺}^{ω2πfs/2}|F(jω)|² (4)

where fₛ is the sampling frequency in Hertz, ω is the circular frequency in radians/second, and the symmetric relationship of F(jω) is utilized. Eq. (4) should be modified for use with discrete Fourier transform (DFT) coefficients because force values at only discrete frequencies are known. The relationship between the continuous Fourier transform coefficients and the DFT coefficients can be approximated for periodic functions by:

$$F ( jω ) \approx Δ tF ( \frac{k}{T} ) \qquad ( 5 )$$

where k is an index that ranges between zero and the total number of frequencies at which the DFT is computed (denoted as N in later equations), T is the length of time (period) for which the response measurements are recorded, and Δt is the time increment between two data samples in the time domain. After substituting Eq. (5) into Eq. (4), the following expression for the total energy of a signal is found:

$$Energy = \frac{Δ {t}^{2}}{T} ( {\vert F ( 0 ) \vert}^{2} + 2 {\sum }_{k = 1}^{k = N / 2} {\vert F ( \frac{k}{T} ) \vert}^{2} ) \qquad ( 6 )$$

where 1/T stems from converting a discrete energy spectral density to a discrete energy spectrum.

In order to consider the energy in the original force estimate due to the actual impact and not measurement noise, the energy of the signal in frequency ranges with a large SNR is analyzed. Consider the original force estimate compared to the actual force for a frequency range from zero to half the sampling rate as shown in FIG. 3-10. The noise has a helpful effect at higher frequencies as discussed previously, but the shape of the estimated force follows that of the actual force for frequencies up to about 1000 Hz. If an assumption is made that the majority of the signal energy for the force estimate is at frequencies greater than zero (DC offset neglected) and less than 1000 Hz and is unaffected by noise, the total energy of the original estimate for frequencies greater than zero and less than 1000 Hz is compared to the energy of the curve-fit force for similar frequencies:

$$Scale = \frac{\sqrt{\frac{{Energy}_{Original\_Estimate}}{{Energy}_{Curve - fit\_Estimate}}}}{2} \qquad ( 7 )$$

Half of the square root of the quotient of the energy of the two signals in the focused frequency span, Eq. (7), is a scalar number by which the corresponding Fourier transform coefficients are multiplied. The ½ factor of Eq. (7) accounts for the symmetry of the Fourier transform because the positive frequencies were considered in the above analysis. The curve-fit force estimate after its Fourier transform coefficients are adjusted to account for energy that is lost in the curve-fitting process is shown in FIG. 3-11. The peak force increases as well as the DFT coefficients, and the adjusted, curve-fit estimate better matches the actual forcing function. The new curve-fit DFT coefficients also better match the original, non-curve-fit force estimate coefficients at frequencies unaffected by the damage, e.g., for frequencies less than 175 Hz. The new curve-fit force estimate has slight oscillations before and after the main lobe of the force in the time domain because the DFT coefficients no longer match a forcing function in which the force is equal to exactly zero before and after the impact. However, the oscillations have small amplitudes (less than 2 N peak-to-peak), so the small oscillations contain a small amount of the total energy of the signal and are neglected (but not eliminated).

The curve-fitting and energy-adjustment processes according to some embodiments are used in finding a force estimate that accurately describes the actual force for a damaged structure and noisy response measurements. These concepts and techniques describing the analytical application of the two proposed force estimation techniques are applied experimentally for forces acting on a filament wound rocket-motor casing in the next section. The experiments include locating and quantifying both non-damaging and damaging, impulsive impacts that include measurement noise. The experimental tests also investigate the robustness of the two force estimation techniques by attempting to identify non-impulsive impact forces and impulsive forces not acting at a trained DOF.

A filament-wound rocket motor casing is used as a test structure to investigate the applicability of the two aforementioned passive force identification techniques. The missile casing is approximately 0.178 meters in inner diameter, 0.61 meters in total length, and 7.95 millimeters in thickness. The rocket motor casing is empty for all experimental tests. A single, miniature, triaxial accelerometer (PCB 356A22) is mounted on the nose of the missile casing to acquire three orthogonal acceleration measurements. The sensor is positioned on the nose of the casing, to simulate a location in which the sensor would be protected inside the warhead instrument panel of the missile. A PCB 086C03 modal impact hammer or Instron Dynatup 9250HV drop tower is used to strike the structure depending on whether low-energy or high-energy impacts, respectively, are investigated. The data from the load cell of the hammer or the load cell in the tip of the drop tower carriage (the tup) is used for comparison to gauge the accuracy of the force estimates.

The two techniques for passive force estimation are used to identify and quantify impulsive forces, similar to the force applied in the previous analytical section, acting on a filament-wound rocket motor casing. Only isolated impacts are considered, i.e., no concurrent forces are applied to the test specimen, although it is understood that other embodiments of the present invention are not constrained by this consideration. Also, as in the first step of both force estimation techniques, the missile casing is discretized into 24 possible forcing DOF. Although the number of possible forcing DOF for this application is chosen to be 24, the accuracy of the estimated force does not depend on the number of possible input DOF, i.e., the accuracy of the applied force would be the same (assuming that three response measurements are available and that the correct input DOF is located) for a missile casing discretized into, as examples only, 18, 24, or 30 points.

The accuracy of the force estimate is a function of the ill-conditioned nature of the FRF matrix (assuming that the response measurement is not corrupted), which depends on the number of response measurements. The number of possible input DOF, when implementing the iterative force estimation techniques presented in this document, is preferably reduced to one regardless of how many or few possible input DOF there are originally. Alternatively, the precision of the estimated forcing location can depend on the number of input DOF using the training model because more input DOF corresponds to less distance between possible input DOF and a more precise estimate of the forcing location.

The number of DOF is chosen to be 24 for this application so that the distance between adjacent forcing points is approximately constant. The 24 points are distributed equally among six equidistant rings along the axis of symmetry of the missile casing, and the applied force is assumed to act at one of the 24 locations. FIG. 3-12 shows the discretized rocket motor casing with a triaxial accelerometer used to measure the dynamic structural response.

One triaxial accelerometer, PCB 356A22, is super-glued on the conic section, or the nose, of the rocket motor casing (RMC) at a location 25.4 mm from the metallic insert and in line with the column of impact locations that includes Points 1-6. The accelerometer senses the response of the structure due to forces applied at one of the 24 possible impact locations. As a result of utilizing an accelerometer for recording the structural responses, the FRFs and response measurements are in acceleration units (“g's”), not displacement as discussed previously. However, because both the FRFs and the responses are in terms of acceleration, no unit conversions or process alterations are needed in either estimation technique. Although the use of an accelerometer is shown and described, the present invention does not so constrain, other embodiments contemplate other devices to measure movement of the article as it responds to the force.

For the experimental tests discussed in this section, the missile casing is suspended by two rubber bands threaded through two diametric holes at the open end of the canister. The FRF matrix is experimentally populated via modal impact testing. A modal impact hammer is used to hit ten times at each of the 24 locations and the accelerometer responses for each hit are recorded. The FRF for impact locations with respect to the three measurements of the accelerometer are estimated using the H1 estimator.

The response and force data are recorded by an Agilent VXI (Agilent E142A, 51.2 ksamples/s) data acquisition system. Conventional force and exponential windows are applied to the appropriate time histories before calculating the FRF in order to reduce measurement noise and leakage effects, respectively. The force window is a rectangular window that has a value of one at the start of the time history and has a width of 10% of the total time span. The exponential window also has a value of one at the start of the time history, and the window exponentially decays to a value of 0.01 at the end of the time history. The time span of the impact tests is one second according to a sampling frequency of 8192 Hz with 8192 data points recorded. The sample rate of 8192 Hz is chosen because 1) it is a standard option available within the software (MRIT from the University of Cincinnati Structural Dynamic Research Laboratory) used for the modal impact testing, and 2) it is higher than twice the frequency at which the magnitude of the modal impact force falls below 20 dB of the force values at frequencies near 0 Hz. The magnitude (in dB) of a force applied at Point 1 from a modal impact hammer with a metallic tip is shown in FIG. 3-13.

After the FRF training matrix is populated, the modal hammer with a metal tip is again used to impart a force on the canister at one of the 24 determined locations. The force is applied in a direction normal to the canister. During and after the impact, the responses from the triaxial accelerometer are recorded. The trained FRFs found via modal impact testing and the recorded acceleration responses are then used to passively estimate the location and amplitude of the applied force.

When implementing the shape-based force estimation technique, the frequency span of 5-1000 Hz is considered when determining the differences between the estimated forces and their curve-fit lines. Similarly, the frequency ranges around the modal frequencies less than 1000 Hz are considered in the amplitude-based technique. As such, the frequency ranges of 520-580 Hz and 840-890 Hz are used when finding the median force values for the amplitude-based technique where the spans of the two frequency ranges are determined empirically.

TABLE 3
Comparison of the ability to correctly locate isolated, impulse forces for
the two passive techniques

| Method | Accuracy (%) |
|---|---|
| Shape-based | 97.8 |
| Amplitude-based | 97.2 |

The shape-based technique for passive force estimation assumes that the force acted at one distinct point among the 24 possible input DOF. Each of these 24 force estimates is then curve-fit with a quadratic line, and the overall, normalized difference between the force estimate and the curve-fit line is an error estimate that is calculated over the span of 5-1000 Hz. The force is assumed to act at the DOF with the lowest overall normalized difference. Because the shape-based method uses three response measurements to estimate one force 24 times, the force is both located and quantified in the same step. The amplitude-based force estimation technique uses multiple steps to locate and quantify the applied force.

The amplitude-based technique in one embodiment for force identification and quantification utilizes multiple force comparisons in iterative steps. For the chosen input-degree-of-freedom discretization of the missile casing, the first iteration of force comparisons breaks each of the six rings of four points into 2 pairs. The method for dividing the four points within each ring is arbitrary. The pairs are based on the two lowest numbered DOF and the two highest numbered DOF within each ring. All three response measurements are used in the calculation of each force pair. For the quantification of the force acting at the last remaining DOF, a final force calculation uses all three acceleration measurements to estimate the force at the determined impact point. As mentioned in the analytical section, the final force calculation for the amplitude-based is the same as that used in the shape-based for the correct impact point. An example of the final force estimate in the time domain for an impact at Point 1 is shown in FIG. 3-14. This result closely matches the actual force applied because no damage is caused by the impact, and the SNR for many frequencies is large.

The procedures for locating and quantifying isolated, impulsive forces using both the shape-based and amplitude based passive, force-estimation techniques are repeated for 20 impacts at each of the 24 possible input DOF for five different Rocs. In total, the two techniques are tested for accuracy in identifying the locations of 2400 impact forces. The accuracies of the two techniques to locate where the force acted on the structure are presented in Table 3. The accuracies of the two techniques are relatively high when compared to the accuracies (e.g., 80%-100%) of tests of force-identification techniques that utilize an overdetermined system of equations and/or more than one sensor.

Both techniques are successful in determining the correct impact location. It is demonstrated above that if the correct input DOF is identified, the force will be quantified with little error as shown in FIG. 3-14.

The number of response measurements included in Eq. (1) when quantifying the force at the final forcing DOF is varied in order to determine how the accuracy of the force estimate is dependent on the degree to which Eq. (1) is overdetermined. Because a triaxial accelerometer is used to capture the structural responses of the object (the rocket motor casing or RMC), one, two, or three response measurement(s) can be included in the force estimate calculation. The force estimate for the force at Point 1 previously described is shown in FIG. 3-15 when the number of response measurements in Eq. (1) is varied. For simplicity, when one response measurement is used, the X-direction data are utilized, and when two response measurements are used, the X- and Y-direction data are utilized.

Because the response measurements had little noise corruption, the difference in the accuracy of the force estimate when three or two response measurements are included in Eq. (1) is small. However, when only one response measurement is used in Eq. (1), the accuracy of the force estimate can reduce. This direct relationship between the number of response measurements and the accuracy of the force estimate makes it helpful that two response measurements be available in a passive SHM system for the RMC.

Although in some embodiments only isolated, impulsive forces are investigated, yet other embodiments are not so constrained. The impact forces acting on the rocket motor casing may not be impulsive. For example, if a tool is dropped on a missile during maintenance operations, the tool may impulsively impact the casing, rebound, and again fall onto the casing. Non-impulsive forces are assumed to act at one location.

TABLE 4
Accuracies of the two force estimation techniques for identifying
“random” forces

| Method | Accuracy (%) |
|---|---|
| Shape-based | 93.9 |
| Amplitude-based | 98.7 |

The data analyzed in this section is acquired by a National Instruments USB-9233 (50 ksamples/s) data acquisition system. The sampling frequency is 5000 Hz, the number of points collected for each impact test is 16,384, and an acrylic hammer tip is used with the modal impact hammer instead of a metal tip. The frequency at which the force magnitude falls 20 dB is approximately 1000 Hz as discussed earlier. All other aspects of the experimental test set-up remain the same as those for the impulsive impact tests.

To further investigate the robustness of the two force-estimation techniques, “random,” impulsive forcing functions are considered. An example of the type of forcing function considered “random” for this investigation is shown in FIG. 3-16. The magnitude of the force in the frequency domain, FIG. 3-16b, still possesses the global roll-off characteristic of an impulsive force. Because the roll-off characteristic is evident for non-impulsive impacts, both the shape-based technique and the amplitude base technique perform well, Table 4. A total of 540 “random” impacts were tested, and although this sample size is small compared to the impulsive impact tests, the relative accuracies of the two techniques is evident. The accuracy of the amplitude-based technique in some embodiments is superior to the accuracy of the shape-based technique for locating random forces because the amplitude-based technique makes no assumption about the magnitude shape or type of force applied and compares median force values.

The RMC used in previous experimental tests was discretized into 24 possible input locations (force acts radially), but a force could also act on the casing at a location other than the specified 24 input DOF. A modal impact hammer with an acrylic tip is used to impulsively impact the RMC at a specified and trained input DOF and at varying distances away from the input DOF. The input force is applied 6.35, 12.7, 25.4, 38.1, and 50.8 millimeters away from the input DOF in both the circumferential and axial directions as shown in FIG. 3-17.

TABLE 5
Accuracies of the two force-estimation techniques to identify impacts
at locations other than the trained input DOF

| | | Distances (mm) away from DOF 4 toward DOF 10 | | | | | |
|---|---|---|---|---|---|---|---|
| | | 0 | 6.35 | 12.7 | 25.4 | 38.1 | 50.8 |
| Technique | Shape-based | 100% | 100% | 100% | 100% | 90% | 0% |
| | Amplitude-based | 100% | 100% | 100% | 100% | 0% | 0% |
| | | Distances (in) away from DOF 4 toward DOF 5 | | | | | |
| | | 0.00 | 6.35 | 12.7 | 25.4 | 38.1 | 50.8 |
| Technique | Shape-based | 100% | 100% | 100% | 100% | 100% | 100% |
| | Amplitude-based | 100% | 100% | 100% | 100% | 100% | 100% |

Ten impacts are applied at the trained input DOF as well as each of the 10 points at varying distances from the input DOF. The accuracies of the two techniques to identify the nearest input DOF for the different impact location are shown in Table 5. The ability of the force-estimation techniques to correctly identify the nearest input DOF is a function of the distance of the actual impact location from the trained input DOF and also the direction away from the input DOF. Both techniques perform well for impacts within 25.4 mm of the input DOF. For impacts more than 25.4 mm from the input DOF in the circumferential direction, the shape-based technique more accurately estimates the nearest input DOF than the amplitude-based technique. The distance between Point 4 and Point 10 is approximately 146 mm, so Point 4 is always the nearest input DOF for the circumferential tests. The higher accuracy of the shape-based technique may be because of it global nature with respect to frequency. Both techniques predict that the impact DOF is DOF 5; therefore both techniques located the impacts within one DOF of the nearest DOF.

Yet other embodiments of the present invention pertain to the use of the two aforementioned force-identification and quantification techniques to correctly estimate the amplitude of a damaging impact force. Because both techniques solve an overdetermined system of equations for the final input DOF, the accuracies of the two techniques to estimate the force amplitude are the same. The input DOF at which the force acts is assumed to be known. The filament-wound rocket motor casings are designed to be impact resistant; therefore, an Instron Dynatup 9250HV drop tower is used to apply high-energy and damaging impacts to the RMC.

For the tests involving the drop-tower, the missile casing is supported by two layers of polyurethane foam in a wooden V-block and is then strapped to the foam and wooden block with bungee cords as shown in FIG. 3-18. The foam is utilized in order to prevent a rattling phenomenon between the canister and the stiff wooden block, and the foam better represents the boundary conditions during normal operating conditions than placing the canister directly on the wooden block. The bungee cords prevent the casing from bouncing out of the foam and striking the underside of the drop-tower frame after a high energy impact.

As FIG. 3-19 illustrates, the filament-wound casing and wooden block are placed beneath the main cabinet of the drop tower because of size restrictions for specimens that fit in the cabinet. A tup (a rod-like structure that actually impacts the canister) with an internal force transducer strikes the canister when the carriage inside the main cabinet is released and allowed to free fall until impacting the specimen as FIG. 3-20 shows. The carriage inside the main cabinet of the drop tower is custom designed to be as lightweight as possible in order to better simulate low-mass objects striking the canister with high velocities (like a rock from blade-wash).

A triaxial accelerometer is mounted on the nose of the missile casing during the drop-tower impacts. An Agilent VXI data acquisition system is used to acquire the data from the accelerometer and tup. The sampling frequency is 4096 Hz and is appropriately chosen after finding the approximate frequency at which the force falls 20 dB with respect to frequency. The number of points recorded is 8192.

The FRF matrix is trained for forces at the input DOF where the tup of the drop tower hits the canister and is determined via modal impact testing. Impacts of varying energy levels are applied in order to analyze the effects of damage sustained by the missile casings. The varying impacts also allow for the identification of unaccounted-for forces including changes in the boundary condition forces resulting from the nonlinear structural properties of the foam activated by higher-energy forces compared to the forces used to train the FRF matrix. Impacts with 0.34, 0.68, 1.36, 2.71, 4.07, 5.43, 8.14, 10.85, and 13.56 J of energy, nominally, are applied to the canister in nine different tests. The estimated force from Eq. (1) and the curve-fit force, as described in the analytical section (without energy-balancing), are shown in FIGS. 3-21 and 3-22 for a 0.34 J impact that causes no visible damage to the RMC. A slight double impact occurs because the rebound of the canister after compressing the foam transpires in less time than is used by the pneumatic brakes of the drop tower to push the carriage and tup out of the way.

The actual peak force of the 0.34 J impact is approximately 845 N, which is slightly higher than some of the modal-impact-hammer forces (typically between 222-667 N) identified in previous sections, and the impact caused no visible damage to the canister. However, the main lobe of the impact is approximately 2.5 times as wide as a typical impulsive force from a modal impact hammer. Accordingly, the frequency at which the magnitude of the force drops 20 dB is approximately 400 Hz (as shown in FIG. 3-22), which is about 2.5 times less than the corresponding frequency for a modal impact using the acrylic hammer tip. Therefore, a much larger portion of the energy of the drop-tower impact is focused at frequencies less than 400 Hz. Low-frequency oscillations have larger deflections than high-frequency oscillations because of inertia effects, and the increased energy in the lower frequencies for the drop-tower impacts causes larger deflections of the foam supports than during modal-impact tests. As FIG. 3-23 shows, the stiffness of the foam varies with foam compression causing the boundary-condition forces to change from those initially modeled in the trained FRF matrix.

Because of the nonlinear properties of the polyurethane foam and other unaccounted-for forces, there may be a decrease in accuracy in the ability of the force-estimation technique to estimate the amplitude of the applied force. As previously mentioned, in some embodiments the techniques are developed for and based on modeling a structure as a discrete, linear structure. The FRF matrix is trained while the structure is its normal operating conditions and subject to typical boundary-condition forces. These assumptions can introduce error in some embodiments.

First, the composite missile casing is not a discrete, nor a linear, system. All structures have inherent nonlinearities, and high-amplitude, damaging excitations usually amplify these nonlinearities. Second, the polyurethane has nonlinear stiffness properties that vary with the amplitude and frequency of the imposed deflections. The errors in the force estimate shown in FIG. 3-21 are due to forces that are not initially modeled in the trained FRF matrix including the nonlinear foam forces exerted on the canister during and after the drop-tower impact. Furthermore, the force estimate for the 0.34 J impact (FIG. 3-21) qualitatively indicates that the foam is the main source of the estimation errors because the force estimate largely differs from that of the actual force at frequencies lower than 50 Hertz, FIG. 3-21b, where no structural modes other than rigid-body modes, which are dependent on the foam properties, are present. The errors in the curve-fit force estimate caused by the differences in the rigid-body modes can be seen when comparing the actual force to the estimated force in the time domain in FIG. 3-21a.

The foam is also isolated as the primary source of the error in the force estimate by considering a high-amplitude impact on a RMC that is suspended by two rubber bands. The boundary conditions of the canister when suspended with rubber bands are less influential on the structural response following a high-amplitude impact than the polyurethane foam in the wooden block. A modal impact hammer is used to apply a force with peak amplitude of over 1779 N, nearly twice the peak force of the 0.34 J drop-tower impact. Similar to the 0.34 J drop-tower impact, the 1779 N, peak-amplitude force causes no visible damage. However, unlike the 0.34 J impact, the impact when the canister is suspended is accurately predicted as shown in FIG. 3-24. The percent difference between the actual and estimated peak force is qualitatively much less when using rubber bands as supports, FIG. 3-24, than when using foam, FIG. 3-21. The large discrepancies between the preliminary curve-fit force and actual force at low frequencies, as seen in the tests involving foam supports (FIG. 3-21), are not present when using the less-influential rubber-band boundary conditions.

The errors of the force estimate because of the unaccounted-for forces also affect the curve-fit force estimate after equating the signal energies of the original and the preliminary curve-fit force estimates (shown in FIG. 3-21) as described in the analytical application. The signal energy in the frequency span of 5-400 Hz is equated between the original and the preliminary curve-fit force estimates for the non-damaging 0.34 J impact; the adjusted curve-fit force is shown in FIG. 3-25. As FIG. 3-25 illustrates, the signal energy of the original estimate is skewed by the frequency content below 50 Hz (which is frequency content that is adversely affected by the properties of the polyurethane foam), and the adjusted curve-fit force estimate over-predicts the amplitude of the applied force. The peak force of the originally estimated force is lower than the actual force for most drop-tower impacts tested in this document, and the peak force of the adjusted curve-fit force may over-predict the force. As FIG. 3-26 shows, the peak amplitude of the original force estimate more accurately predicts the actual peak force, possibly because the adjusted curve-fit estimate is affected by the boundary condition forces of the polyurethane foam.

As the impact energy increases, the original estimates become less accurate because 1) the nonlinear boundary condition forces of the foam are amplified and 2) structural damage is sustained with impacts greater than or equal to 4.07 J. However, the results of FIG. 3-26 suggest that the actual peak force is bounded by the original and the adjusted curve-fit force estimates.

The adverse effects of the foam boundary conditions and other forces not modeled in the trained FRF can be eliminated. Much of the foam effects are at frequencies lower than approximately 50 Hz. In order to minimize the adverse foam effects at low frequencies, the assumption that the applied force is impulsive is revisited. As the ability of the shape-based technique to locate where a force acted has demonstrated, the magnitude of an impulsive force decreases with increasing frequency and can be accurately represented with a quadratic curve. Therefore, the magnitude estimate of the applied, impulsive force of the drop-tower experiments should follow a quadratic decay with respect to frequency.

The magnitude of the drop-tower force at low frequencies is adjusted to follow a quadratic, curve-fit line according to the impulsive-force assumption. Although the majority of foam effects are below 50 Hz, by inspecting FIG. 3-25, adverse effects from the foam properties can be seen up to frequencies around 100 Hz. Consequently, the following procedure is followed in some embodiments to reduce the effects of the foam on the force estimate:

1. Equation (1) is used to estimate the force as previous sections have described.

2. A quadratic line is curve fit to the force estimate over the frequency range of 100-350 Hz in order to avoid the frequency range most affected by the foam and zero-crossings of the magnitude estimate. It is understood that yet other embodiments are not constrained to a curve-fit technique based on a quadratic line, and yet other curve-fitting techniques known in the art are contemplated in other embodiments.

3. The determined quadratic line is extrapolated toward 0 Hz, and the magnitude of the originally estimated force is adjusted to follow the curve-fit line. Although the magnitude of the force is adjusted, the phase of the force remains unchanged.

The force estimate for a 0.34 J drop-tower impact after applying the above procedure is shown in FIG. 3-27. The curve-fitting process causes a discontinuity in the force estimate in the frequency domain at 100 Hz. A discontinuity in the frequency domain introduces a sinusoidal-type of signal in the time domain as evident near the main pulse of the forcing function in FIG. 3-27a. The fluctuation in the frequency domain that is caused by the double impact of the tup is lost in the curve-fit portion of the force in the frequency domain. However, in the frequency ranges where the double impact information is lost, the foam effects erroneously dominated the original force estimate, and for an impulsive impact, as assumed, no double impact would be present.

The force estimate after the foam effects are minimized is used in an energy balance with the time-domain, curve-fit force of the original force estimate. Although the peak amplitude of the adjusted force estimate after minimizing the foam effects and equating the signal energy better matches the actual force for a 0.34 J impact, as shown in FIG. 3-28, the estimate outside of the main lobe of the force better matches that of the actual. The increased accuracy of the adjusted force estimate is evident in the frequency domain also, especially at low frequencies.

The peak force error between the original estimate, the adjusted estimate without removing the foam effects, and the adjusted estimate with foam effects removed is shown in FIG. 3-29. It is clear that by removing the effects of the foam and balancing the signal energy, the amplitude of the applied force estimate is greatly improved, especially for impacts with higher energy levels.

Various embodiments of the present invention offer two minimal sensing, passive force identification and quantification techniques. These methods can be applied to quantify forces acting on a structure with multiple input locations using one multi-directional sensor when the structure becomes damaged due to the impact. Both force estimation techniques investigated in this document are applied in the frequency domain. The first technique discussed is a shaped-based technique. The second method is based on the amplitude of the estimated force. The shape-based technique includes the assumption that the applied force is impulsive, but the amplitude-based technique includes no such assumptions. The shape-based technique is a global technique, i.e., it analyzes the shape of the force magnitudes over a broad range of frequencies. Conversely, the amplitude-based technique finds the median force value for a frequency region consisting of multiple, narrow frequency spans. Both force-estimation techniques reduce an underdetermined system of equations into many overdetermined systems of equations in order to locate and quantify the applied force.

1. The analytical application proved that although the FRF matrix is more ill-conditioned near resonant frequencies, the low SNRs for frequencies other than those near resonant frequencies cause more errors in the force estimate than the ill-conditioning of the FRF matrix. Therefore, it is helpful in some embodiments to focus on frequencies near the resonant frequencies of the structure when implementing the amplitude-based technique.

2. When estimating forces that damage the structure or that act on a damaged structure, the processes of curve fitting the estimated force in the time or frequency domain and matching the signal energy of the original estimate to that of the curve-fit force increase the accuracy of the estimated force. In the experimental tests that estimate damaging impacts, the adverse effects of the force estimates due to the nonlinear properties of the polyurethane foam and other unaccounted-for forces are minimized before equating the signal energies of the original and the curve-fit forces. The foam effects are minimized by revisiting the assumption that the applied force is impulsive, and that the magnitude of an impulsive force has a smooth roll-off in the frequency domain with increasing frequency.

3. The accuracy of the estimated force is proportional to the number of response measurements included in the equations of motion. For the experimental application involving the filament-wound RMC, at least two response measurements (i.e., in two orthogonal directions) achieve relatively accurate force estimates.

4. The two force-estimation techniques are able to identify the location of over 97% of 2400 impulsive impacts acting at a designated input DOF correctly.

5. Although the shape-based technique was developed to identify impulsive impacts, both force-estimation techniques are able to locate the input DOF for non-impulsive forces. The accuracies for both techniques for the small sample size tested is at least 93%, and the amplitude-based technique performs slightly better than the shape-based technique because no assumptions about the applied force are used.

6. In those applications pertaining to objects that are cylindrical, the techniques are able to better identify the nearest input DOF for forces that do not act at a trained input DOF if the impact acts away from the input DOF in the axial direction rather than the radial direction. This suggests that the discretization mesh can be coarser in the axial than the radial direction.

The experimental results suggest that in certain instances the shape-based technique better locates and quantifies the applied force than the amplitude-based technique (e.g. when the impact does not act at a specified DOF), but in some instances the opposite is true; the amplitude-based technique performs better (e.g., when identifying nonimpulsive impacts). Therefore, some embodiments of the present invention contemplate a force estimation technique that incorporates both the shape and amplitude-based techniques to provide robust performance in passively identifying and quantifying external forces on objects.

While the inventions have been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A method for estimating an unknown load on an object, comprising:
preparing an experimental model of the object, the model relating the spatial response of a location on the object to a known load applied at a plurality of test sites on the object;
impacting the object with an unknown load;
measuring the spatial response of the object at the location to the unknown load;
using the response from said measuring in the model to predict a hypothetical load at each of a plurality of predicted sites; and
selecting at least one of the hypothetical loads as an estimate of the unknown load.

2. The method of claim 1 wherein the model includes a frequency response function for each predicted site relating the known load to the response at the location.

3. The method of claim 2 wherein the frequency response functions are expressed in at least two orthogonal directions.

4. The method of claim 1 which further comprises interpolating the spatial responses between adjacent test sites and associating the interpolated responses with an interpolated site.

5. The method of claim 4 wherein the predicted sites include the test sites and the interpolated sites.

6. The method of claim 5 wherein the model includes a frequency response function for each site relating a load to a response at the location.

7. The method of claim 6 wherein the frequency response functions are expressed in at least two orthogonal directions.

8. The method of claim 1 wherein said impacting is within an area of the object bounded by the positions of the test sites.

9. The method of claim 1 wherein the spatial responses are measured in at least two orthogonal directions.

10. The method of claim 1 wherein the predicted sites are the test sites.

11. The method of claim 1 wherein said preparing is with a first object, said impacting is with a second object, and the first object and the second object are substantially identical members of a family of like objects.

12. The method of claim 1 wherein said selecting includes preparing an error index

13. A method for estimating an unknown load on an object, comprising:
providing a sensor and a known test load;
placing the sensor at a predetermined sensing location on an object;
establishing a plurality of testing sites on the object;
exciting the object at a testing site with the test load;
measuring the response of the object to said exciting with the test load by the sensor;
storing the response in memory;
repeating said exciting, said measuring, and said storing for each of the testing sites;
exciting the object with an unknown load;
measuring the response of the object to said exciting with the unknown load by a sensor placed at the sensing location; and
using the stored test load responses and a quality of the measured load response and predicting a qualities of a plurality of hypothetical loads each at a different one of the sites.

14. The method of claim 13 wherein said predicting includes assuming that the unknown load excited the object at a single location.

15. The method of claim 13 wherein said predicting includes assuming that the unknown load did not plastically deform the object.

16. The method of claim 13 wherein said predicting includes assuming that the unknown load was a single impulsive load.

17. The method of claim 13 wherein said predicting includes assuming a direction for the unknown load.

18. The method of claim 17 wherein the direction corresponds to an impact from the outside environment of the object.

19. The method of claim 13 wherein the hypothetical loads are predicted in the time domain.

20. The method of claim 13 wherein the hypothetical loads are predicted in the frequency domain.

21. The method of claim 13 wherein the quality of the unknown load is the magnitude of the load.

22. The method of claim 13 wherein the quality of the unknown load is the time history of the load

23. The method of claim 13 wherein the quality of the unknown load is the frequency content of the load.

24. The method of claim 13 which further comprises associating the test load at the site to the response measured at the testing site by a frequency response function.

25. The method of claim 13 wherein the source has a time history similar to the time history expected of the unknown load.

26. The method of claim 13 wherein the sensor measuring the response to the unknown load is different that the sensor measuring the response to the testing source

27. The method of claim 13 wherein the source is a hammer.

28. The method of claim 13 wherein the plurality of testing locations are arranged in a two dimensional grid.

29. The method of claim 13 wherein the object is a structural panel.

30. A method for estimating an unknown load on an object, comprising:
preparing an experimental model of the object, the model relating the spatial response in at least two orthogonal directions of a location on the object to a known load applied at a plurality of test sites on the object;
impacting the object with an unknown load;
measuring the spatial response of the object at the location to the unknown load;
using the response from said measuring in the model and predicting a hypothetical load at a test site;
using the hypothetical load in the model and predicting a hypothetical spatial response at the location in the at least two orthogonal directions; and
comparing the measured spatial response to the hypothetical spatial response.

31. The method of claim 30 which further comprises comparing the ratio of the measured directions to the ratio of the hypothetical directions.
